(19) United States
(12) Patent Application Publication
(10) Pub. No.: US 2004/0230508 A1
(43) Pub. Date: Nov. 18, 2004

(54) System for generating financial statements using templates

(76) Inventors: Raymond Albert Minnis JR., Charleston, SC (US); Scott Howard Ramoth, Coatesville, PA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/696,768

(22) Filed: Oct. 29, 2003

Related U.S. Application Data
(60) Provisional application No. 60/422,049, filed on Oct. 29, 2002.

(51) Int. Cl. G06F 17/60

(52) U.S. Cl. 705/35

(57) ABSTRACT

In a computerized accounting system, a method of generating a financial report includes displaying a user-configurable chart template to a user of the system via a user-interface, receiving inputs into the chart template to define rows of information to be included in the report, the inputs include header/total pairs and detail lines. Rules associated with each detail line determine what accounts will be included in the report and how they are arranged. Rules may be based on a range of account codes, with each account having its own account code. Rules may also be based on a filter of account criteria associated with each account. Validation of the template ensures that accounts are not include twice in the same report and that no accounts are inadvertently overlooked.

### CROSS REFERENCE TO RELATED APPLICATION

This application claims the benefit under 35 U.S.C. § 119(e) of U.S. provisional patent application No. 60/422,049, entitled “System and Method for Creating Financial Statements for Nonprofit Organizations,” filed Oct. 29, 2002, which is incorporated herein by reference.

### FIELD OF THE PRESENT INVENTION

The present invention relates generally to financial and accounting software and, more particularly, to methods and systems for quickly generating robust and versatile financial statements and financial reports for organizations through the use of easy-to-configure, rule-driven templates accessible through a user interface.

### BACKGROUND OF THE PRESENT INVENTION

Accounting principles, tax issues, and reporting requirements for non-profit or not-for-profit organizations (hereinafter “not-for-profit organizations” or “not-for-profits”) are substantially different from those applicable to commercial enterprises. For example, commercial enterprises typically measure product, brand, division, and company performance on a profit/loss basis. In contrast, not-for-profit organizations not only measure incoming and outgoing funds, but they must also document that they are spending and using money wisely, efficiently, in accordance with their own charter, and in accordance with the specific restrictions placed on donations they receive.

Not-for-profits must keep a formal budget as part of the organization's books; track and report accounting records separately for different funding sources, grants, departments, scholarships, programs, or functions; be able to allocate expenses across different funding sources, grants, departments, scholarships, programs, or functions; track and report across diverse time periods, sometimes spanning multiple years and on a non-annual basis; keep funds separate, according to donor restrictions; measure the success of fund raising events, programs, and departments; track efficiency of the organization using the ratio of overhead to program usage; and produce specialized reports for different internal and external audiences.

Because of these obligations, not-for-profit organizations need accounting systems that are more robust and versatile than conventional accounting system used by commercial enterprises or individuals. In particular, accounting systems for not-for-profit organizations must have the ability to generate numerous financial statements and reports for this diverse audience. Not only must not-for-profits comply with the stringent reporting standards of the Financial and Governmental Accounting Standards Boards (FASB & GASB), but they must also respond to requests from private and public granting agencies that require detailed, customized reports, and they must be able to generate reports for their own internal uses—such as review by the Board of Directors or by a particular fund or project manager.

Many accounting software packages currently exist that provide not-for-profit organizations with a means for tracking financial information and for creating financial reporting documents, such as balance sheets and income statements. These software packages, however, typically require substantial configuration and customization before any financial statements can be generated or, alternatively, only allow generation of reports in a pre-configured and non-modifiable format or arrangement. If the software permits customized financial statements, it typically requires extensive coding and arrangement to generate such new reports—even if they have only slight variations to already existing financial statement formats or arrangements. Further, whenever any new account is created or added to the accounting system of the organization, it is usually then necessary to add a new line item for such new account to each relevant financial statement that needs to report about such account. Because of the above difficulties, it is typically necessary for not-for-profits to retain experienced programmers or hire contractors to develop the code necessary to configure each financial statement desired by the organization, at great cost of time and money. In addition, because of the difficulty of creating or modifying what information will be displayed in a financial statement, it is generally not possible for organizations to create customized reports “on the fly,” as is often necessary or desirable by individuals within the organization, for targeted reporting purposes. Also, when modifications are made to an existing report, it is usually necessary to run the report just to confirm what effect or impact the modification has had to the report.

For these and many other reasons, there is a need for a system and method for enabling organizations to create robust financial statements and financial reports quickly, cheaply, and “on the fly.”

There is a need for a system and method for enabling organizations to create financial reports using easily-modifiable templates that define what accounts will be included in the report and in what order and in what configuration and with what formatting.

There is a need for a system and method having an easy-to-use user interface to enable non-programmers, such as data entry personnel, to create, modify, and save templates used to generate financial statements.

There is a need for a system and method that associates rules with specific line items on a template for generating robust and configurable financial statements and that incorporate newly-created accounts without requiring further modification or updating to the template (or any templates) used to generate financial statements.

There is a need for a system and methods for enabling a not-for-profit to have the ability and flexibility to create unlimited charts of accounts and financial statement formats.

There is a need for a system and methods for enabling formatting of a financial statement into hierarchical levels that are not dependent upon specific account setups. In other words, there is a need for being able to create multiple financial statements, each having the same account displayed or presented at a different hierarchical level based on the financial statement. Stated yet another way, there is a need for a system and methods that allow accounts to be created independent from where and how such account will be displayed on any given financial statement.

There is a need for a system and methods for enabling a user of the accounting system to define, customize, and preview a financial statement structure on a real-time basis.

There is a need for a system and method that enables a user quickly to view the layout or structure of a financial statement without requiring access to real-time data or the delays associated with accessing such data to populate an actual financial statement.

For these and many other reasons, there is a general need for having, in a computerized accounting system with access to a database of accounts, each account having account data associated therewith, the account data including account name and account financial information, a system and method for generating a financial report that comprises the steps of displaying a user-configurable chart template to a user of the system via a user-interface, receiving inputs into the chart template, each input defining a respective detail line, associating a rule with each detail line of the chart template, each respective rule defining a subset of accounts to be grouped together in the financial report, retrieving from the database account data for each account associated with the detail lines of the chart template, merging the retrieved account data into the financial report, the financial report having columns for account name and account financial information, the rows of information in the financial report grouped based on the detail lines of the chart template, and presenting the financial report to the user.

For these and many other reasons, there is also a general need for having, in a computerized accounting system, in which rows of a financial report generated by the accounting system are defined by a user-configurable chart template, a system and method for creating the chart template that comprises the steps of displaying a visual representation of the chart template via a user interface, the visual representation corresponding to at least one section of the financial report, receiving an input for a header/total pair for insertion into the at least one section of the financial report, the header/total pair defining a header row and a corresponding total row for inclusion in the financial report, receiving an input for a detail line associated with the header/total pair, and associating a rule with the detail line, the rule defining which accounts of the accounting system are to be listed between the header row and the corresponding total row of the financial report.

The present invention meets one or more of the above-referenced needs as described herein in greater detail.

### SUMMARY OF THE PRESENT INVENTION

The present invention relates generally to financial and accounting software and, more particularly, to methods and systems for generating and quickly creating robust and versatile financial reports for organizations through the use of rule-driven templates accessible through a user-interface. Briefly described, aspects of the present invention include the following.

In a first aspect of the present invention, in a computerized accounting system with access to a database of accounts, each account having account data associated therewith, the account data including account name and account financial information, a method of generating a financial report comprises the steps of displaying a user-configurable chart template to a user of the system via a user-interface, receiving inputs into the chart template, each input defining a respective detail line, associating a rule with each detail line of the chart template, each respective rule defining a subset of accounts to be grouped together in the financial report, retrieving from the database account data for each account associated with the detail lines of the chart template, merging the retrieved account data into the financial report, the financial report having columns for account name and account financial information, the rows of information in the financial report grouped based on the detail lines of the chart template, and presenting the financial report to the user.

In a feature of the first aspect, when displaying the user-configurable chart template to the user, the chart template is initially blank. In another feature, when displaying the user-configurable chart template to the user, the chart template already includes at least one pre-defined detail line.

In a further feature of the first aspect of the invention, the above method also includes the step of validating the chart template to identify any accounts in the database not associated with at least one detail line of the chart template. In yet a further feature, the above method also includes the step of validating the chart template to identify any accounts in the database associated with more than one detail line of the chart template.

In another feature, the above method includes the step of receiving further inputs into the chart template, each further input defining header rows and total rows for inclusion in the financial report.

In yet another feature of the first aspect of the invention, the above method includes the step of receiving further inputs into the chart template, each further input defining a header/total pairs, and wherein each respective detail line is associated with one of the header/total pairs. Additionally, the method includes the step of assigning an account is category to each respective header/total pair and further includes assigning an account category to each account in the database, wherein the rule associated with each respective detail line requires that all accounts associated with the respective detail line be of the account category of the associated header/total pair.

In yet further features of the first aspect, the above method includes assigning a level to each respective header/total pair and each respective detail line and wherein each header/total pair defines a respective header row and a respective corresponding total row for inclusion in the financial report, and wherein the level determines the indentation of each respective header and total row in the financial report.

Preferably, the level selectively determines whether each respective header and total rows are displayed in the financial report. In an embodiment, the user selectively determines up to what level the financial report will include.

In another preferred embodiment, the level determines the indentation of the account names of each accounts associated with a respective detail line. Further, the level selectively determines whether accounts associated with each respective detail line are displayed in the financial report.

In another feature, each account in the database includes an account code and the rule associated with each respective detail line is based on a range of account codes. Alternatively or simultaneously, some rules associated with respective detail line are based on a filter of account criteria.

In another feature, the above method includes the step of receiving a request from the user for generation of the financial report. In a further feature of the first aspect of the invention, the method includes the step of presenting the user with a list of available financial reports. In one embodiment, when funds are defined in the accounting system, the rows of information in the financial report are sortable by such funds. In another feature, the step of presenting the financial report includes displaying the financial report on a computer screen and/or printing the financial report. In yet another feature, the above method includes the step of presenting the user with a list of available financial reports.

Other features of the first embodiment include the step of saving the chart template and displaying a visual representation of the chart template wherein each respective detail line is replaced by a list of all accounts associated by the rule of the respective detail line.

In yet a further feature of the first aspect of the invention, the chart template corresponds to a section of the financial report. Such section may be a balance sheet or an income statement. When the section is a balance sheet, the account category of each detail line in the balance sheet section of the chart template is assets, liabilities, net assets, or “balance sheet.” If “balance sheet,” then the detail line may include combinations of assets, liabilities and net assets. When the section is an income statement, the account category of each detail line in the income statement section of the chart template is revenue, expense, gift, transfer, gain, loss, or “income statement.” If “income statement,” then the detail line may include combinations of revenue, expense, gift, transfer, gain, and loss.

In a second aspect of the present invention, in a computerized accounting system, in which rows of a financial report generated by the accounting system are defined by a user-configurable chart template, a method of creating the chart template comprises the steps of displaying a visual representation of the chart template via a user interface, the visual representation corresponding to at least one section of the financial report, receiving an input for a header/total pair for insertion into the at least one section of the financial report, the header/total pair defining a header row and a corresponding total row for inclusion in the financial report, receiving an input for a detail line associated with the header/total pair, and associating a rule with the detail line, the rule defining which accounts of the accounting system are to be listed between the header row and the corresponding total row of the financial report.

In a feature of the second aspect of the present invention, the method includes assigning an account category to the header/total pair. In another feature, the method includes assigning an account category to each account in the accounting system and wherein the rule requires that all accounts associated with the detail line be of the account category of the associated header/total pair. In another feature, the method includes presenting a list of acceptable account categories assignable to the header/total pair based on the at least one section.

In yet further features, the method of the second aspect of the invention includes assigning a level to the header/total pair, determining the indentation of the header and total rows in the financial report based on the level, and selectively determining whether the header and total rows are displayed in the financial report based on the level. In another feature, the method includes assigning a level to the header/total pair and a level to the detail line, wherein the level of the detail line is greater than the level of the header/total pair.

In another feature of the second aspect of the present invention, each account in the accounting system includes an account code and the rule associated with the detail line is based on a range of account codes. Preferably, the range of account codes is a subset of a range of permissible account codes associated with an account category of the corresponding header/total pair. Alternatively or in combination with the above, the rule associated with the detail line is based on a filter of account criteria.

In a feature, the method includes displaying a visual representation of the chart template wherein the detail line is replaced by a list of all accounts associated with the detail line by the rule.

In other features, the section is a balance sheet or an income statement and the input for the header/total pair includes a caption for the header row.

The present invention also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a system view of the primary components of a preferred embodiment of the present invention;

FIG. 2 is a screen shot of a main start page associated with the system of FIG. 1;

FIG. 3 is a screen shot of a main records page associated with the system of FIG. 1;

FIG. 4 is a screen shot of a main accounts page associated with the system of FIG. 1;

FIGS. 5A through 5B are screen shots of a new account page associated with the system of FIG. 1;

FIGS. 6A through 6C are screen shots of an account search page associated with the system of FIG. 1

FIGS. 7A through 7D are screen shots of a new project page associated with the system of FIG. 1;

FIG., 8 is a screen shot of a main reports page associated with the system of FIG. 1;

FIGS. 9A through 9B are screen shots of account report pages associated with the system of FIG. 1;

FIGS. 10A through 10H are screen shots of financial statement report pages associated with the system of FIG. 1;

FIG. 11 is a screen shot of a journal entry page associated with the system of FIG. 1;

FIG. 12 is a screen shot of a configuration page associated with the system of FIG. 1;

FIGS. 13A through 13D are screen shots of account setup pages associated with the system of FIG. 1;

FIG. 14 is a screen shot of an account code setup page associated with the system of FIG. 1;

FIG. 15A through 15C are screen shots of transaction code setup pages associated with the system of FIG. 1;

FIG. 16 is a screen shot of a business rules setup page associated with the system of FIG. 1;

FIG. 17 is a structural framework of an exemplary financial statement for use with the system of FIG. 1;

FIGS. 18 through 28 are screen shots associated with the visual chart organizer associated with the system of FIG. 1;

FIG. 29 is a flowchart of a methodology associated with the system of FIG. 1;

FIG. 30 is a flowchart of another methodology associated with the system of FIG. 1;

FIG. 31 is a flowchart of a methodology associated with the methodology of FIG. 30;

FIG. 32 is a flowchart of another methodology associated with the methodology of FIG. 30;

FIG. 33 is a flowchart of a methodology associated with the methodology of FIG. 32;

FIG. 34 is a flowchart of another methodology associated with the system of FIG. 1;

FIG. 35 is a flowchart of a methodology associated with the methodology of FIG. 34;

FIG. 36 is a flowchart of a methodology associated with the methodology of FIG. 35;

FIG. 37 is a flowchart of another methodology associated with the methodology of FIG. 35;

FIG. 38 is a flowchart of another methodology associated with the system of FIG. 1.

### DETAILED DESCRIPTION OF PREFERRED EMBODIMENTS

Account System Terminology

Before turning to the detailed description of the preferred embodiments, it will be helpful to identify a number of standard accounting system definitions and terms that will be used repeatedly herein. These definitions and terms are provided not for purposes of limitation but rather for providing some context for the following description of the invention. The detailed description of the invention that follows may modify or expand the scope of these terms as will become apparent hereinafter.

Account. An account is a tool typically used to group financial transactions posted from the journal entry of an accounting system or from other subsystems of an accounting system, such as accounts payable, accounts receivable, or payroll. Accounts typically show increases, decreases, and an ending balance that provide a means for creating financial statements.

Account category. Accounts in not-for profit accounting systems are typically and currently classified into one of the following account categories: asset, liability, net asset, revenue, expense, gift, transfer, gain, or loss.

Account code. An account code is an account segment portion of an account number. The account code may be used advantageously to indicate in what account category the account number (and hence the account) belongs.

Account class. There are currently three different types of account classes for accounts used by not-for-profit organizations: (i) unrestricted net assets, (ii) temporarily restricted net assets, and (iii) permanently restricted net assets. These three account classes indicate whether and to what extent funds in the account have any restrictions placed upon their use.

Account number. An account number is the alphanumeric representation assigned to or associated with an account. The account number may be divided into a plurality of account segments, each of which may be used advantageously to place the account into different groupings (e.g., by fund, department, project, account category, etc.) for easy sorting, filtering, and reporting purposes.

Account segment. An account segment is preferably a set of digits or alphanumeric characters that make up all or part of the account number. For example, in a preferred embodiment of the present invention, account number 01-11100-00-00 may be arbitrarily defined to indicate the following: the first set of numbers in this account number is called the “fund segment” because it represents, in this case, that this account is in fund 01, the second set of numbers is called the “account code segment” because these numbers stand for the account code (in this case, 11100), the third set of numbers is called the “department segment” because it indicates with which department this account is associated, and the last set of numbers is called the “location segment” because it indicates the location (00) associated with this account. Although not shown in this one example, many other system-defined or user-defined segments may be used to further subgroup and compartmentalize accounts. Further, it should be readily apparent to one skilled in the art that the mere arrangement of the segments, use and type of separators between segments, if any, and the use of characters or other symbols instead of numbers are arbitrary and are all within the scope of the present invention.

Asset. An asset is property owned by the organization using the accounting system of the present invention. The property may be tangible or intangible and it has a value. Assets are typically recorded at cost on the balance sheet and reduced by depreciation or amortization as their value is used in the course of business operations.

Attribute. An attribute is a tool used to group information based on a common theme. Attributes may be used, for example, to filter or sort information for display or reporting purposes. Typical attributes used in the present invention include the following: accounts, projects, transactions, actions, vendors, purchase orders, invoices, and credit memos.

Chart of accounts. A chart of accounts is a systematic numeric listing of all accounts that exist in an organization's general ledger.

Equity. Equity is the worth of an organization, calculated by subtracting liabilities from assets. In nonprofit organizations, equity is known as “net assets”.

Expense. An expense is the result of using assets in the course of conducting operations. Examples are telephone charges, gasoline purchases, and repairs. Expenses are deducted from revenues on the income statement of financial activities report to arrive at net income or net surplus.

Fund. A fund is a self-balancing set of accounts. Funds separate accounts into groups specific to certain activities, donor-imposed restrictions, or objectives. In the preferred embodiment, funds must be created before accounts can be entered or created.

Gain. A gain is an infrequent or one-time source of revenue, as opposed to revenues derived from an organization's normal activities. An example of a gain is revenue realized from the sale of a vehicle.

General Ledger. A general ledger is the primary financial transaction register in an accounting system that contains all balance sheet and income statement accounts. It is used as a central storage file for all financial transaction records, regardless of whether they are created in related systems, such as an accounts payable program or added as manual journal entry transactions directly into the general ledger.

Gift. A gift typically is revenue from donations.

Loss. A loss is an infrequent expense, for example, a vehicle disposed of prior to the end of its estimated life.

Net asset. A net asset is residual value in an entity's asset remaining after liability is deducted.

Project. A project is a transaction-level identifier that categorizes transactions and budget entries. Projects are used to track equity balances or prepare financial statements for a given purpose.

Record. A record is the primary way information is stored in the present invention. From a record, one can add, edit, and delete collections of information. One record can contain other records. For example, a vendor record usually contains invoices.

Transaction. A transaction is a general ledger entry that indicates to the system the amount and account to debit or credit. Transactions also contain additional information that helps trace and report on them. Transactions include source codes and journal references and, in some embodiments, may include project and transaction code distributions.

Transaction code. A transaction code is an additional field on each transaction that helps further categorize information in reporting and closing fiscal years. In the preferred embodiment, up to five transaction code tables can be defined by the user. Because it can retain equity, a transaction code acts like a project. Unlike a project, though, a transaction code does not offer budgets, media, or notes.

System Overview

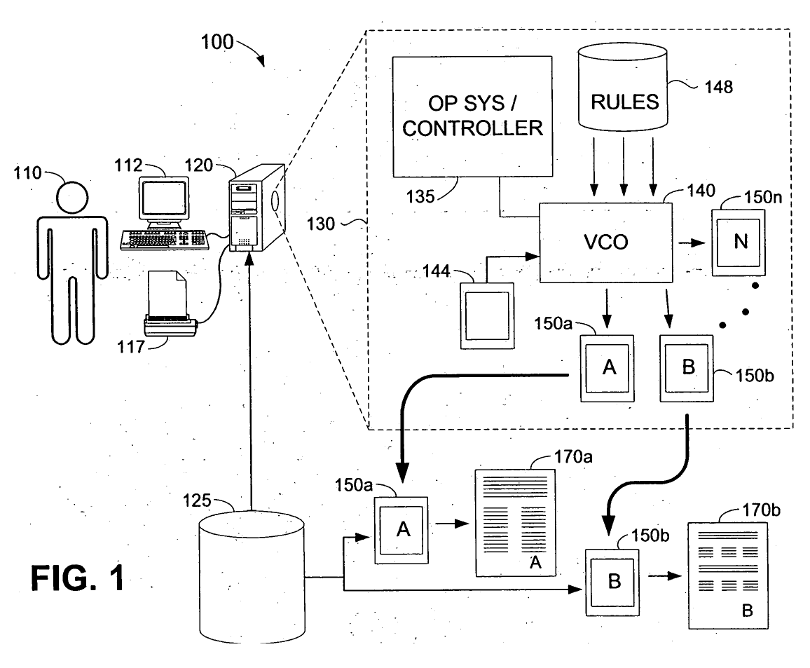

Turning now to FIG. 1, an exemplary embodiment illustrating primary components of the system 100 of the present invention is shown. The system 100 is preferably accessed by at least one system user 110 from a computer or terminal 115. The computer or terminal 115 may be a stand-alone computer or, preferably, a terminal or computer networked with a conventional computer network or server 120 utilized by most companies and organizations. The computer 115 has conventional components, such as a keyboard and a monitor or display 112, and preferably connects directly, or through the network 120, to at least one printer 117. Preferably, the computer 115 and the network 120 also have read/write access to at least one database 125 that maintains accounting data and records of the company or organization utilizing the system 100 in conventional manner. The computer 115 or network 120 includes or has the capability of running or accessing software associated with accounting system 130, shown in phantom lines. The accounting system 130 includes a number of conventional components or software modules (not necessarily shown but as will be readily apparent to one skilled in the art) as well as a number of components or software modules specifically relevant to the present invention.

In particular, accounting system 130 includes, among other things, an operating system or controller 135 for managing and integrating all of the subcomponents (shown and not shown) of the accounting system 130. The accounting system 130 includes a visual chart organizer 140 subsystem or subcomponent that is preferably accessible by the system user 110 by means of a user interface, viewable on display 112 and which will be described in greater detail hereinafter. The visual chart organizer 140 has access to a default or baseline financial statement generation template 144 and to a rule base 148 and enables the system user 110 to create or build any number of financial statement generation templates 150a, 150b, . . . , 150n quickly, easily, and in a customizable manner. As will be described in greater detail hereinafter, financial statement generation templates 150 are created by using the default template 144, by adding line items of the type of information the system user 110 wants to include in a financial statement, such as header/total pairs and accounts to be shown within each such header/total pair. Rather than requiring the user 110 to list each desired account, however, the visual chart organizer 140 enables the user to associate a rule, as allowed by rule base 148, with one or more “detail lines” within each such header/total pair, which defines what accounts will be included therein. The visual chart organizer 140 enables the user quickly to see the resulting list of accounts that will be included within a header/total pair based on such rule association without actually requiring the generation of a financial statement. Once a template 150 is created and when the user 110 is actually ready to generate a financial statement, the system user 110 selects one of the available financial statement generation templates 150a or 150b (in this case) and defines the columns of information to be included in the financial statement. The system 130 then combines the user's selections with real-time data obtained from database 125 to generate the desired financial statement 170a or 170b. Such financial statement 170a,b is displayable on the user's computer display 112, printable on printer 117, and savable to computer memory in conventional manner.

It should be understood that, although only one system user 110 is shown for simplicity reasons, multiple system users typically will have access to the system 100. Further, it is permissible that the system user requesting or generating a financial statement 170 not necessarily be the same system user who created any of the selectable financial statement generation templates 150.

Environment

Before describing the specific components and methodologies of the present invention associated with FIG. 1 in greater detail, it will be helpful to understand the operating environment, data, account, and record structures, and standard components of the accounting system 130 within which the present invention preferably operates. This will be done with reference to a plurality of exemplary screen shots showing a system user's perspective of the accounting system 130. Those skilled in the art will understand and appreciate the underlying functionality and programming necessary to generate and utilize such computer screens. It should be understood further that these screen shots are shown merely for illustrative and explanatory purposes and not for purposes of limiting the scope or applicability of the present invention. Those skilled in the art will understand and appreciate that the present invention has broad utility within many accounting systems regardless of the specific layout, look and feel, and interface used by the system to interact with system users.

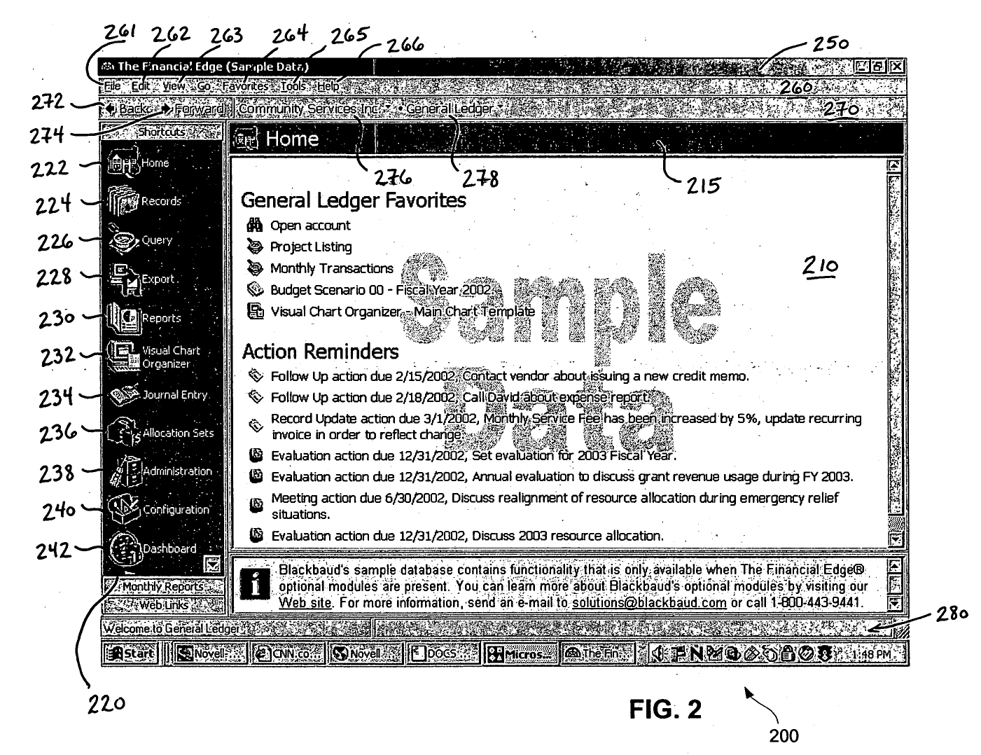

Turning now to FIG. 2, a screen shot of an exemplary user interface 200 (or “shell”) generated by the accounting system 130 is illustrated. A primary purpose of the preferred embodiment of the present invention is to provide easy navigation. Thus, the user interface 200 has the look and feel of a conventional web browser, which makes maneuvering between programs, modules, and functions simple and intuitive. This user interface provides many benefits, including the ability to move back and forward with a click of a computer mouse and a centralized location for accessing the various subsystems and components of the system.

The user interface 200 includes a primary display area 210 and a navigation bar 220. The primary display area 210 further includes a title bar 215, which tells the user what subsystem or component is currently being accessed and displayed in the display area 210. Currently, the general ledger “home” page, which is customizable by the user, is displayed within display area 210. The navigation bar 220 includes logos and words, each of which are hyperlinked to different subsystems and components of the system. The user is able to “hide” the navigation bar 220 and move it to the top, bottom, left, or right side of the user interface 200. When any one of the links is activated in conventional manner, the start page for that subsystem or component is preferably displayed within the display area 210 (and in some cases as a separate window). As illustrated, the navigation bar 220 includes “short cut” links to home 222, record 224, query 226, export 228, reports 230, visual chart organizer 232, journal entry 234, allocation sets 236, administration, 238, configuration 240, and dashboard 242. Some of these subsystems and components, which are relevant to the present invention, will be described in greater detail hereinafter.

The user interface 200 also includes a title bar 250, a menu bar 260, a toolbar 270, and a status bar 280. The title bar 250 at the top of the shell usually displays the name of the program and includes standard Windows® buttons to minimize, maximize, and close the program. When in a specific record, the title bar 250 displays the “saved” name of the record. The menu bar 260 under the title bar 250 displays accessible menus containing commands for various functions. The menus typically include file 261, edit 262, view 263, favorites 264, tools 265, and help 266. The current screen display 210 includes go 267, as an additional menu bar option. Other menu bar options available on some screens (not shown) include account, project, batch, vendor, and asset menu options. The commands available within each menu depend on the area of the system currently being accessed.

The toolbar 270 appears under the menu bar 260 and provides “back” and “forward” buttons 272, 274, respectively, that enable the user to quickly move back and forth between screen and system modules. The toolbar 270 also preferably displays the name 276 of the organization for which the user works or is associated and the specific program 278 in which the user is working. The specific program 278 area includes a pull-down menu from which the user can select from general ledger, accounts payable, accounts receivable, fixed assets, and cash receipts. The present invention will be directed to functionality associated primarily with general ledger.

The status bar 280 appears across the bottom of a screen or record and acts as a guide within the system—displaying important messages or helpful information, as necessary.

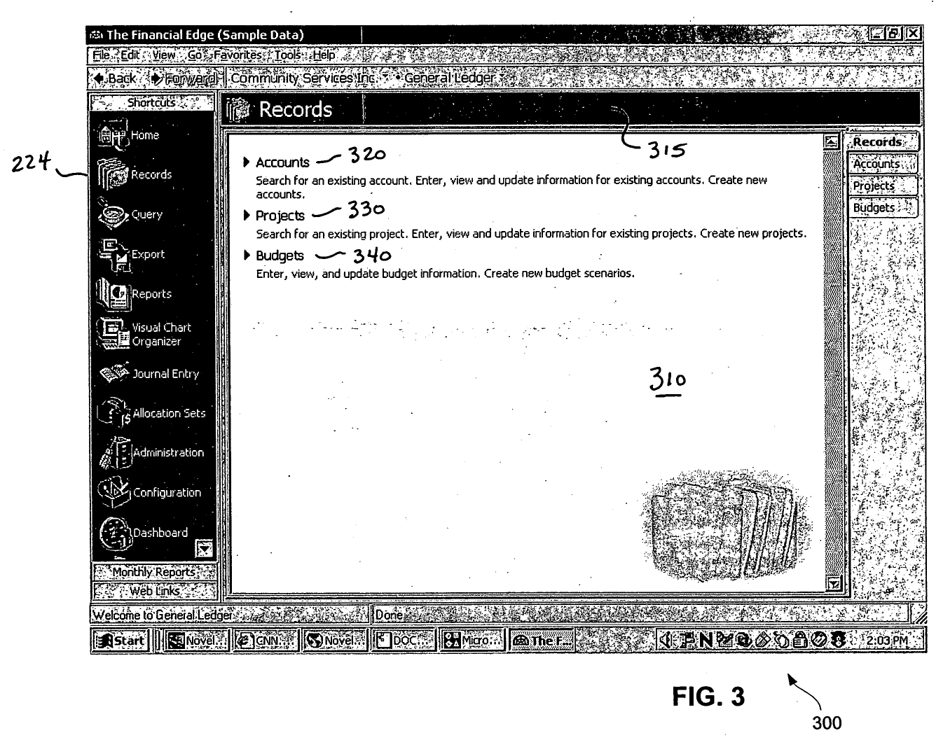

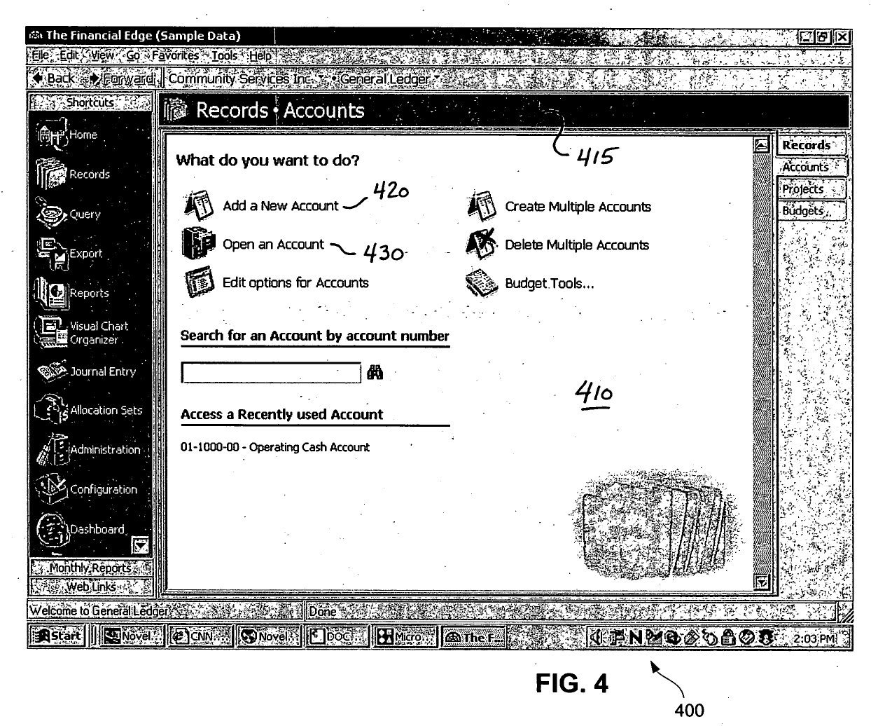

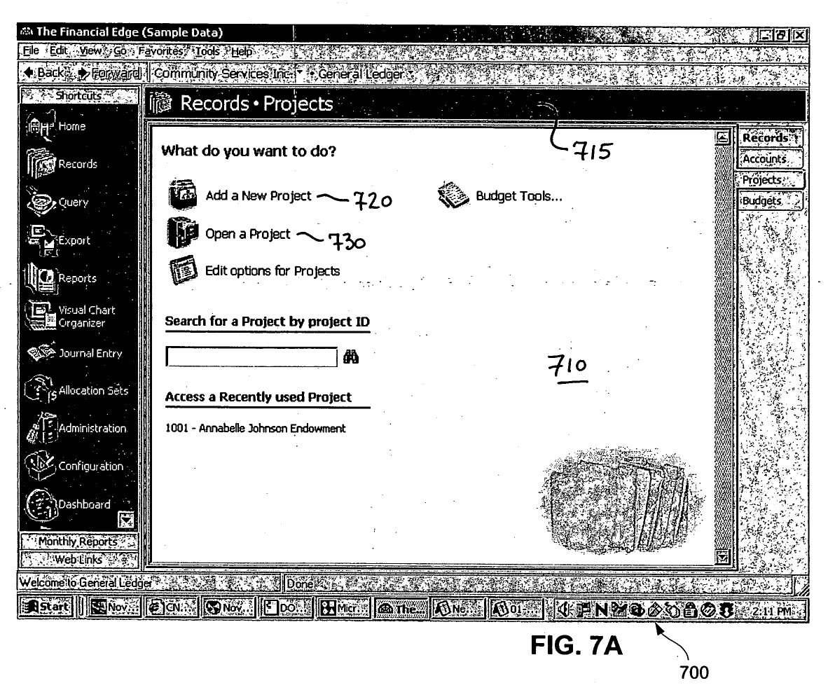

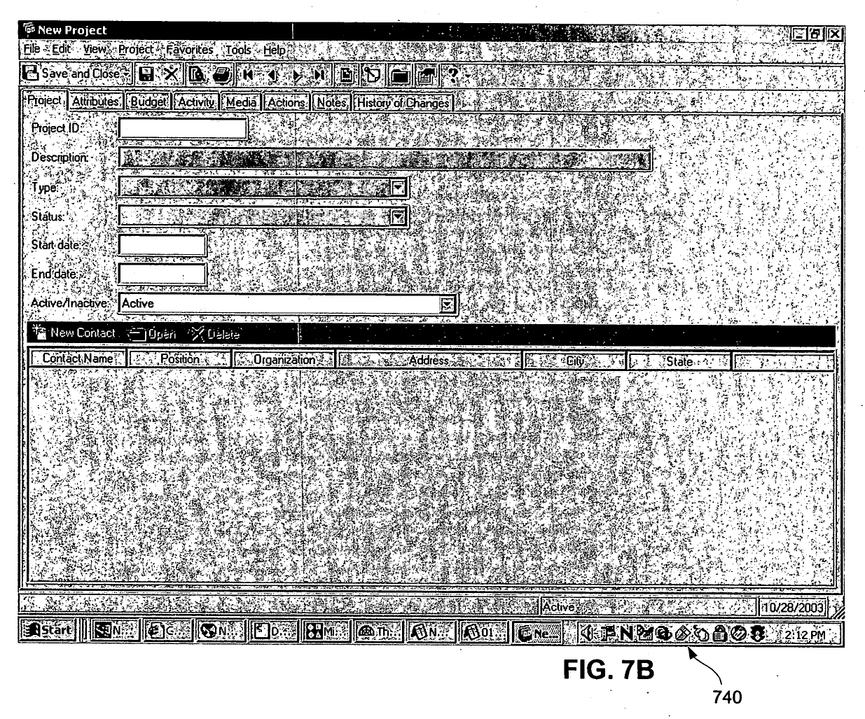

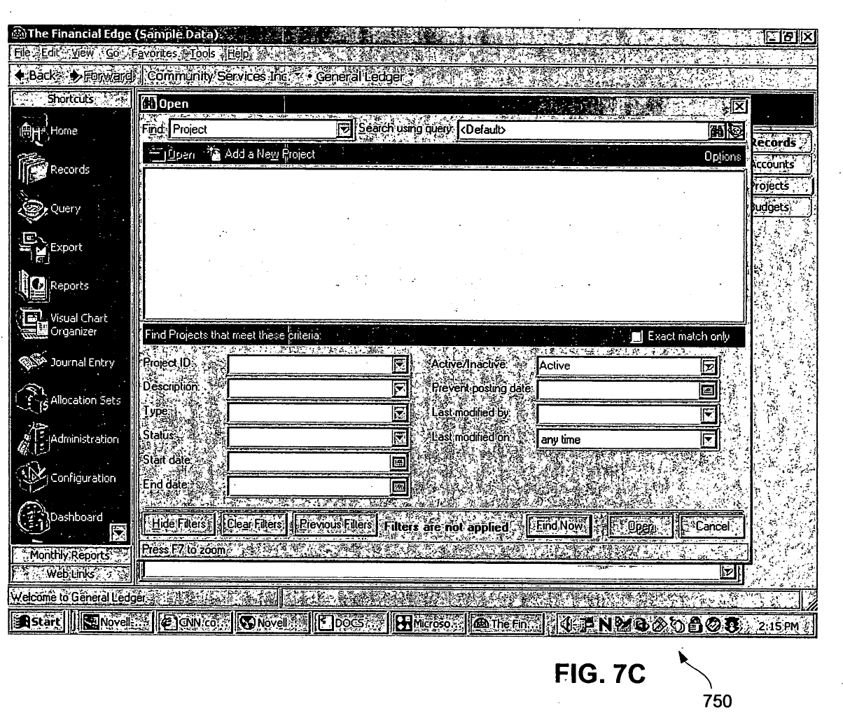

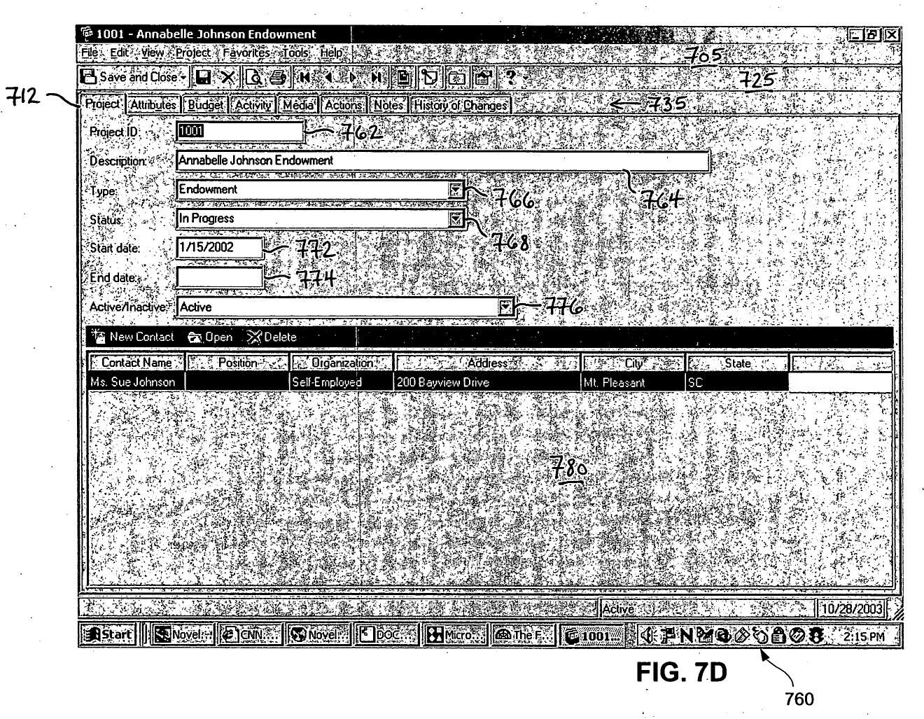

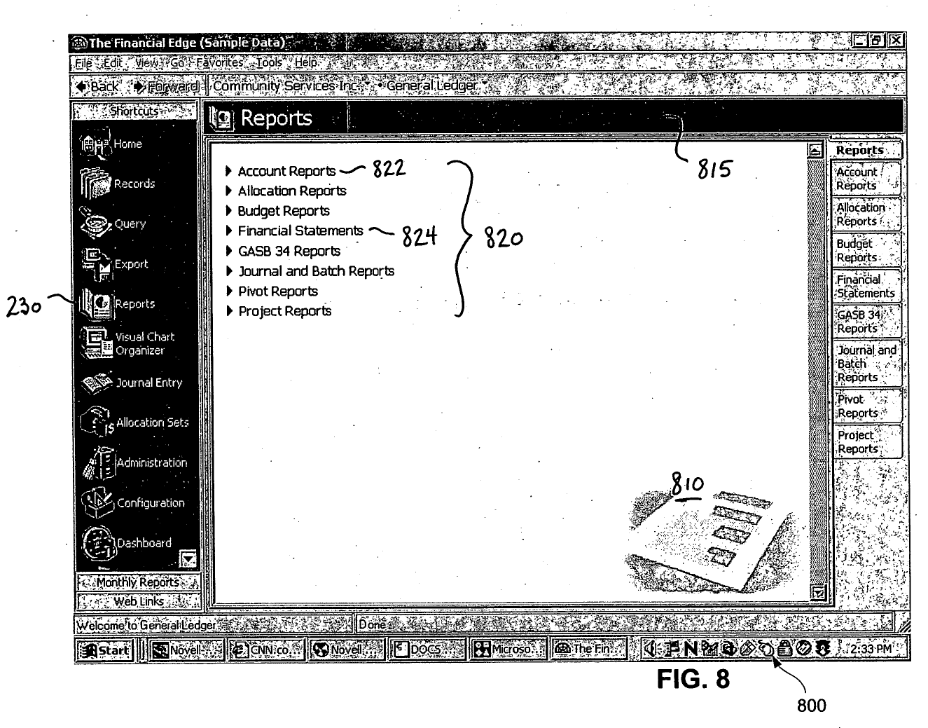

As shown in FIG. 3, when the records 224 hyperlink is activated, the records start page 300 is displayed in display area 310, as confirmed by the title displayed in the title bar 315. Preferably, users are able to access their account, project, and budget records from this records start page 300. Correspondingly, this page 300 contains links 320, 330, 340 to the accounts page (see FIG. 4), the projects page (see FIG. 7), and the budgets page (not illustrated), respectively.

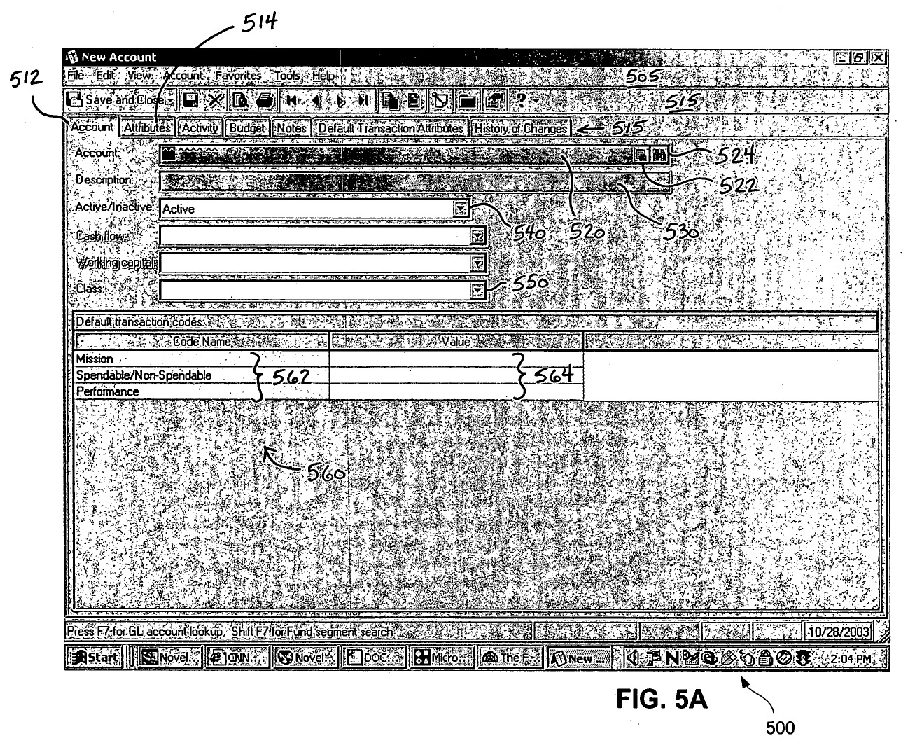

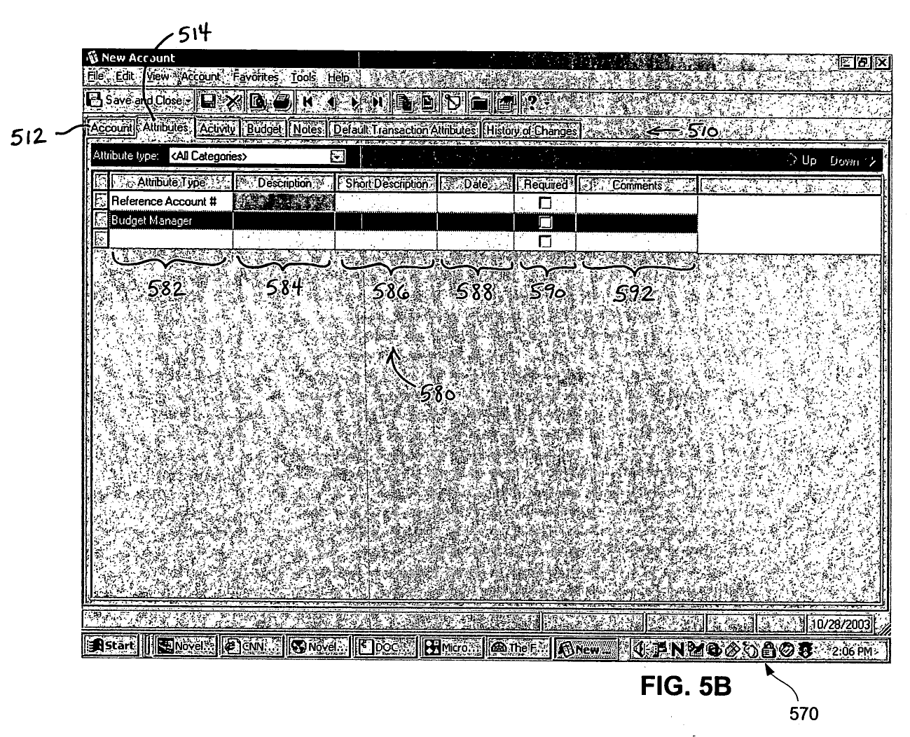

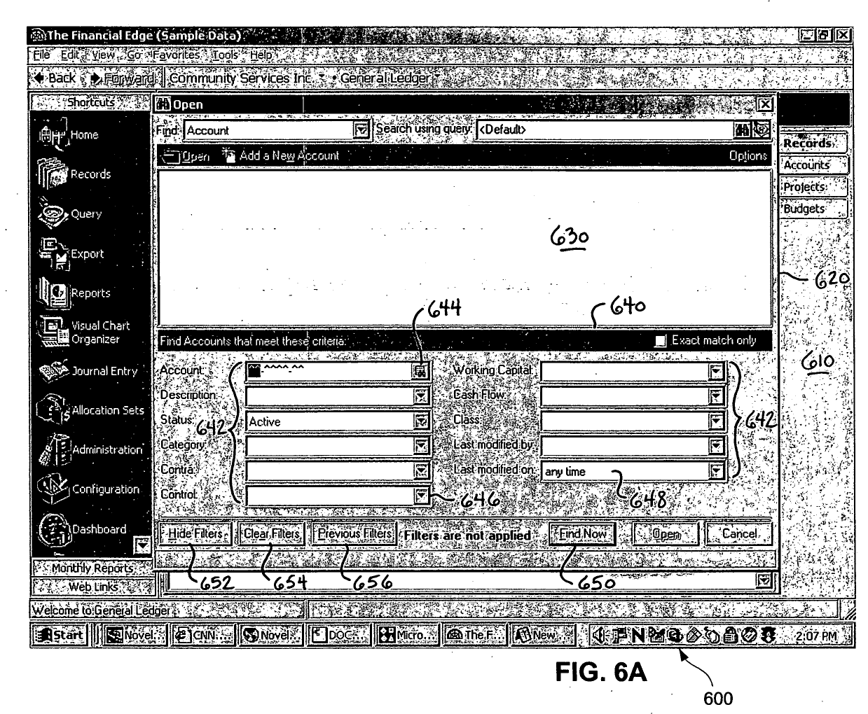

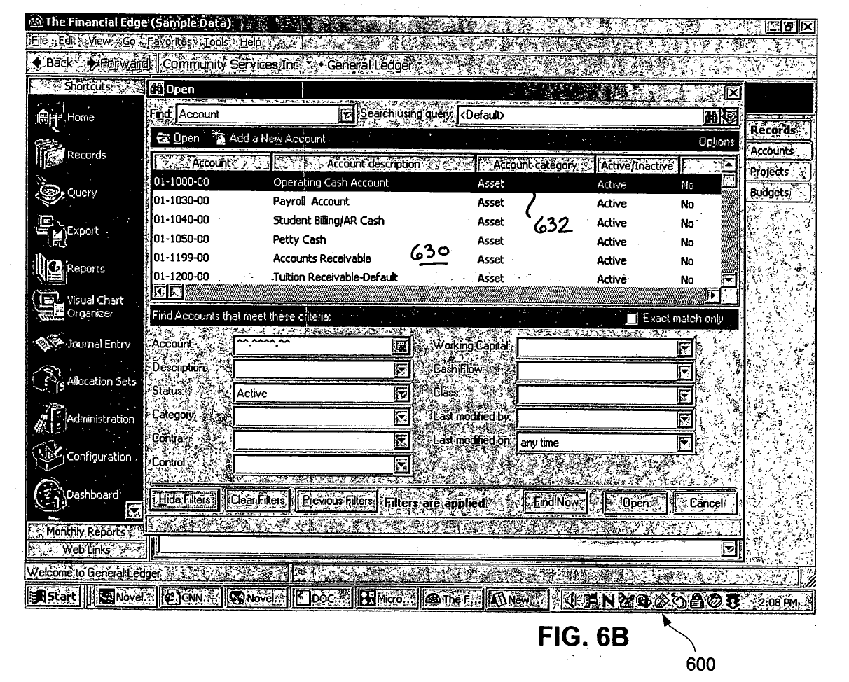

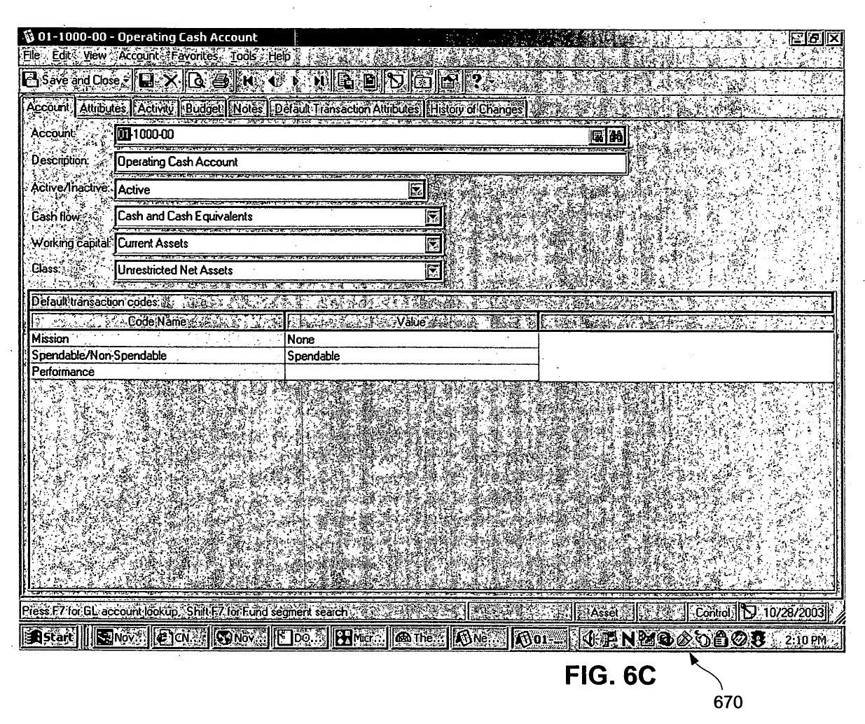

Turning now to FIG. 4, an account start page 400 is displayed in display area 410, with its title displayed in title bar 415. From this account start page 400, users access a “new account” page by activating link 420 (see FIGS. 5A-5B) or access an “existing account” by activating link 430 (see FIG. 6).

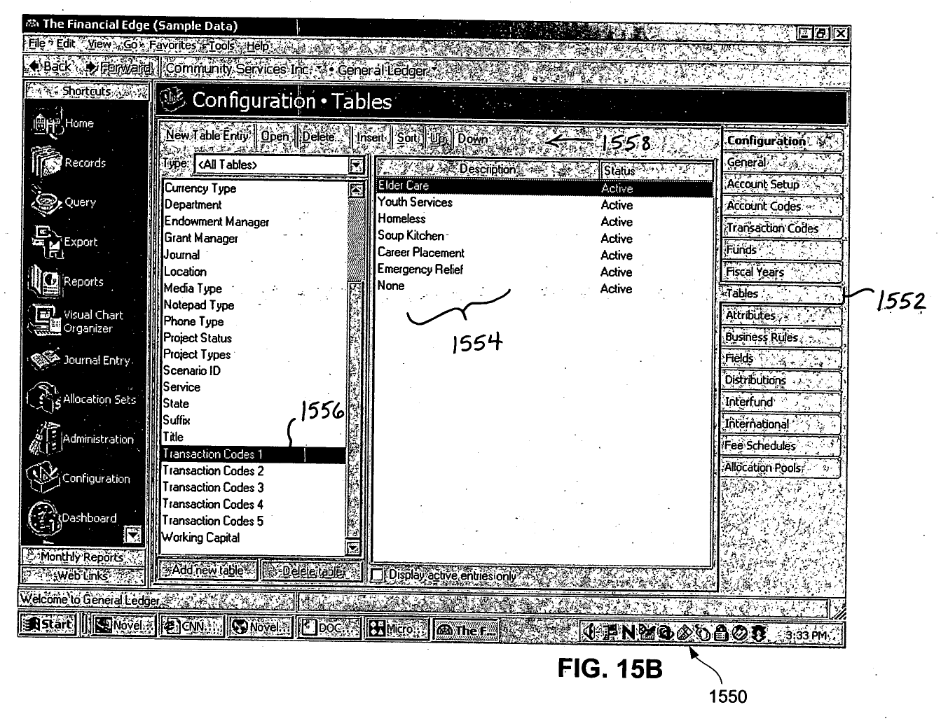

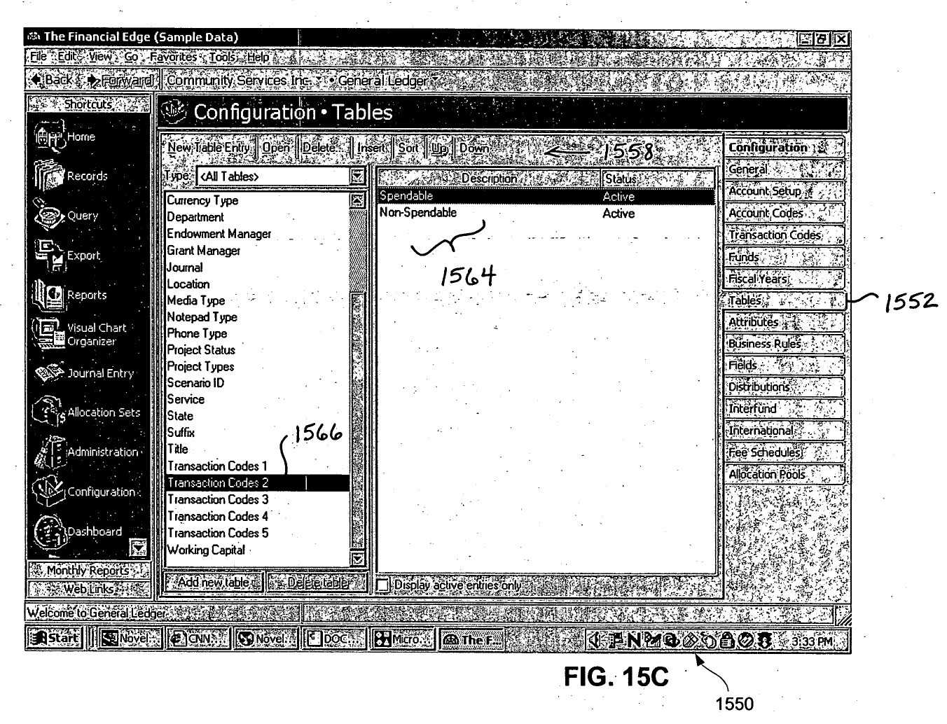

With reference first to FIG. 5A, the new account page or window 500 is preferably displayed as a separate window from the display area 410 of the previous account start page 400. The new account page 500 enables the user to create a new account, to define its characteristics, and to begin to associate data therewith. The new account page 500 includes a conventional menu bar 505 and tool bar 515. The new account page 500 also is divided into a number of “tabbed” sub-pages, as shown by the plurality of tabs 510 below the tool bar 515. These tabbed sub-pages preferably include a general account information page, an attributes page, an activity page, a budget page, a notes page, a default transaction attributes page, and history of changes page—some of which are described in greater detail hereinafter. Generally, these tabbed sub-pages provide data input fields and locations in which the user can define, characterize, and describe the account. These tabbed sub-pages also provide further information about the account that is generated and updated automatically by the system and viewable by the user. As shown, the new account page 500 defaults to the general account information sub-page, indicated by tab 512. This account information sub-page includes a plurality of fields, including account number field 520 that enables the user to input an account number for the new account 520. The account number can be typed directly into field 520 or the user can select an available account number after accessing an account code segment look-up table (by activating button 522) or an account number look-up table (by activating button 524). This sub-page also includes a description field 530, into which the user can type in a preferred written description of the new account. The account information sub-page further includes an active/inactive status line 540, a class description 550, and a transaction tracking code table 560. As stated previously, available class descriptions for the new account include: (i) unrestricted, (ii) temporarily restricted, and (iii) permanently restricted. The transaction tracking codes 562 shown in transaction tracking code table 560 are definable by the user (in system configurations, discussed hereinafter in association with FIGS. 15A-15C) and enable the user to define what transaction codes will be usable for transactions associated with this particular account. In fields 564, the user is able to specify a “default” value, if desired, for each transaction tracking code 562. Such default values will automatically be used whenever this account is later referenced; however, the user always has the option of over-riding such defaults values as necessary.

By activating tab 514, the user is taken to the attribute sub-page 570, illustrated in FIG. 5B, which includes an attributes input table 580. This table 580 enables the user to define attributes, such as reference account number and budget manager, associated with this new account. The table 580 includes data columns for attribute types 582, long description 584, short description 586, date 588, whether the attribute type is required 590, and any additional comments 592 relevant to the attribute type. Although not discussed herein because it is beyond the scope of the present invention, those skilled in the art will appreciate and understand the additional account information that may be input and displayed on the additional sub-pages shown by tabs 510.

By activating link 430 in FIG. 4, the user is presented with a search screen 600, as shown in FIG. 6A, from which the user initiates a search to find an existing account for viewing and/or further editing. The search screen 600 may be displayed within display area 610 or as a separate window 620 (as shown), which, in this case, allows a larger screen area to be used than is available in the display area 610. The window 620 includes two primary sections: a search results display area 630 and a filter area 640. Before any searches have been run, the search results display area 630 is empty, as shown. The filter area 640 includes a plurality of fields 642 in which the user can specify particular search parameters. Each of the fields includes a look-up table 644 or a pull-down menu option 646, and a text entry area 648 in which a search term(s) is typed. Once at least one search parameter is input by the user, an account search is initiated by activating or selecting the “find now” button 650. Depending upon the search parameters, no accounts may be found or one or more accounts may be found and listed in display area 630, as shown in FIG. 6B. To increase the viewable size of the display area 630, the user selects button 652 to “hide filters.” The user is able to clear or reset all previous search parameter fields 642 by selecting button 654 to “clear filters.” The user is also able to display search results from a previous search by selecting the “previous filters” button 656. Turning briefly to FIG. 6B, by selecting or “double clicking” on one of the accounts 632 found during a search and displayed in area 630, an account detail page is then displayed. The account detail page 670, associated with account 632 from FIG. 6B, is illustrated in FIG. 6C. The account detail page 670 is essentially the same as the new account page 500 from FIG. 5A except all of the data fields and account details are populated with information already associated with or input into the account record.

By activating the “projects” link 330 from FIG. 3, the user is presented with a project start page 700, as shown in FIG. 7A. The project start page 700 is displayed in display area 710, as indicated by title bar 715. From this project start page 700, users access a “new project” page by activating link 720 or access an “existing project” page by activating link 730. The new project page 740, illustrated in FIG. 7B, is set up in a format quite similar to the new account page 500 from FIG. 5A but with data fields that are relevant to projects (e.g., Project ID, project type, project status, start and end dates, etc.) rather than to accounts. Project types include grants, endowments, member projects, service projects, and similar types that are user-definable. Project status include “in progress,” “pending application,” “closed,” and the like, again, which are user-definable. FIG. 7C illustrates a find projects search screen 750, which is accessed by activating link 730 on FIG. 7A. The project search screen 750 is very similar in format and function to the account search screen 600 from FIG. 6A. An actual project detail page 760 is illustrated in FIG. 7D. Similar to an account detail page, the project detail page 760 includes a conventional menu bar 705 and tool bar 725. The project detail page 760 is also divided into a number of “tabbed” sub-pages, as shown by the plurality of tabs 735 below the tool bar 725. These tabbed sub-pages preferably include a general project information page, an attributes page, an activity page, a budget page, a media page, an actions page, a notes page, and history of changes page. These sub-pages provide data input fields and locations in which the user can define, characterize, and describe the project. These sub-pages also provide further information about the project that is generated and updated automatically by the system and viewable by the user. As shown, the project detail page 760 defaults to the general project information sub-page, indicated by tab 712. This project information sub-page includes a plurality of fields, including project ID 762, project description 764, project type 755, project status 768, start date 772, end date 774, active/inactive status bar 776, and a project contact list 780.

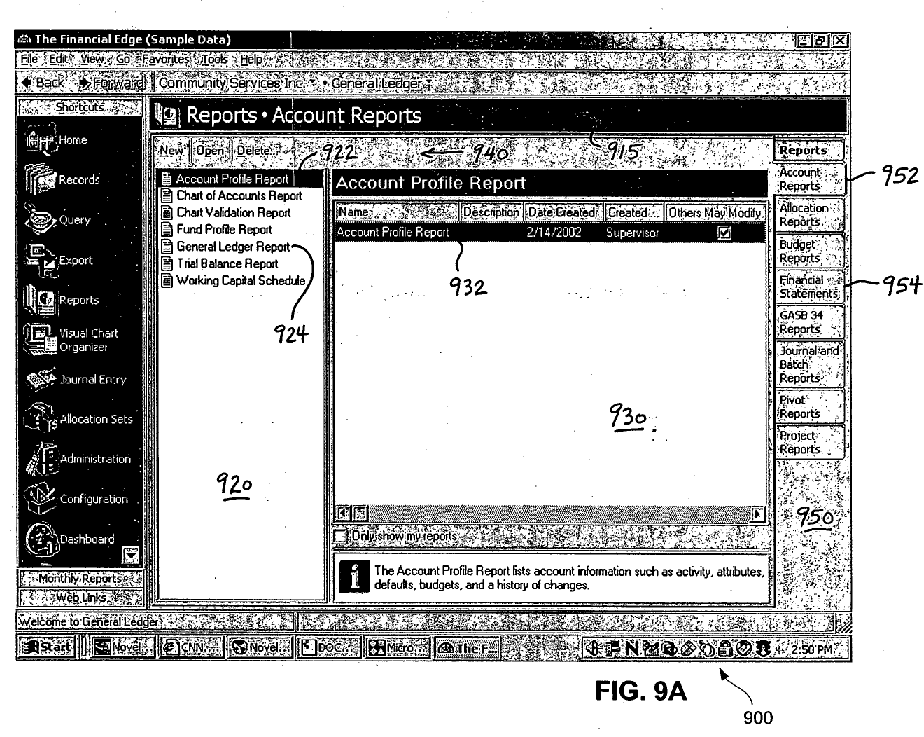

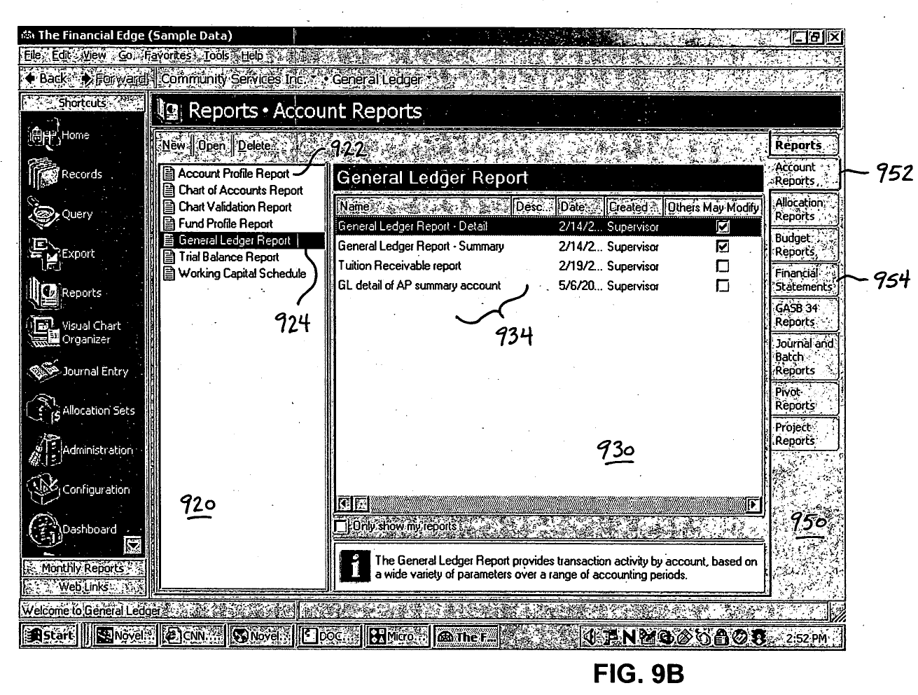

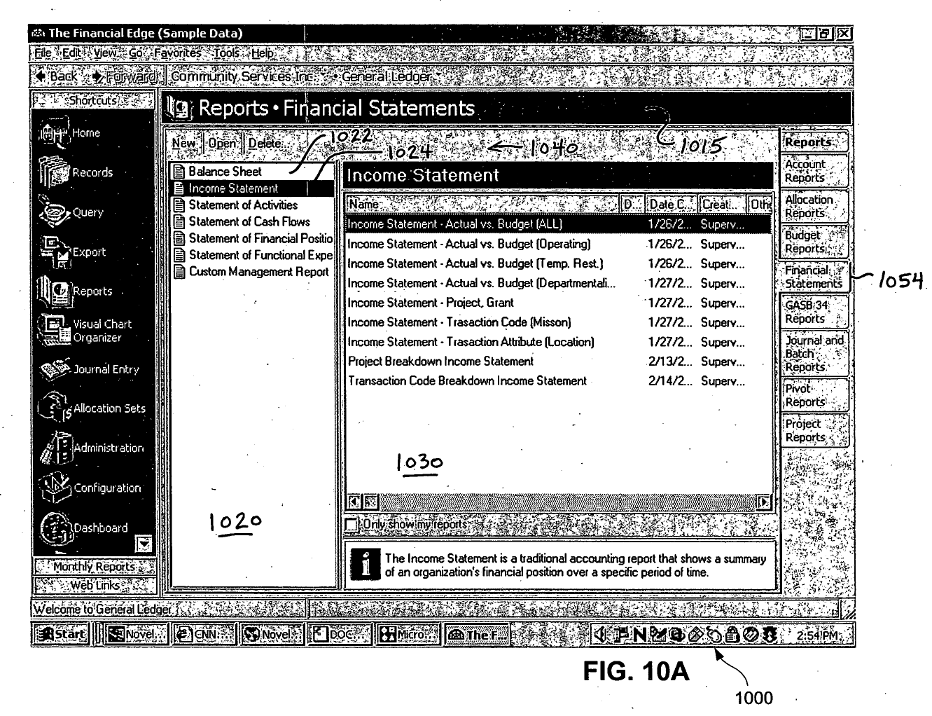

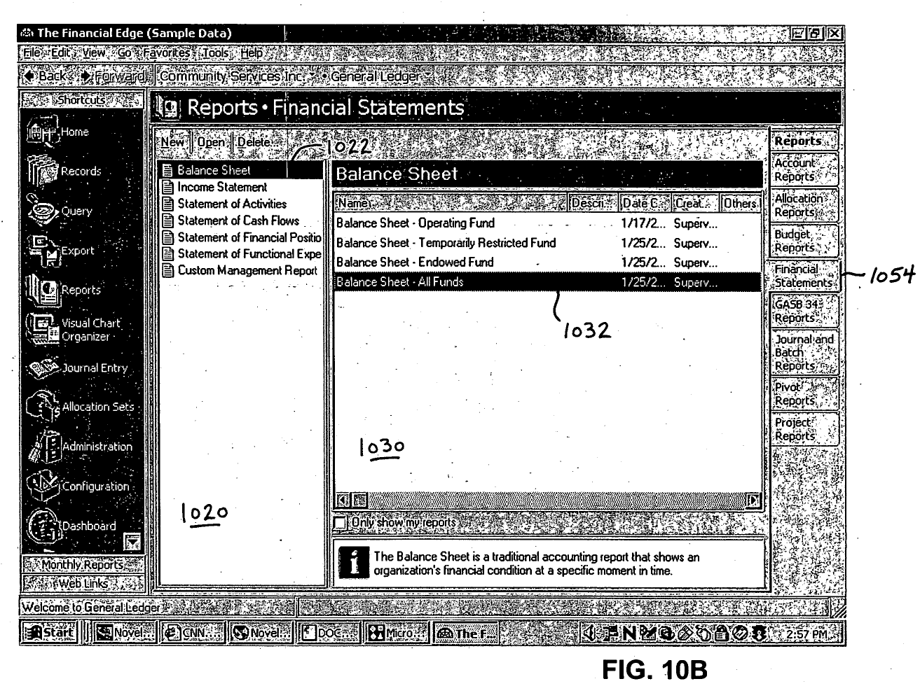

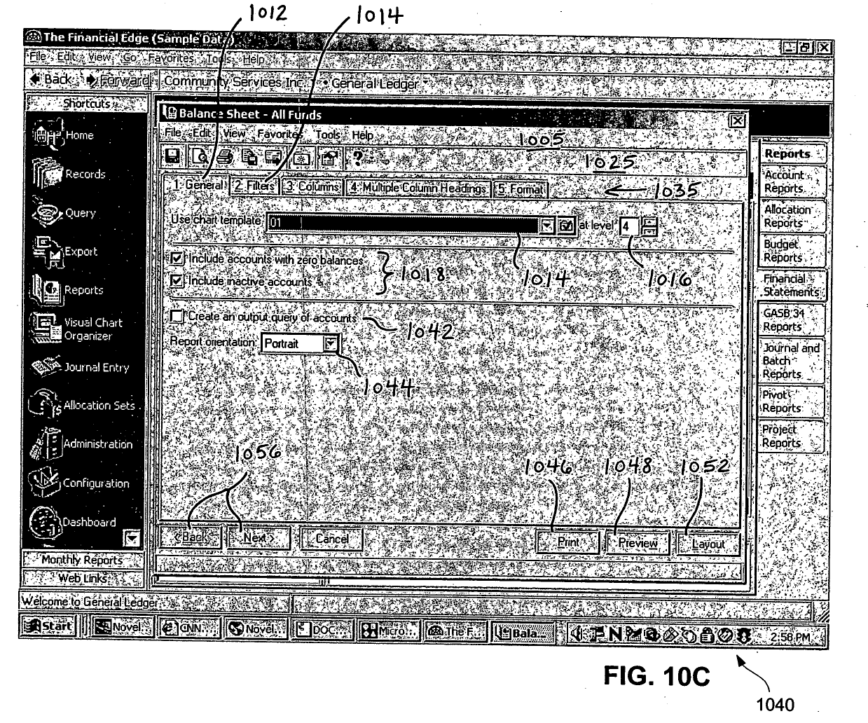

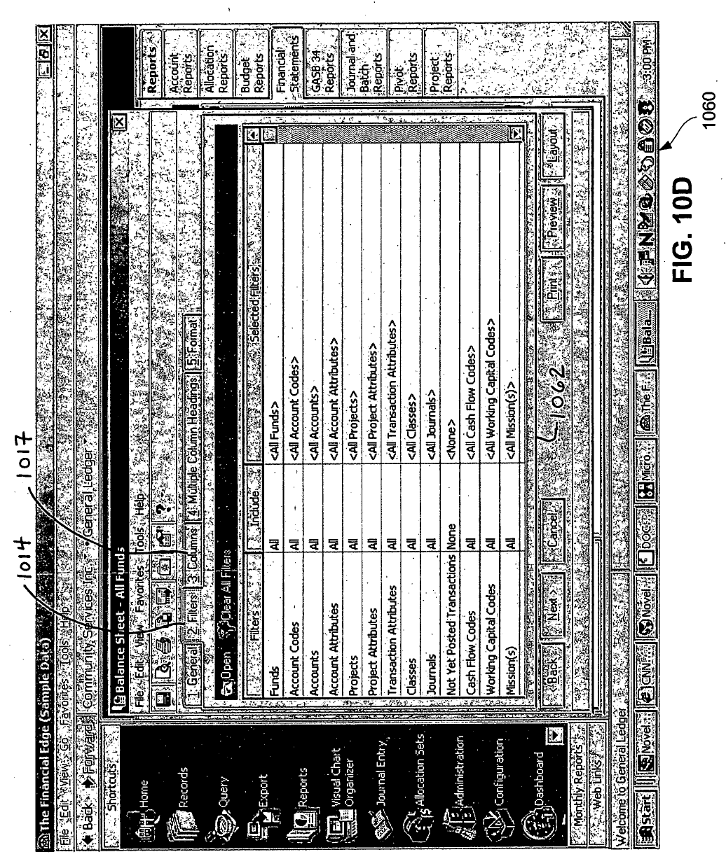

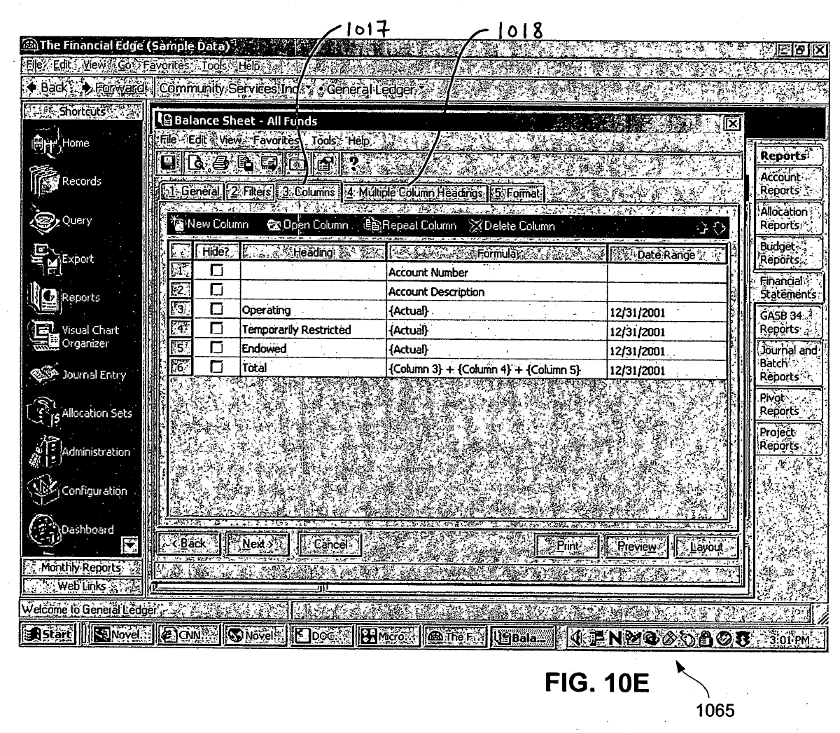

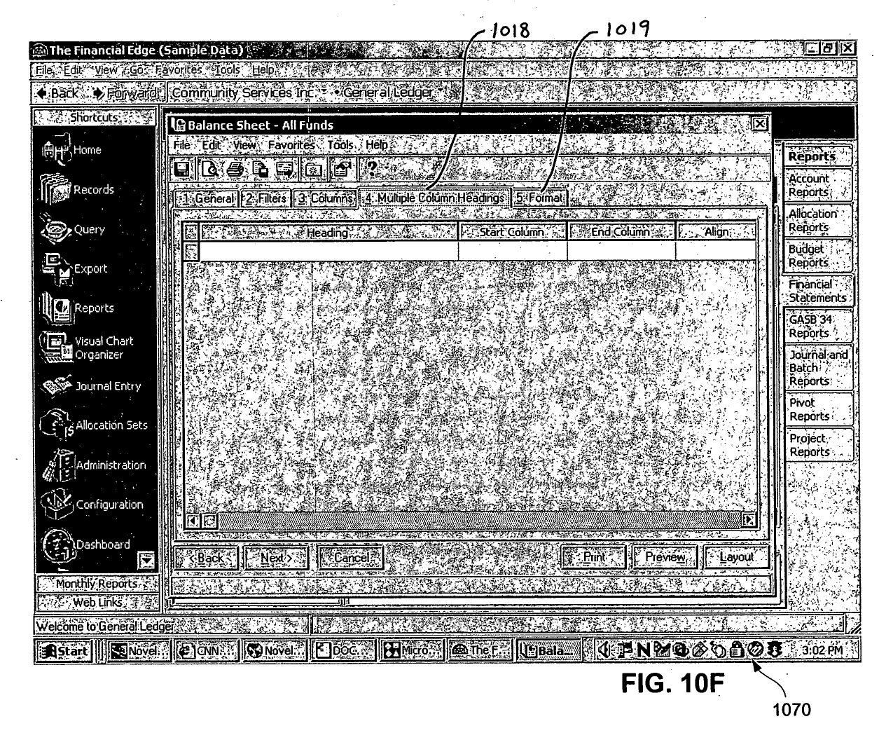

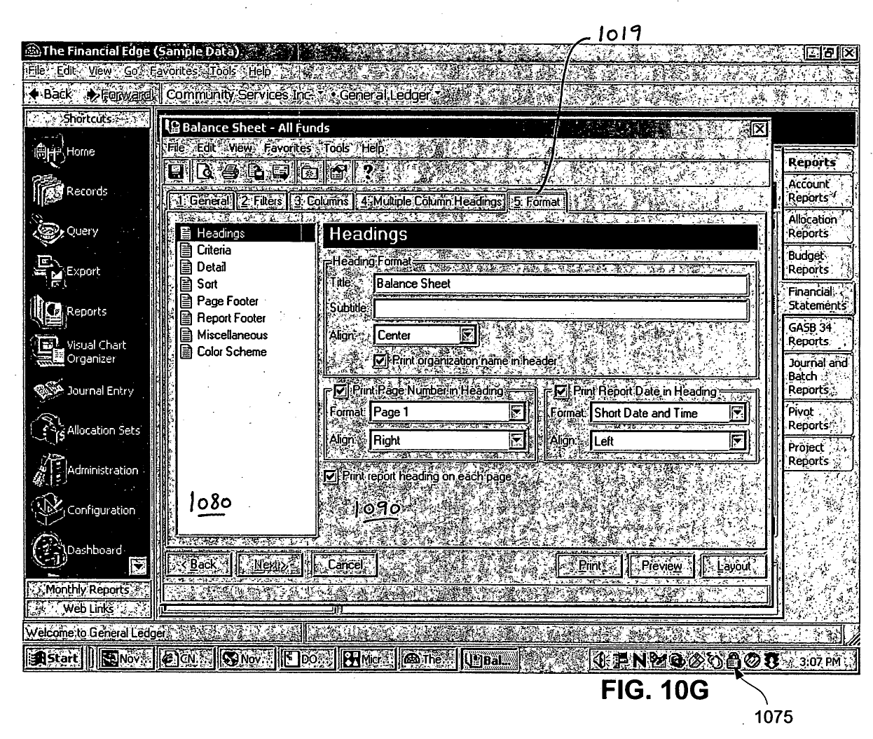

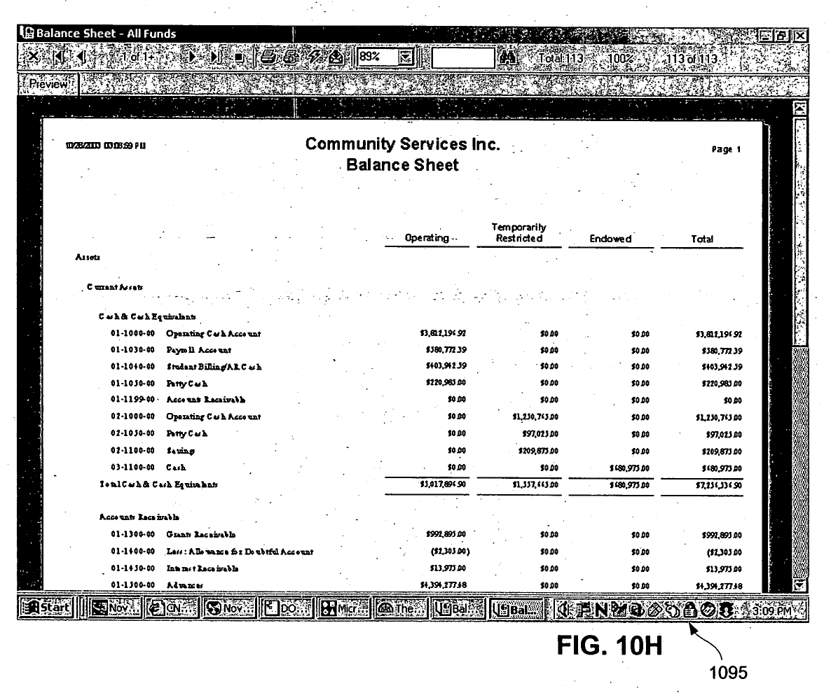

By activating the reports link 230, a reports start page 800 is displayed in display area 810, as indicated by title bar 815 in FIG. 8. The reports start page 800 includes a plurality of links 820 to specific reports pages. For example, by activating the account reports link 822, an accounts reports main page is opened in display area 810 (see FIGS. 9A-9B). By way of another example, by activating the financial statements link 824, a financial statement reports main page is opened in display area 810 (see FIGS. 10A-10H). It should be understood that from this reports start page 800, users are able to generate financial statement reports using visual chart templates that have already created. The process for creating visual chart templates will be discussed in greater detail hereinafter.

Turning first to FIG. 9A, the accounts reports main page 900 is illustrated. This page 900 is divided into a number of different sections or windows. For example, the accounts reports main page 900 includes a title bar 915, a list of available account report types in area 920, a list of specific reports available for each report type in area 930, and a control bar 940. The list of report types shown in area 920 are conventional or standard to accounting systems; however, the user is able to create or define new types if desired. By activating any one of the report types listed in area 920 (for example by double clicking the report type or by single clicking the report type and then selecting the open button in area 940), a list of all previously created reports of that type is displayed in area 930. As shown, the account profile report type 922 has been activated and the one specific report available for the account profile report type, account profile report 932, is listed in area 930. To view this report 932, the user double clicks on the report 932 or selects the report 932 and activates the open button in area 940. The user can also delete the report 932 in similar manner by activating the delete button in area 940. Tab area 950, on the right side of the screen, includes tabs to the same reports pages that were previously displayed as links 820 in display area 810 from FIG. 8. As shown by the prominence of tab 952 in FIG. 9A, the user is currently viewing the accounts reports main page 900.

By selecting or activating the link for the general ledger report type 924 in area 920, all available general ledger reports are then listed in area 930, as shown in FIG. 9B. As shown, a plurality of specific general ledger reports 934 are currently available for viewing by the user.

By selecting tab 954 on FIGS. 9A,9B or by activating link 824 on FIG. 8, the user is taken to the financial statements reports main page 1000, as shown in FIG. 10A. Similar to account reports main page 900, the financial statements reports main page 1000 is divided into a number of different sections or windows, including a title bar 1015, a list of available financial statement report types in area 1020, a list in area 1030 of the specific reports available for the respective financial statement report type currently selected in area 1020, and a control bar 1040. The list of report types shown in area 1020 are conventional or standard to accounting systems; however, once again, the user is able to create or define new types as desired. By activating any one of the report types listed in area 1020, a list of all previously created reports of that type is displayed in area 1030. As currently shown, the income statement report type 1024 has been activated and the list of specific reports available for the income statement report type 1024 is shown in area 1030. As shown by the prominence of tab 1054, the user is currently viewing the financial statements reports main page. By activating the balance statement report type 1022, a list of specific reports available for the balance sheet report type 1022 is shown in area 1030 of FIG. 10B.

By activating or selecting a specific balance sheet report, such as the “balance sheet—all funds” report 1032, the user is presented with a reports setup window 1040 as shown in FIG. 10C. The reports setup window 1040 includes a conventional menu bar 1005 and tool bar 1025. The reports setup window 1040 is also divided into a number of “tabbed” sub-sections, as shown by the plurality of tabs 1035 below the tool bar 1025. These tabbed sub-sections preferably include a general setup section, a filters setup, a columns setup, a multiple columns headings setup, and a format setup. These sub-sections enable the user to define how the particular report will be displayed or printed by the system. In particular, the general and filter tabbed subsections enable the user to specify generally what row information will be included in the particular report. The columns and multiple columns tabbed sub-sections enable the user to specify generally what column information will be included in the particular report. The format tabbed sub-section enables the user to provide general formatting options for the overall report.

In particular, as shown in FIG. 10C, the reports setup window 1040 defaults to the general setup section, indicated by tab 1012. This general setup section includes a plurality of fields, including a use chart template field 1014 that includes a pull-down menu for ease in selecting an available chart template. The user is able to specify what headers, accounts, and total will be displayed in the report based on which chart template is selected. The general setup section also includes a level specifier 1016 that determines how many levels (as discussed hereinafter) of the selected chart template will be used to generate the report. Two check boxes 1018 enable the user to select whether or not the report will include accounts with zero balance and inactive accounts. Check box 1042 enables the user to select whether or not an output query of accounts will be created. Report orientation (portrait or landscape) is selectable in field 1044. At any time, the user is able to print the report by selecting the “print” button 1046, to preview the report by selecting the “preview” button 1048, and access a layout editor by selecting the “layout” button 1052. The layout editor is similar to the print preview function, however, it provides for a quicker preview because it does not access real-time data or run calculations to populate the numeric columns of the report. For further editing options, the user selects one of the other tabs 1035 or the back or next buttons 1056 to move to the previous or following tab next to the currently selected one.

The filters setup section 1060, indicated by tab 1014, is illustrated in FIG. 10D. This filters setup section 1060 includes a table 1062 in which the user selects what information to include or exclude from the report. As can be seen from the table 1062, almost any piece of information maintained by the accounting system associated with accounts can be used to filter a report. Filters are basically used in this context to reduce or minimize the amounts of information and particular accounts that would otherwise appear in the report based on the selected chart template.

The columns setup section 1065, indicated by tab 1017, is illustrated in FIG. 10E, in which the user specifies how many columns will be included in the report, what headings, if any, will be shown, what information or data will be displayed (e.g., what formulas will be used to generate the numeric data for that column, if any), and the date range of data that will be included in such numeric data. The multiple column headings section 1070, as indicated by tab 1018 of FIG. 10F, enables the user to specify the size and alignment of multi-column headers, if any, that will appear above selected columns previously defined in FIG. 10E.

FIG. 10G illustrates the format setup section 1075, as indicated by tab 1019. The format setup section 1075 includes two primary windows, a topic display window 1080 and a detailed display window 1090. The topic display window 1080 enables the user to specify formats for headings, criteria, detail, sorting, page footers, report footers, miscellaneous (such as how to display negative numbers, percentages, number of decimals, font size, and the like), and color scheme (for on-screen display or print-offs to color printers). Finally, FIG. 10H illustrates a top portion of an example print preview 1095 for a report that has been configured by the user (using the settings shown in FIGS. 10B through 10G).

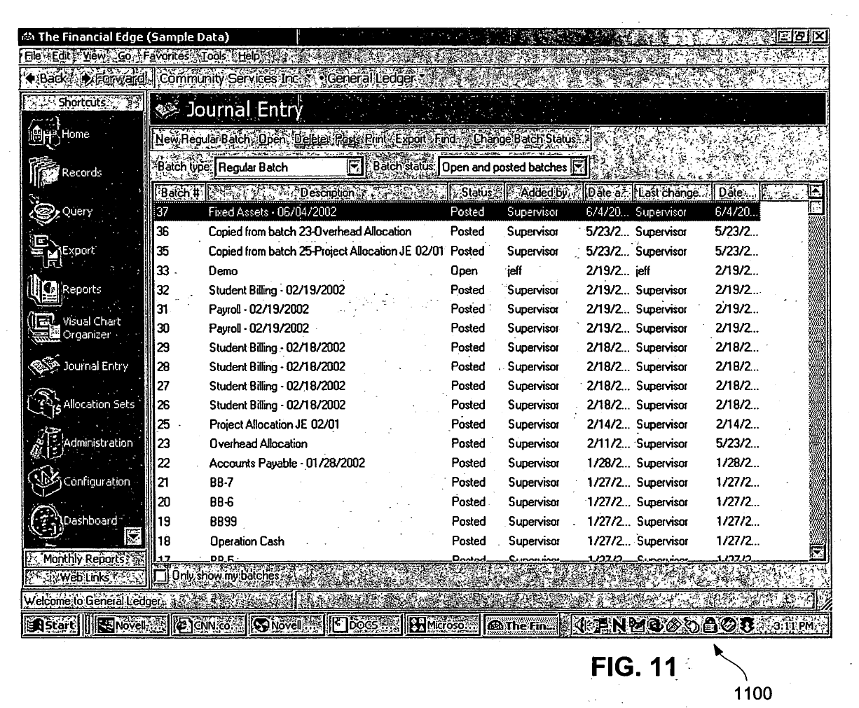

A conventional journal entry page 1100 is illustrated in FIG. 11. This page is accessed by activating the journal entry link 234 from FIG. 2. Those skilled in the art will understand and appreciate the various options for entering specific transactions into the accounting system using such a journal entry interface.

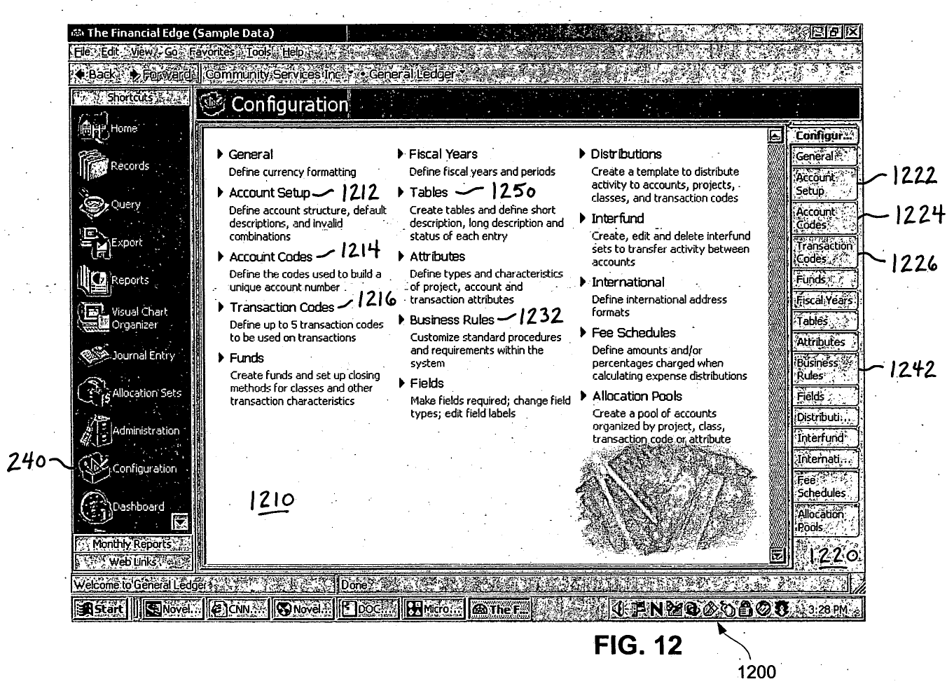

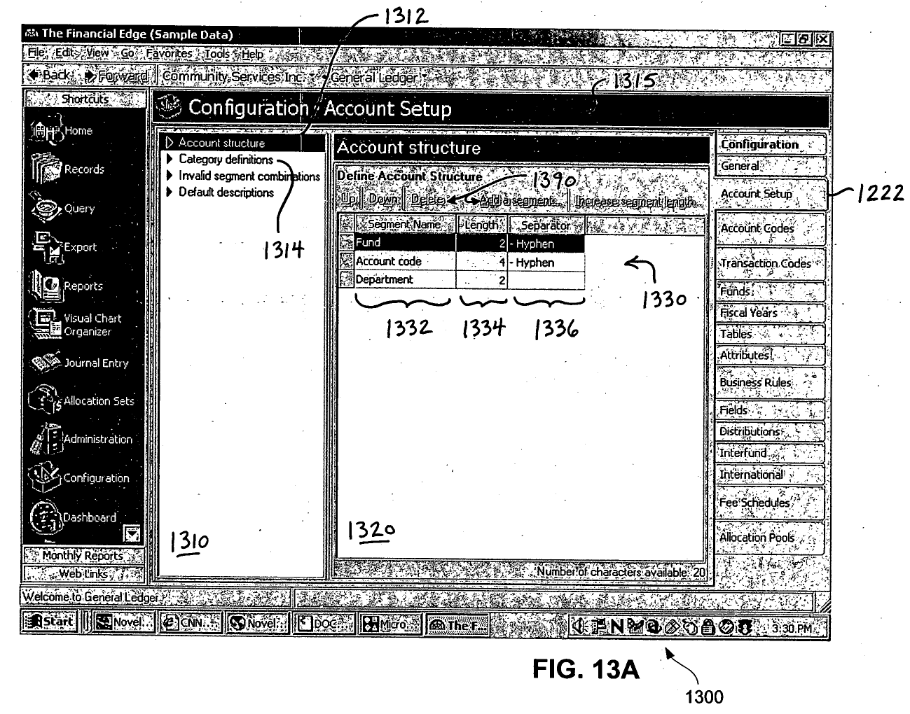

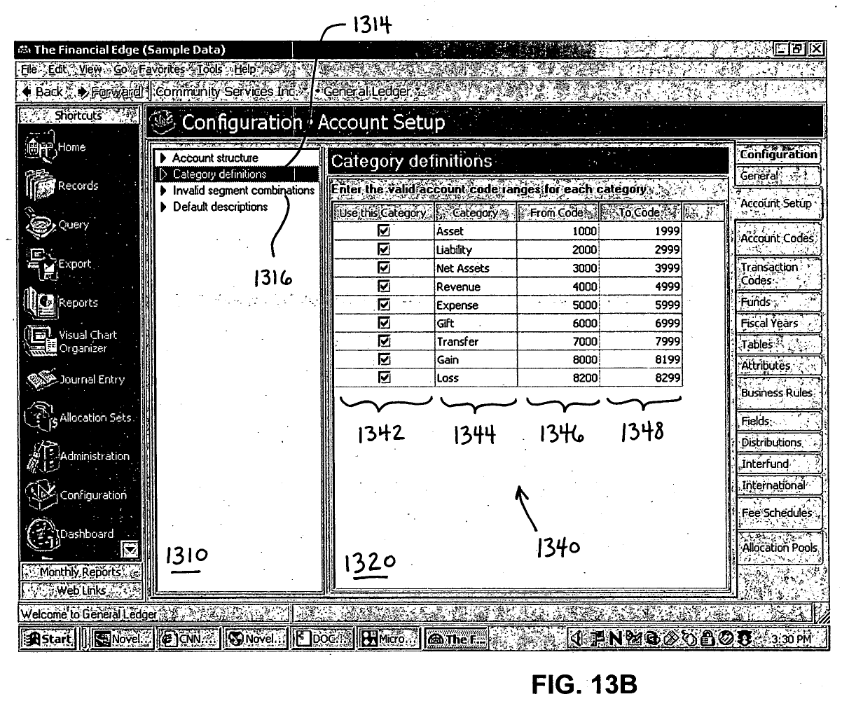

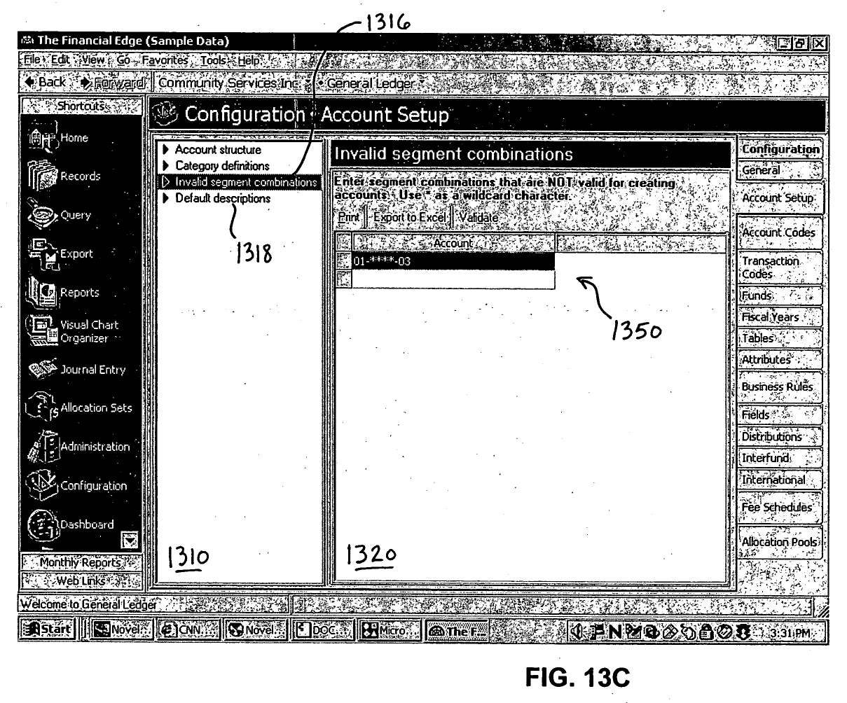

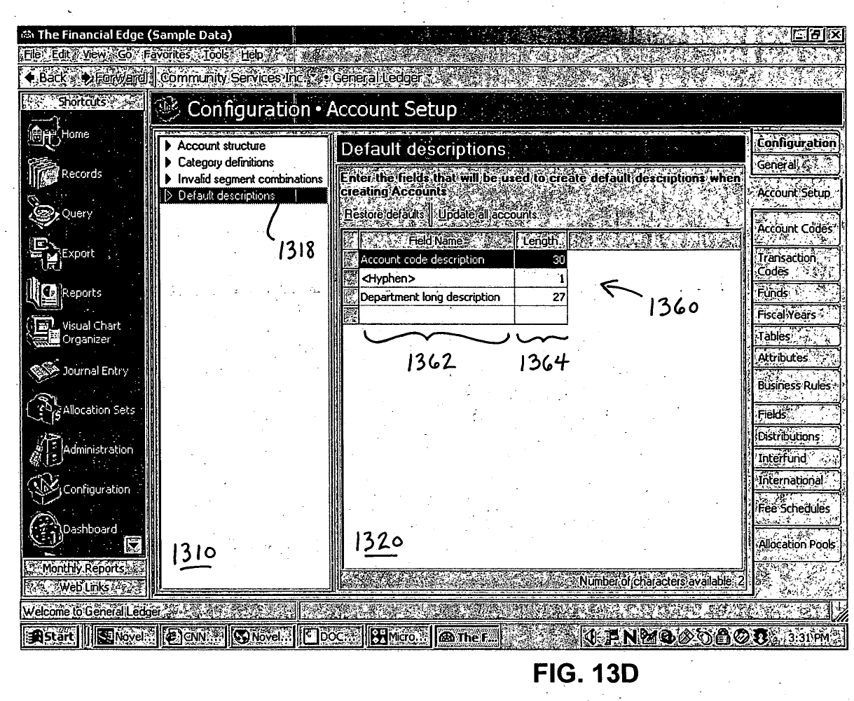

A system configuration main page 1200 is illustrated in FIG. 12. This page is accessed by activating the configuration link 240 from FIG. 2. The system configuration main page 1200 includes a number of links in display area 1210, with corresponding tabs accessible in tab area 1220. By selecting or activating the account setup link 1212 or account setup tab 1222, the user is taken to an account setup main page 1300, as shown in FIG. 13A.

The account setup main page 1300 of FIG. 13A includes a title bar 1315, a primary topic area 1310, and a specific configuration input area 1320. The tab area 1220 from FIG. 12 is still viewable and accessible to the user on the right side of the screen. As shown, the user is permitted to define the account structure to be used by the accounting system by selecting the account structure link 1312 in area 1310, which then displays a table of options 1330 for the user in configuration input area 1320. Specifically, for account structure, the user specifies each account segment 1332 to be used to define accounts in the system, the length 1334 of each segment, meaning the number of alphanumeric characters that segment includes, and what type of separator 1336 (if any) will follow each segment. As has been stated previously, the user is able to arrange the order of the segments, determine how many segments will be used, determine which segments will be used, and otherwise customize accounts numbers used by the accounting system as desired by the organization using this system using controls 1390. The account structure must include at least one segment, which is preferably the account code. The “fund” account segment will also be used in most embodiments. Additional account segments, such as department, location, and other user-definable segments, are also available.

By activating the category definitions link 1314 in area 1310, an account category definition table 1340 is displayed in area 1320, as shown in FIG. 13B. The account category definition table 1340 preferably includes four columns of information. In column 1344, the nine standard account category types used by not-for-profit organizations are listed. These standard account categories include asset, liability, net assets, revenue, expense, gift, transfer, gain, and loss. The user is able to specify, by selecting or deselecting any of the check boxes in column 1342, which of the standard account categories will be used in the accounting system. In the preferred embodiment, assets, liabilities, net assets, revenue, expense, and transfer are required account categories—the others are optional and may be included or excluded using the check boxes in column 1342. Columns 1346 and 1348 are used to define the range of account codes associated with each account category. As shown, the current account codes use four digits—this corresponding to the length 1334 of the account code segment from FIG. 13A. Thus, the number of available accounts codes usable by the system hinge on the user's selection of the account code length from FIG. 13A. The system will automatically input preferred ranges for each account category; however, the user is free to modify these ranges as desired. For the system to operate in preferred manner (and to provide for the best functionality for the visual chart organizer, described hereinafter), there should be no overlap in account codes between any two account categories. Although not required, it is also preferable that there not be any gaps in account codes between account categories.

By activating the invalid segment combination link 1316 in area 1310, an invalid segment combination table 1350 is displayed in area 1320, as shown in FIG. 13C. The invalid segment combination table 1350 preferably includes one or more fields into which the user specifies what segment combinations are not permissible by the system. For example, as shown in the one entry of FIG. 13C, fund 01 cannot be associated with department 03 regardless of the type of account and regardless of the specific account number used (as indicated by the **** wildcard characters). As should be readily apparent, there are an infinite number of specific invalid segment combinations that can be defined by the user—as desired or needed by the particular organization using the accounting system.

By activating the default descriptions link 1318 in area 1310, a default account descriptions table 1360 is displayed in area 1320, as shown in FIG. 13D. The default account descriptions table 1360 preferably includes columns of information that enable the user (i) to specify fields 1362 that will be used to create default descriptions for any account created by the user or created automatically by the system (when necessary and when permitted by the user in the system configurations) and the length 1364 of each such field.

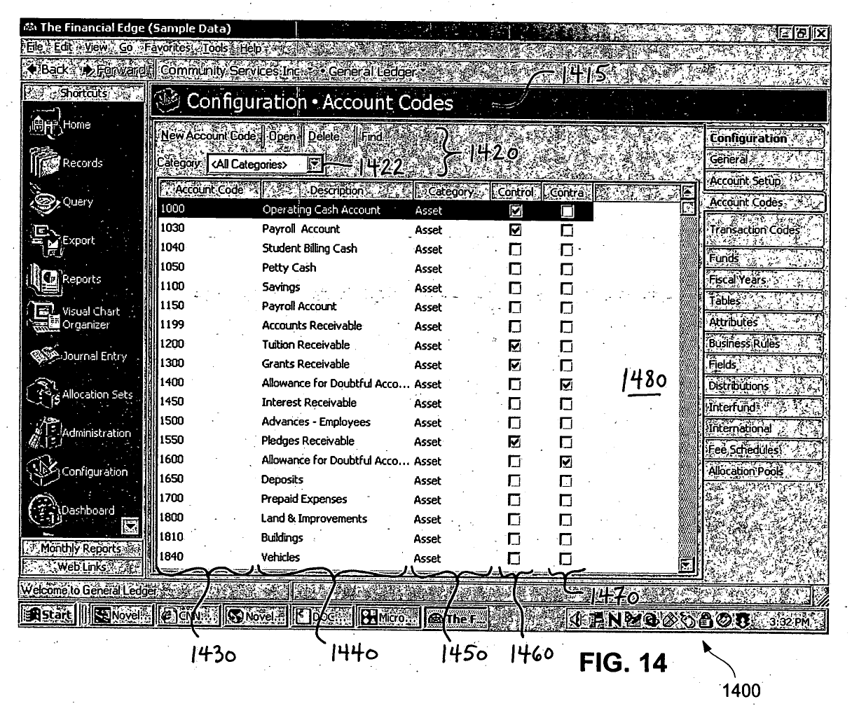

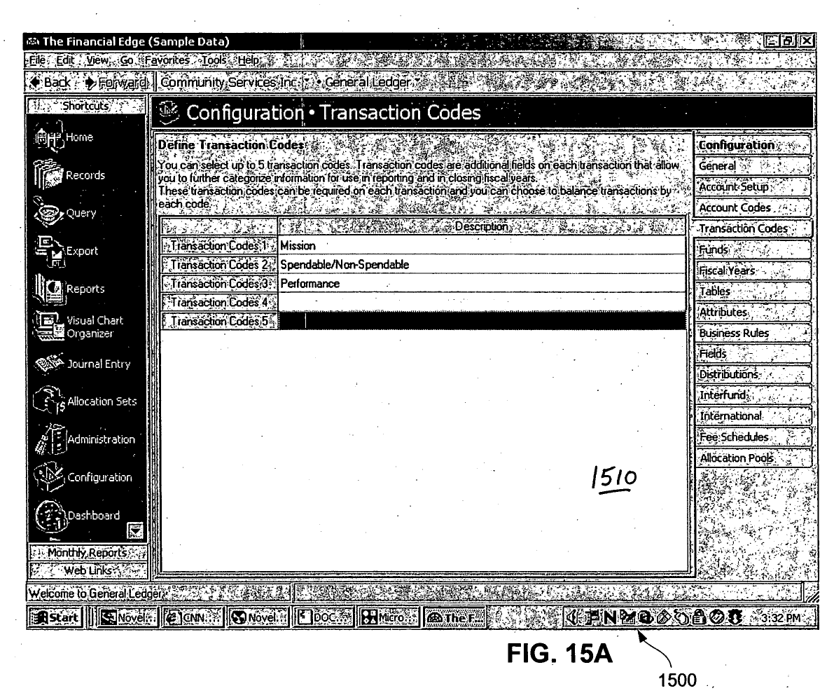

By activating the account code link 1214 or the account code tab 1224 in FIG. 12, the user is taken to an account code setup main page 1400, as shown in FIG. 14, which allows the user to define specific accounts by specific account codes. The account code setup main page 1400 includes a title bar 1415, controls 1420, and a plurality of columns in display area 1480. Preferably, there are at least five columns of account information displayed in display area 1480 including an account code column 1430, a description column 1440, an account category column 1450, a control column 1460, and a contra column 1470. All or selected (based on the user's choice using control 1422) accounts used by the system are displayed in display area 1480. The system includes a number of default or commonly-used accounts for each type of account category that may be used in whole or in part by the user. The account codes correspond to the length of the account codes already configured by the user and fall within the ranges defined for each account category. New accounts may be added to this list, account numbers may be modified (as long as they remain within the acceptable account code range for their account category), and account descriptions may be modified as desired. The user is also able to specify by selection or deselection of the check boxes in columns 1460,1470 whether each particular account is a control account or a contra account, as will be appreciated by one skilled in the art. Preferably, accounts are assigned account codes within their account category in the sequence that the user will generally want them to appear on any financial statement. Generally, the user will include gaps in the account code listing so that future accounts can be inserted therebetween, as desired.

Turning back briefly to FIG. 12, by activating the transaction code link 1216 or the transaction code tab 1226, the user is taken to a transaction code setup page 1500, as shown in FIG. 15A. The transaction code setup page 1500 includes a transaction code table 1510 that allows the user to define a plurality of transaction codes, which are additional fields of information that enable the user (or organization) to subcategorize and subdivide transactions for providing greater detail in reports. The system, as shown, currently allows up to five transaction codes to be defined; however, the number and naming of such transaction codes is arbitrary. As shown, the user has already defined three transactions codes for “mission,” “spendable/non-spendable,” and “performance.” With quick reference back to FIG. 5A, the reader will recall that these three transaction codes were displayed as the three available transaction codes for the displayed account 500. It should be understood that any modification or additions to the transaction codes 1510 on the transaction code setup page 1500 will be reflected throughout the system, such as for account 500 in FIG. 5A.

Once transaction codes are created in table 1510, allowable values for each such transaction code are defined in configuration table 1550, as shown in FIGS. 15B and 15C. Configuration table 1550 is accessed by activating the table link 1250 (as shown back in FIG. 12), and then by activating the table tab 1552, shown in FIGS. 15B and 15C. FIG. 15B illustrates the values 1554 that have been defined for transaction code 1 1556. FIG. 15C illustrates the values 1564 that have been defined for transaction code 2 1566. Links 1558 enable the user to create a new transaction code value, and to delete, edit, insert, and sort the values currently listed in the table 1550.

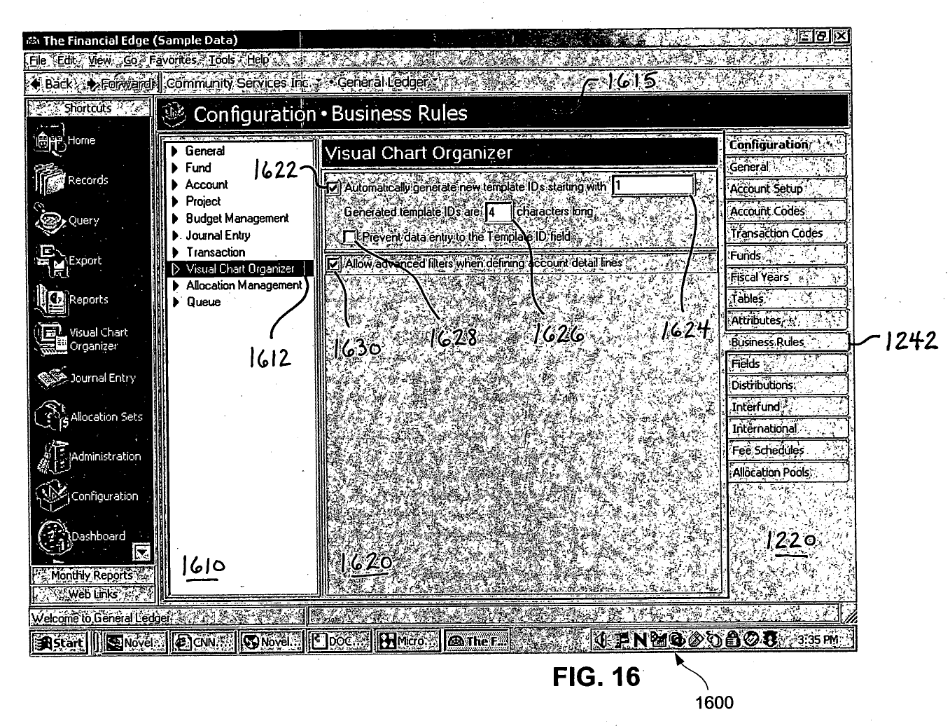

Turning again briefly to FIG. 12, by activating the business rules link 1232 or the business rules tab 1242, the user is taken to a business rules main page 1600, as shown in FIG. 16. The business rules main page 1600 of FIG. 16 includes a title bar 1615, a primary topic area 1610, and a specific business rules input area 1620. Again, the tab area 1220 from FIG. 12 is still viewable and accessible to the user on the right side of the screen. As shown, the user is permitted to define business rules associated with the visual chart organizer by selecting the visual chart organizer link 1612 in area 1610, which then displays a number of business rules for the user to define in business rule input area 1620. Specifically, the user specifies whether new visual chart IDs will be generated automatically by selecting the appropriate box 1622 and, if so, what number or character such template IDs will begin numbering from, as specified in field 1624. The user specifies in field 1626 the number of characters to be used for IDs associated with generated visual chart template IDs. The user is also able to specify whether any user will be able to override the automatically-generated template ID with a custom ID by selecting or deselecting check box 1628. Further, the user is able to specify whether advanced filters (as opposed to mere account ranges) will be allowed for defining account detail lines by selecting or deselecting check box 1630. Further understanding of the impact of the business rules chosen for the visual chart organizer will become apparent from the more detailed description of the visual chart organizer that follows.

Visual Chart Organizer

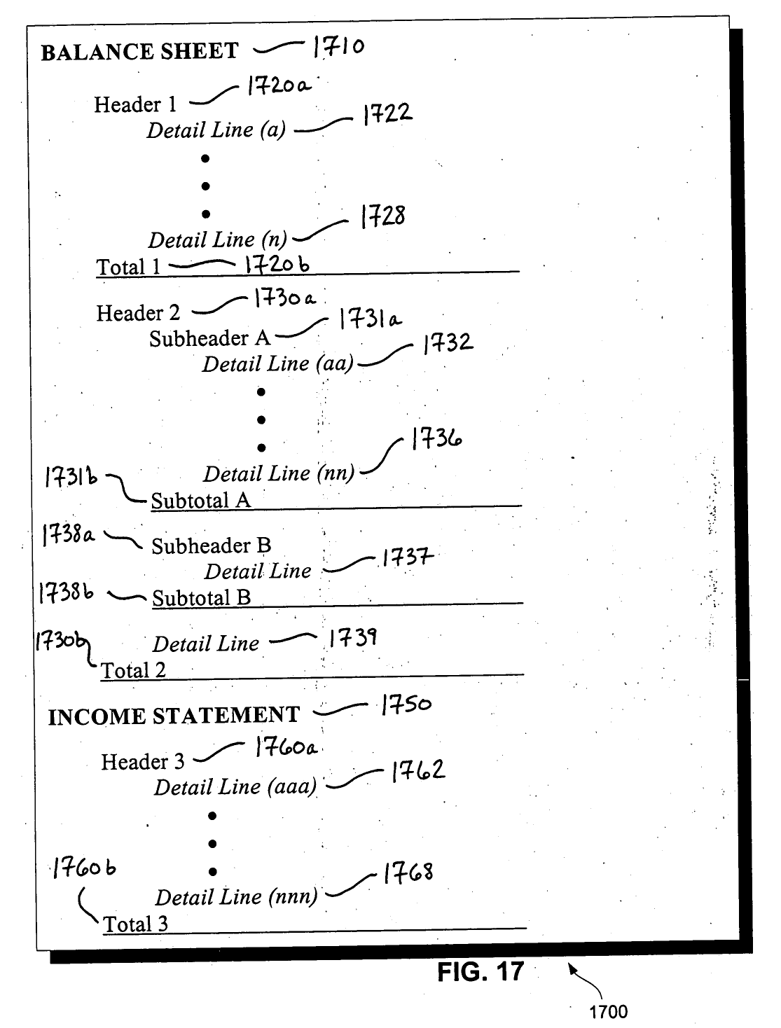

Before turning specifically to the screen shots and methodologies associated with the visual chart organizer and the systems associated therewith, it will be helpful to have a general understanding of the features and arrangements of a conventional financial statement. Turning now to FIG. 17, the general structure of a simplified and generic financial statement 1700 is illustrated. The financial statement 1700 includes two primary sections: a balance sheet 1710 and an income statement 1750. Although both sections 1710,1750 are shown, any given financial statement may include one, or the other, or both of these sections, as will be appreciated by one skilled in the art. As will also be appreciated by one skilled in the art, the balance sheet section of a financial statement for a not-for-profit generally only contains accounts that are of the account category: assets, liabilities, or net assets. Likewise, the income statement section of a financial statement for a not-for-profit generally only contains accounts that are of the account category: revenue, expense, gift, transfer, gain, and loss. Again, as will be appreciated by those skilled in the art, any given balance sheet and income statement may include some but not all of the accounts of the particular category for that section, depending upon the purpose and need for the particular financial statement. Further, in most cases, the highest level header/total pairs that are used for the financial statement will represent one of the particular account categories permitted on that section of the financial statement. As will be appreciated by one skilled in the art, a header/total pair is restricted to containing one or more of the account categories permitted by the particular section in which it is located. Correspondingly, each detail line within a header/total pair must match the permitted account category of the header/total pair in which it is contained, as will become apparent hereinafter.

With this in mind and turning back to FIG. 17, this particular balance sheet 1710 has only two header/total pairs 1720a,b and 1730a,b. Header/total pair 1720 includes or contains a plurality of detail lines 1722 through 1728. Header/total pair 1730 has a more complex structure than header/total 1720 and includes, specifically, a subheader/total pair 1731a,b, a subheader/total pair 1738a,b, and a single detail line 1739 at the same hierarchical level as the two subheader/total pairs. Subheader/total pair 1731 includes a plurality of detail lines 1732 through 1736. Subheader/total pair 1738 includes a single detail line 1737. In this particular financial statement 1700, the income statement section 1750 includes only one header/total pair 1760a,b, which contains detail lines 1762 through 1768. As will be appreciated by those skilled in the art, the structure of financial statement 1700 is shown merely as an example of the types of arrangements that a financial statement may take. Any given financial statement may be much more complex or even simpler in design.

The present invention enables users to create and customize chart templates that are structured in a manner somewhat similar to the general structure of the financial statement 1700 illustrated in FIG. 17. Using such chart templates, the system of the present invention is able to generate financial statements for display on screen, for print-off, or for download. Using such chart templates, the user is able to organize the structure and layout of any desired financial statement, by grouping accounts as desired (e.g., by account code range or filter) for presentation, providing titles for the financial statement, providing titles and formatting for each header and subheader and corresponding total line, and provide for an almost unlimited organization, grouping, and arrangement of accounts desired by the user—with substantial flexibility.

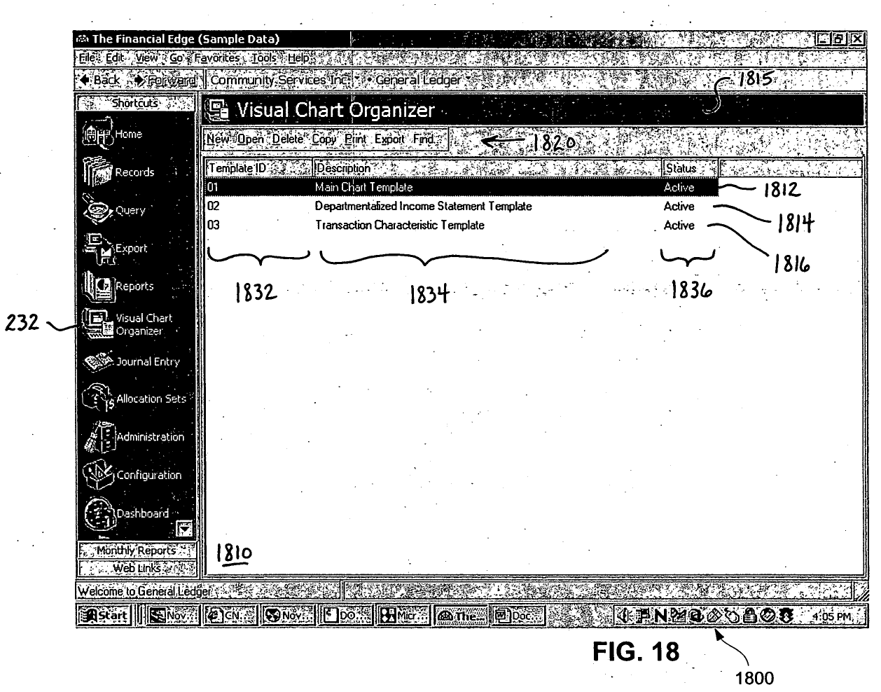

Turning now to FIG. 18, a visual chart organizer main page 1800 is illustrated. The visual chart organizer main page 1800 is accessed by activating the visual chart organizer link 232 shown in FIG. 2. The visual chart organizer main page 1800 includes a title bar 1815, a menu bar 1820, and a main display area 1810. The main display area lists all previously-created chart templates 1812, 1814, 1816, 1818. Each such chart template has a template ID 1832, a description 1834, and a status 1836. To access one of the existing chart templates, the user double clicks on one of the chart templates in display area 1810 or highlights one and then selects “open” from the menu bar 1820.

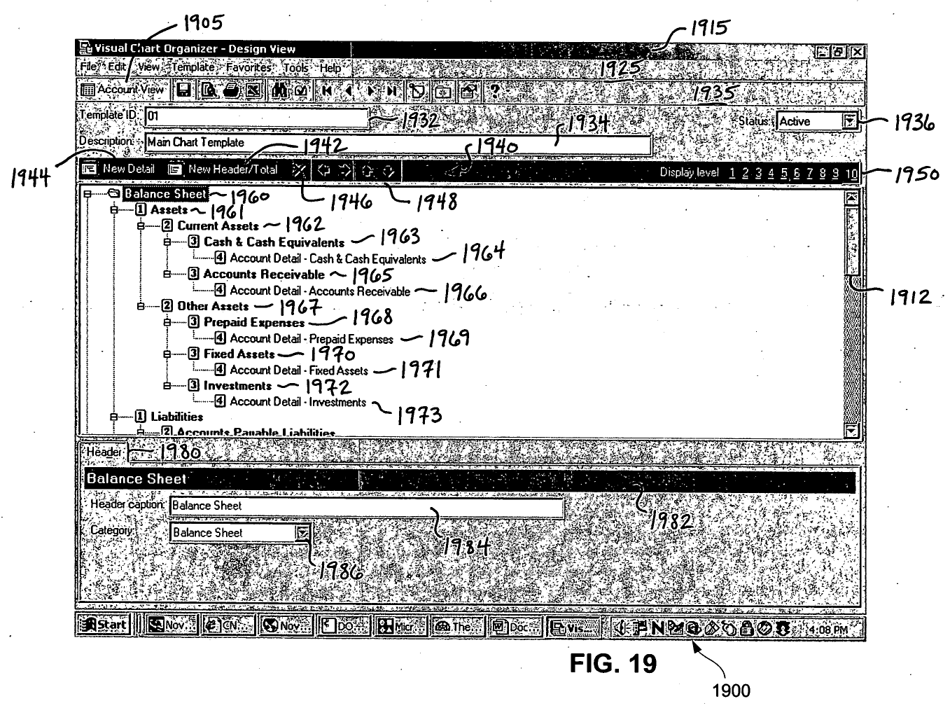

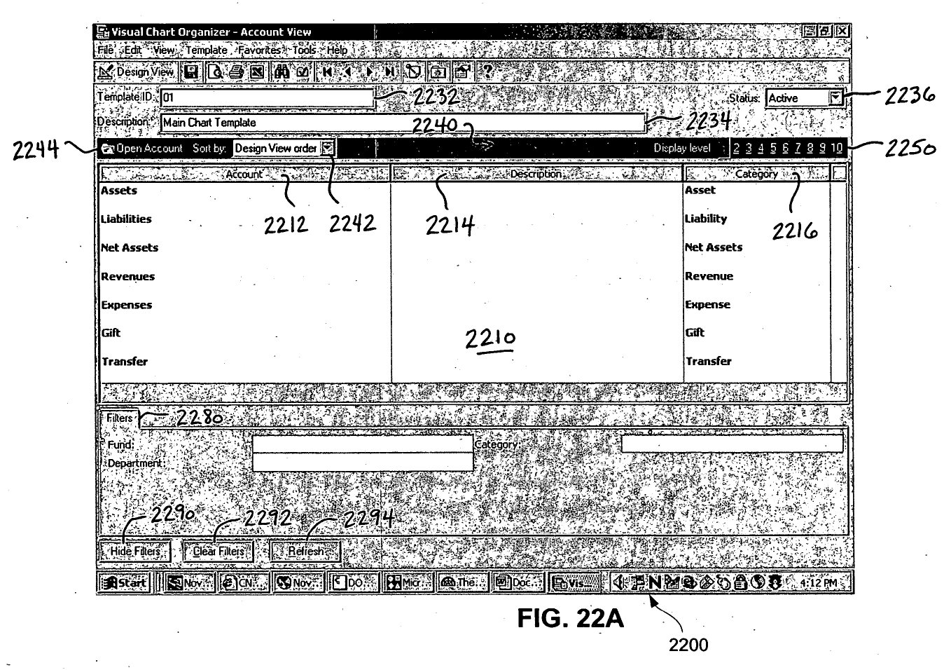

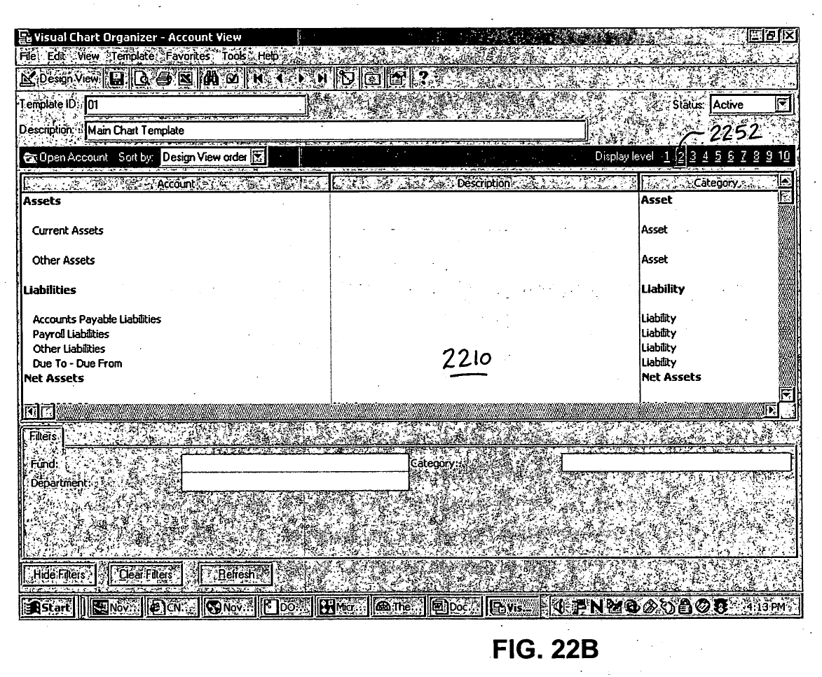

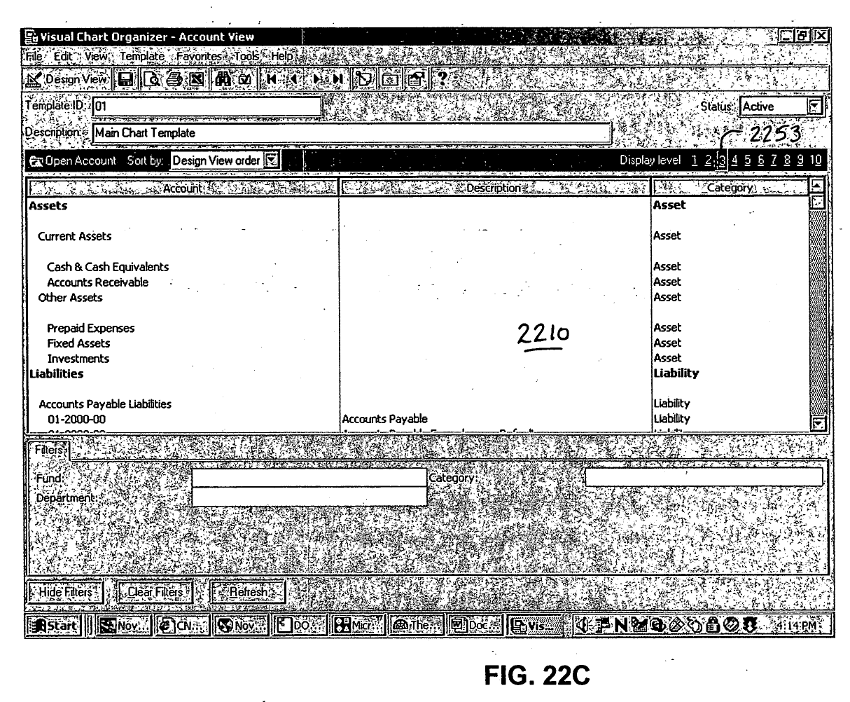

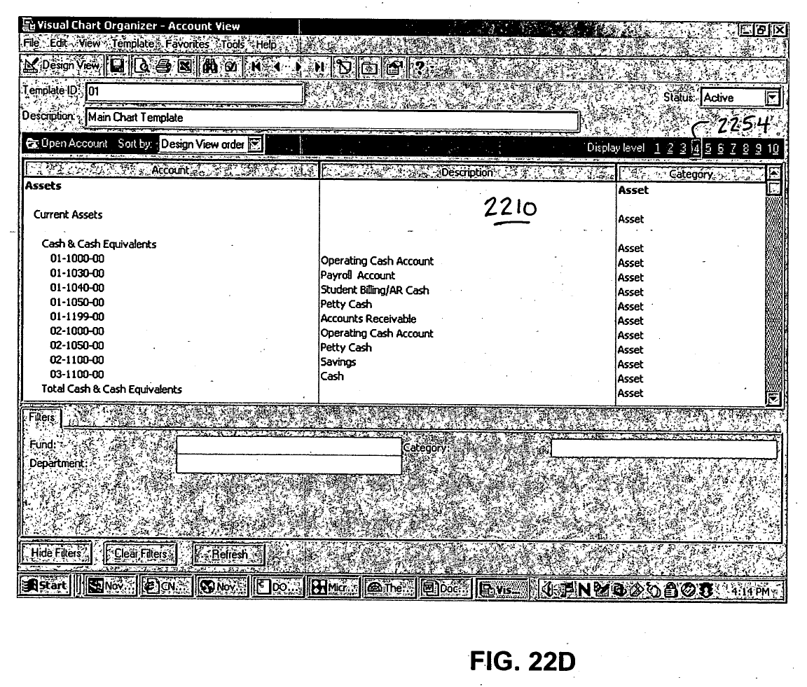

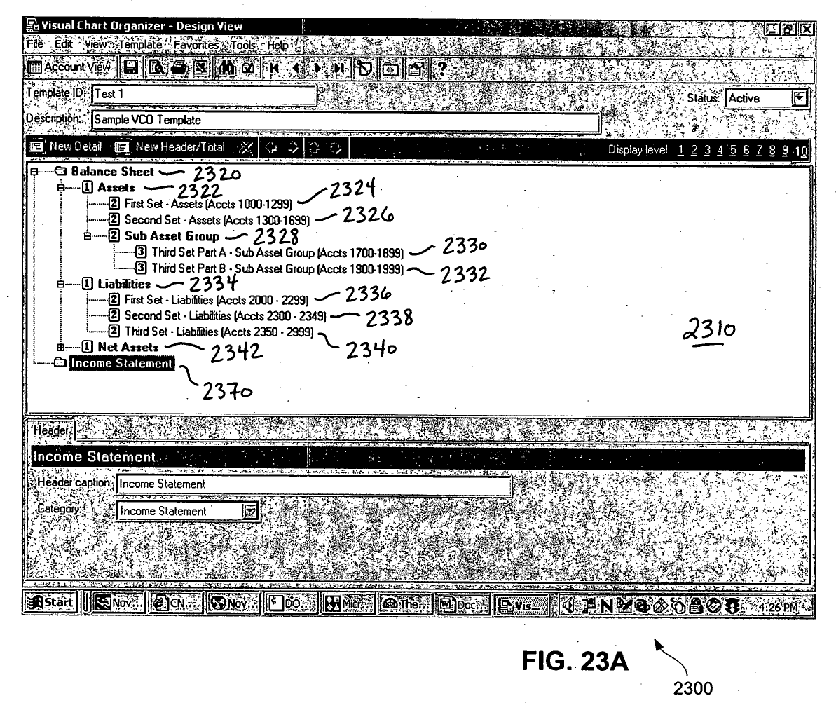

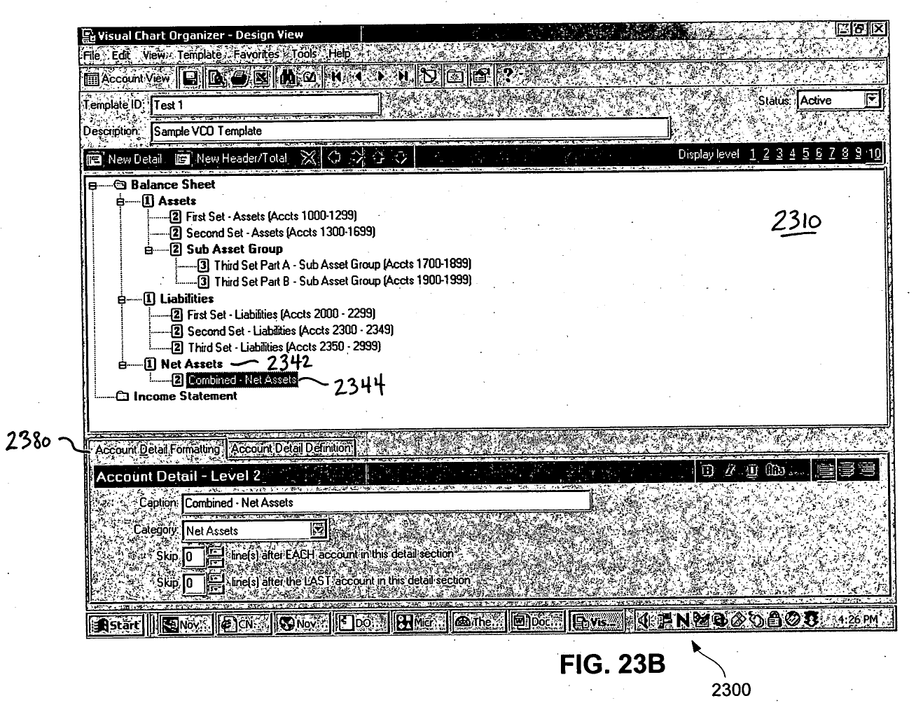

FIG. 19 illustrates a “design view” of a visual chart template 1900 corresponding to template ID 01, which was activated selecting template 1812 from FIG. 18. The chart template 1900 is a separate window that includes a title bar 1915, a menu bar 1925, a tool bar 1935, and a display area 1910. The tool bar 1935 includes a toggle button 1905 to enable the user to switch back and forth between the current “design view” of chart template 1900 and an “account view” (as shown and discussed hereinafter in association with FIG. 22A). As will be explained hereinafter, the design view enables the user to build a chart template; the account view enables the user to preview or see generally what the financial statement will look like when it is generated using the chart template.

The design view includes fields that identify the current template ID 1932, description 1934, and status 1936. These fields also allow the user to change any of the information, including the template ID, in which case, the user will be prompted as to whether the user wants to rename the existing template that was called “01” or whether the user wants to save the template as a new template under the new ID. The design view also includes a control bar 1940 with a number of controls that enables the user to insert a new header/total 1942, insert a new detail 1944, delete 1946 the highlighted (in display area 1910) header/total or detail and all subservient header/totals and details, move 1948 the highlighted header/total or detail up or down in its current level or up or down between levels, and determine down to what level the display area 1910 will show, using display level controls 1950.

The design view of chart template 1900 is displayed in hierarchical or tree format in display area 1910. In the balance sheet section 1960 of this chart template 1900, a first level header/total called “assets” 1961 is shown. Assets 1961 has at least two subheader/totals at a second level of the chart template called “current assets” 1962 and “other assets” 1967. Current assets 1962 then includes two of its own subheader/totals at a third level called “cash and cash equivalents” 1963 and “accounts receivable” 1965. Cash and cash equivalents 1963 has a detail line 1964 at level four called “account detail—cash & cash equivalents.” Accounts receivable 1965 has its own detail line 1966 at the fourth level called “account detail—accounts receivable.” The other assets subheader/total 1967 at level two includes three subheader/totals at the third level called “prepaid expenses” 1968, “fixed assets” 1970, and “investments” 1972. Each of these subheader/totals 1968,1970,1972 includes its own detail line 1969,1971,1973, respectively, at level four of the chart template. Additional header/total lines and detail lines of this chart template are accessible by scrolling down display area 1910 using scroll bar 1912 in conventional manner. Further details of this chart template in display view are not shown but should be readily apparent to those skilled in the art.

Still with reference to FIG. 19, with balance sheet 1960 highlighted in display area 1910, tab 1980 is displayed at the bottom of the design view of chart template 1900. Because balance sheet 1960 is a defined section of a financial statement, its “balance sheet” is displayed in title area 1982, in header caption 1984, and category field 1986. None of these are modifiable by the user.

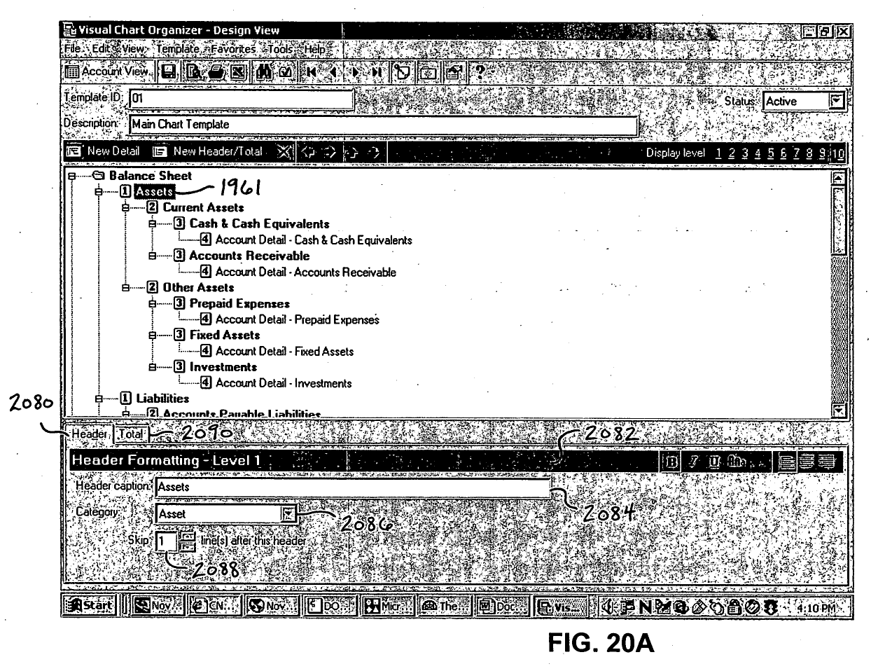

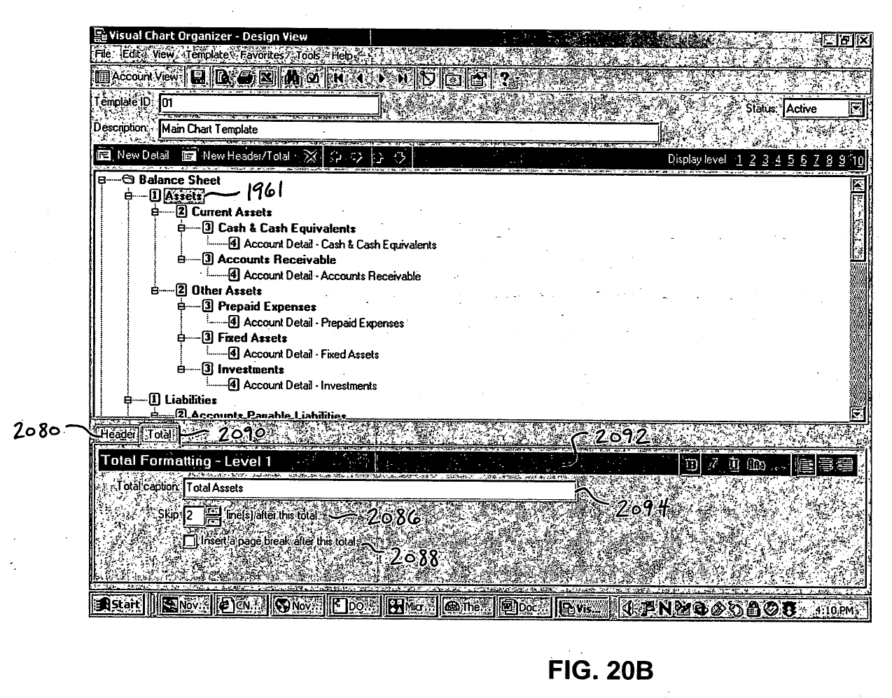

When any one of the header/totals are highlighted in display area 1910, header/total tabs 2080,2090, as shown in FIGS. 20A and 20B, are displayed. For example, when the assets 1961 header/total is highlighted, header 2080 is displayed and includes a format bar 2082, a header caption 2084, a category field 2086, and a skip line formatting option 2088. Using the format bar 2082, the user is able to specify the formatting (e.g., bold, italics, underline, font style and size, and justification) of this header line on any generated financial statement using this chart template 1900. Using field 2084, the user is able to name this header line, which, in this case, has been named “assets.” Using pull down menu in the category field 2086, the user is also able to define what account categories will be permitted in any detail lines that are subordinate or included under this header/total line in the tree structure of this chart template 1900. Because this header/total is on the balance sheet 1960, options for account category include balance sheet, assets, liabilities, or net assets. If assets, liabilities, or net assets is selected, only accounts, of that type are permitted therein. If the user selects “balance sheet,” then any accounts of the type assets, liabilities, or net assets are permitted therein. As shown, the user has defined assets 1961 to contain only asset accounts. Using option 2088, the user is able to specify how many blank lines will appear after this header on any displayed, printed, or downloaded financial statement using this chart template.

By selecting tab 2090, the user is able to format how the total line corresponding with the assets header will appear, as shown in FIG. 20B. The total window 2090 includes a format bar 2092, a total caption 2094, a skip line formatting option 2086, and a page break option 2088. Using the format bar 2092, the user is able to specify the formatting (e.g., bold, italics, underline, font style and size, and justification) of this total line on any generated financial statement using this chart template 1900. Using field 2094, the user is able to name this total line, which, in this case, has been named “total assets.” Preferably, the name for this total line defaults to “total” followed by whatever name the user has given to the header line in field 2084. Using options 2086 and 2088, the user is able to specify how many blank lines will appear after this total and/or whether a page break will follow this total line on any displayed, printed, or downloaded financial statement using this chart template.

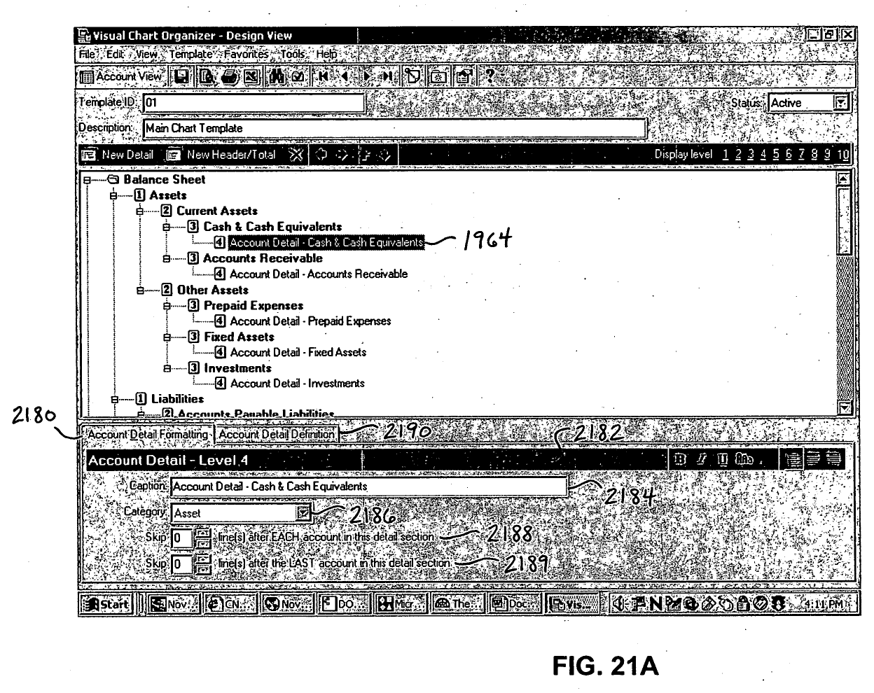

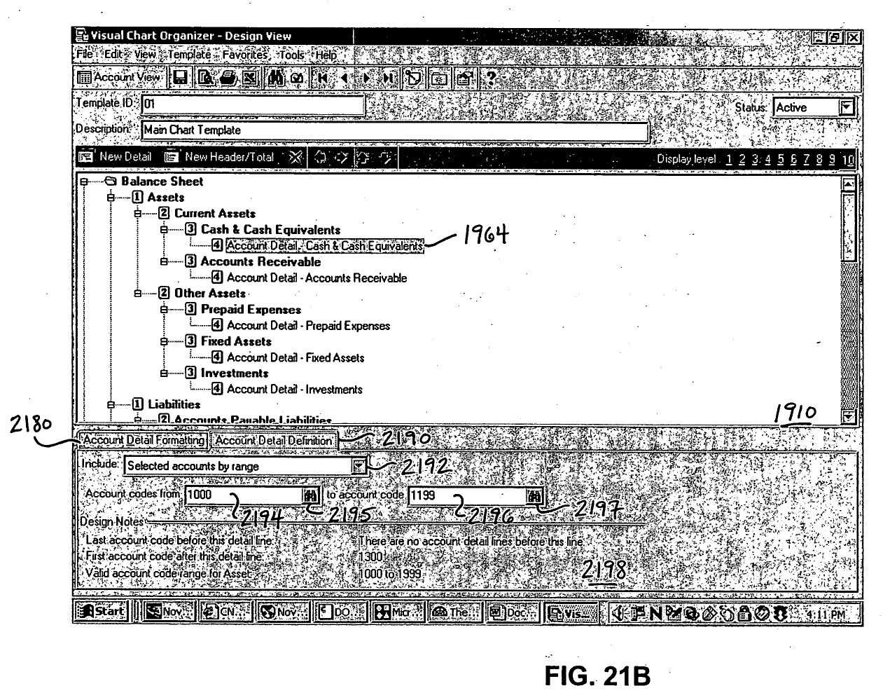

When any one of the detail lines is highlighted in display area 1910, account detail formatting and account detail definition tabs 2180,2190, as shown in FIGS. 21A and 21B, are displayed. For example, when the account detail—cash & cash equivalents 1964 detail line is highlighted, account detail formatting window and tab 2180 is displayed and includes a format bar 2182, a detail line caption 2184, a category field 2186, a skip line after each account formatting option 2188, and a skip line after last account formatting option 2189. Using the format bar 2182, the user is able to specify the formatting (e.g., bold, italics, underline, font style and size, and justification) of each account defined by this detail line that appears on any generated financial statement using this chart template 1900. Using field 2184, the user is able to detail line, which, in this case, has been named “account detail—cash & cash equivalents.” Using pull down menu in the category field 2186, the user is able to define what account categories are included in this detail line. Typically, if the header/total for this detail line has been defined as an asset, liability, or net asset, such account category will appear in this option and be unchangeable. However, if the header/total had been previously defined as balance sheet, then the user is able to specify whether this detail line will be limited to assets, liabilities, or net assets, or whether it will include any allowable accounts on a balance sheet. In this case, because current assets 1962 had been defined to include only asset accounts, “assets” appears in category field 2186.

By selecting tab 2190, the user is able to specify which accounts will be associated with this detail line. Drop down menu 2192 allows the user to specify whether accounts will be associated with this detail line by account code ranges or by using advanced filters. Advanced filters will be discussed hereinafter. The present screen illustrates use of the account code ranges, as shown. It will be recalled that account code ranges for each account category were previously defined in table 1340 of FIG. 13B. By default, the range of all possible account codes matching the currently-permitted account category are displayed in start range field 2194 and end range field 2196. Design notes area 2198 provides the user with information to help the user decide and determine what range of accounts the user would like to associate with this detail line. For example, design notes area 2198 indicates, in this case, what account code ranges have been used prior to and after this particular detail line. If no account code exist prior to or after this detail line, the design notes area 2198 will so indicate. Design notes area 2198 also provides the user with the range of acceptable account codes for this particular account category, in this case account numbers 1000 to 1999. The user is able to look up accounts within this accepted range using lookup buttons 2195, 2197, which presents the user with a list of accounts that shows account numbers and descriptions to help the user decide what account number to start and end this detail line. It will be understood by those skilled in the art that by associating a range of account codes (or advanced filter definition) to a particular detail line, that a plurality of accounts falling within the account range or satisfying the filter definition will be displayed in list format on any resulting financial statement using this particular chart template.

Turning now to FIG. 22A, an “account view” of the present chart template 2200 is illustrated. This display is accessed by selecting the toggle button 1905 from FIG. 19. The account view is similar to the design view for the chart template; however, the display area 2210 shows all header/totals and detail lines previously arranged by the user in the design view of the chart template 1900 of FIG. 19. The primary differences between the design view and the account view are the fact that headers are shown with the formatting previously assigned to that header by the user and each account associated with a particular detail line is shown as a separate line entry. Like the design view, the account view includes fields that identify the current template ID 2232, description 2234, and status 2236. Like the design view, these fields allow the user to change any of the information, including the template ID. The account view also includes a control bar 2240 with a number of controls that provide the user with a shortcut 2244 to open an account, to sort the information in the display area 2210 (e.g., by design view order, by fund, by account code order, alphabetical by header or account, and the like), and determine down to what level the display area 2210 will show, using display level controls 2250. Preferably, display area 2210 is divided into three columns of information, namely, an account column 2212, an account description column 2214, and a account category column 2216. FIG. 22A shows no specific accounts because it is only showing down to level one (corresponding to the same levels used in design view). By way of example, FIG. 22B shows down to display level two 2252, FIG. 22C shows down to level three 2253, and FIG. 22D shows down to display level four 2254. Because this particular chart template 1900,2200 does not contain any levels below level four, changing display level setting anywhere between four and ten has no actual impact on the information that is displayed in display area 2210.

Remaining on FIG. 22A, the account view of chart template 2200 provides the user with a filter 2280, which allows the user to filter or otherwise limit what header/totals and accounts are actually shown in display area 2210. For example, the user is able to view selectively information associated with particular fund(s), department(s), and category(ies), and any combinations thereof. To expand the visible display area 2210, the user can toggle the show/hide filters button 2290. The user is able to clear all filter fields using the “clear filters” button 2292 and to apply the current filters to the display area using the “refresh” button 2294.

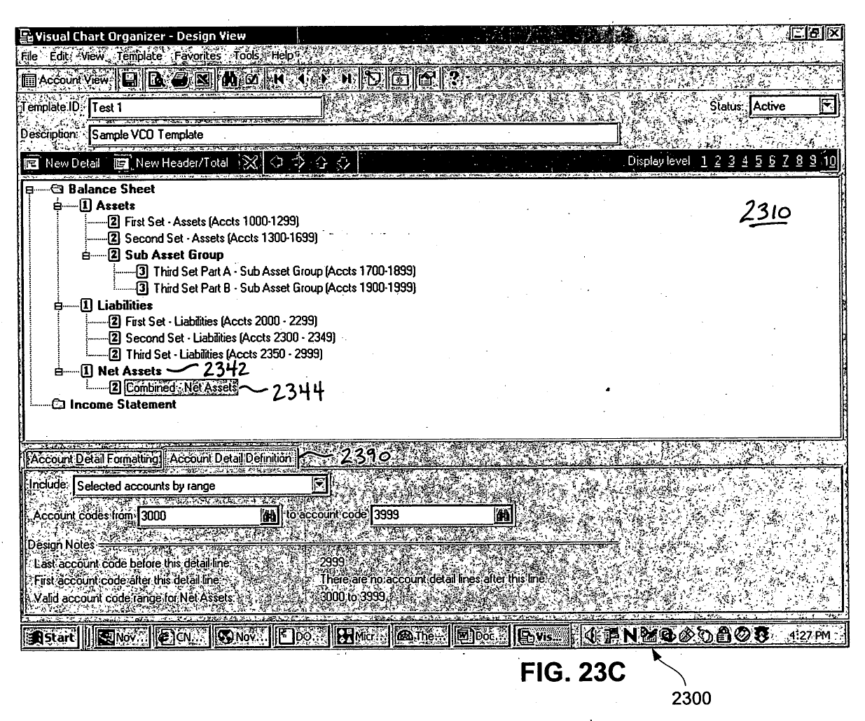

FIG. 23A illustrates-another example chart template 2300 that is much simpler than chart template 1900 from FIG. 19. This chart template 2300 is a “balance sheet only” template since there are no detail lines defined under the income statement section 2370. The balance sheet section 2320 include header/total pairs for assets 2322, liabilities 2334, and net assets 2342. Assets 2322 includes two groupings of actual asset accounts defined as a first set 2324 (having accounts from 1000 to 1299) and a second set 2326 (having accounts 1300 to 1699). Assets 2322 also includes a subheader/total called “sub asset group” 2328 that has two groupings of asset accounts of its own 2330,2332, (having accounts 1700 to 1899 and accounts 1900 to 1999, respectively). The liabilities header/total 2334 is merely divided into three grouping of liability accounts 2336,2338,2340 (having accounts 2000 to 2299, accounts 2300 to 2349, and 2350 to 2999, respectively). Currently, no detail lines are yet defined under the new assets header/total 2342. FIG. 23B illustrates the addition of a detail line 2344 under net assets header/total 2342, with the account detail formatting section 2380 displayed. FIG. 23C illustrates the addition of account detail 2344 with the account detail definition section 2390 displayed. As shown, the detail line 2344 has been named “combined net assets” as has associated therewith account codes from 3000 to 3999.

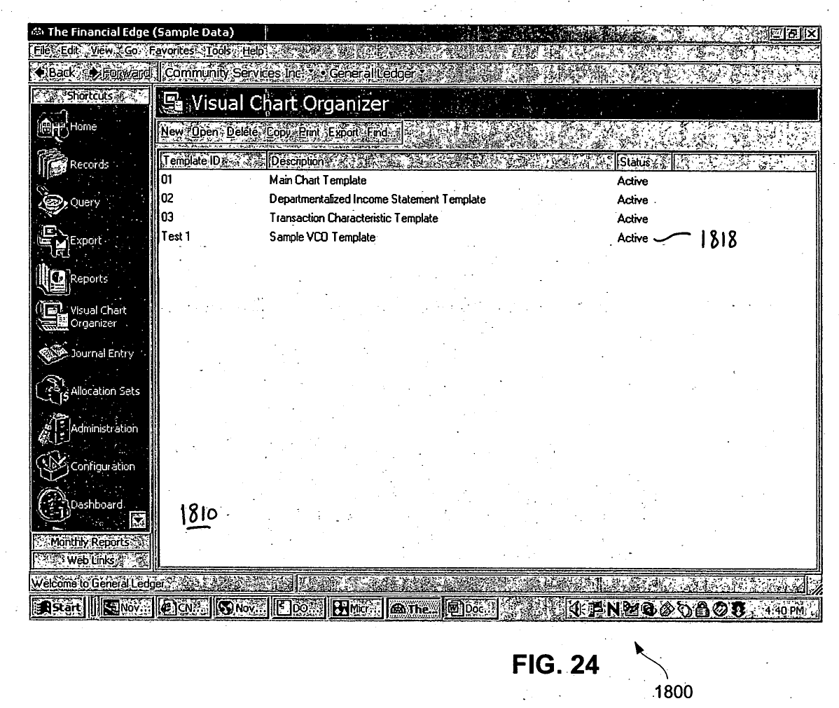

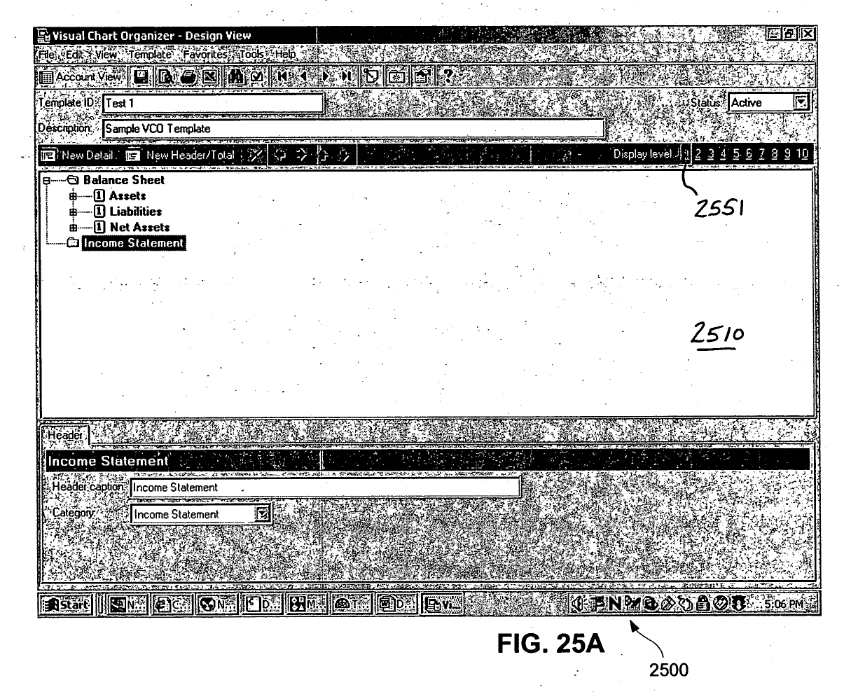

FIG. 24 illustrates the visual chart organizer main page 1800 (previously shown in FIG. 18) but with the new chart template 2300 (from FIG. 23) now saved and displayed as chart template 1818 in display area 1810. Chart template 1818 has been defined as template ID “Test 1” and has the description “sample VCO template.”

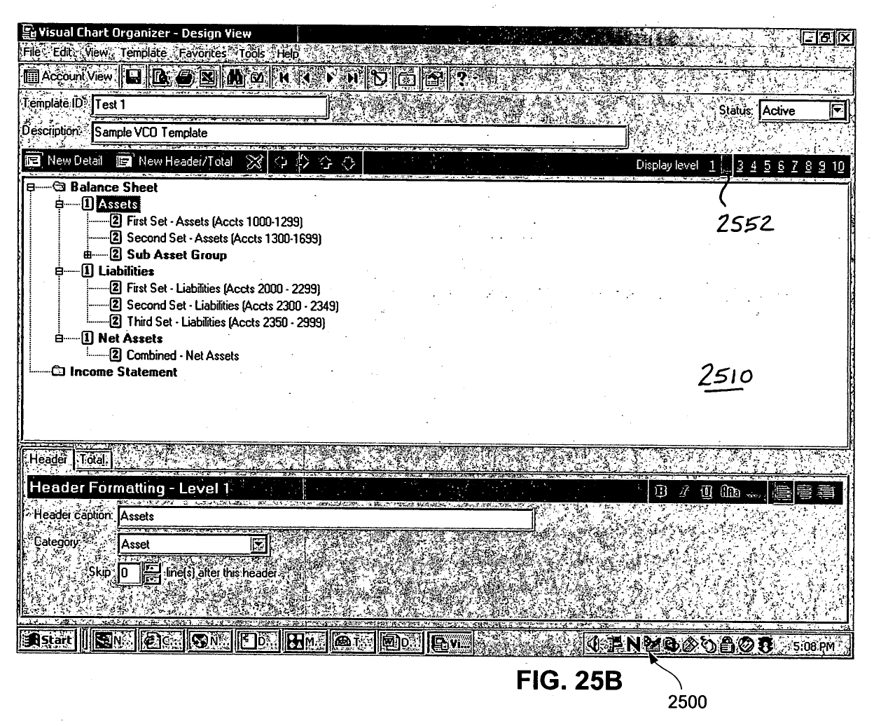

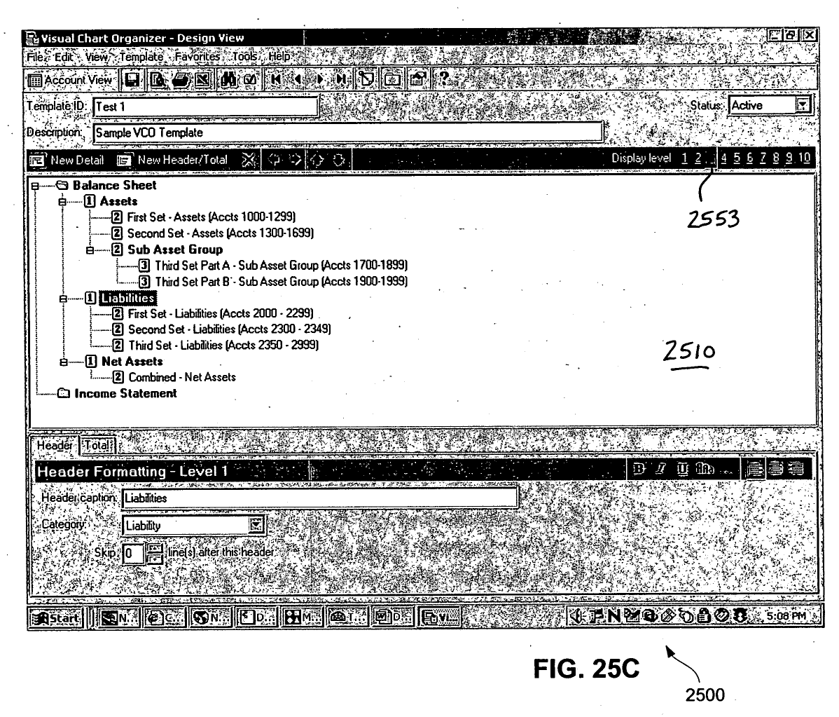

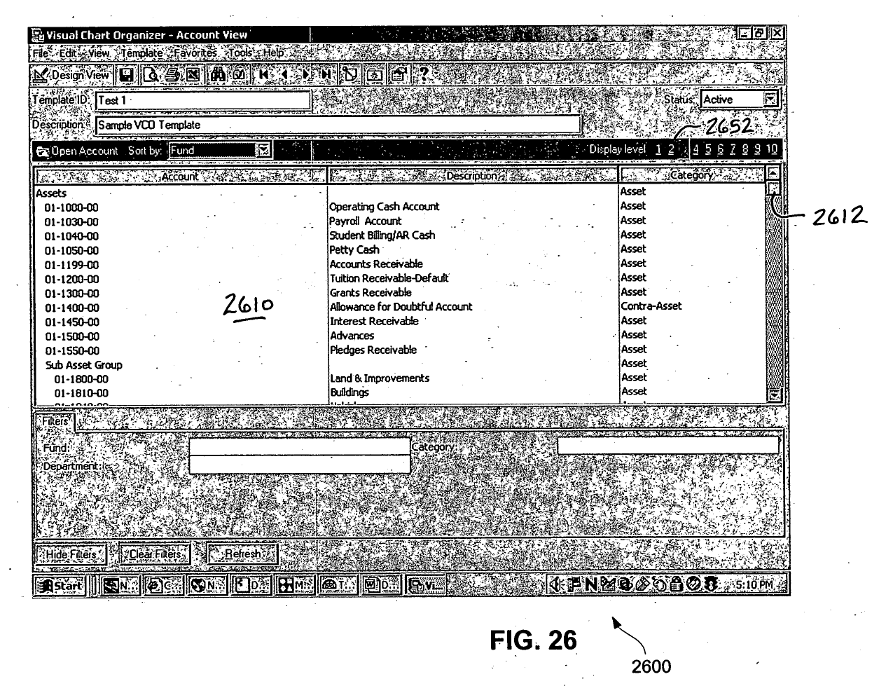

FIGS. 25A through 25C illustrate use of the display level setting in conjunction with the design view 2500 of chart template “Test 1” (before creation of the detail line under net assets). FIG. 25A shows the design view of chart template Test 1 in display area 2510 with display level setting of one 2551. FIG. 25B shows the design view of chart template Test 1 in display area 2510 with display level setting of two 2552. Correspondingly, FIG. 25C illustrates the design view of chart template Test 1 with a display level setting of three 2553.

FIG. 26 illustrates the chart template 2300 from FIG. 23 in “account view” format 2600. Specifically, the account view is shown at level two display setting 2652. Only a portion of the account view of this chart template is shown in display area 2610—the remaining portions are viewable using the scroll bar 2612.

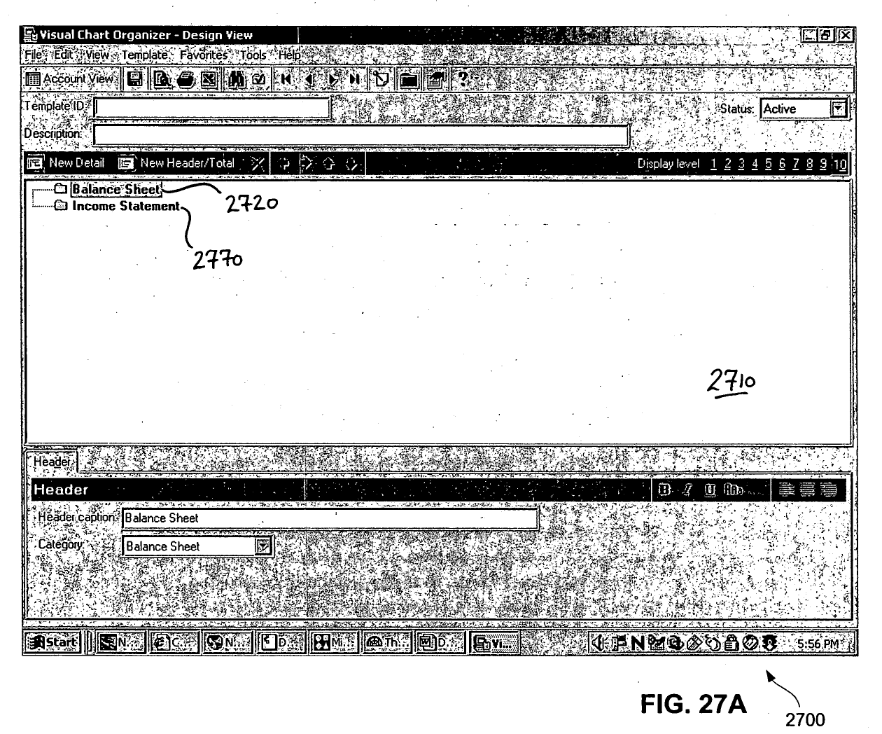

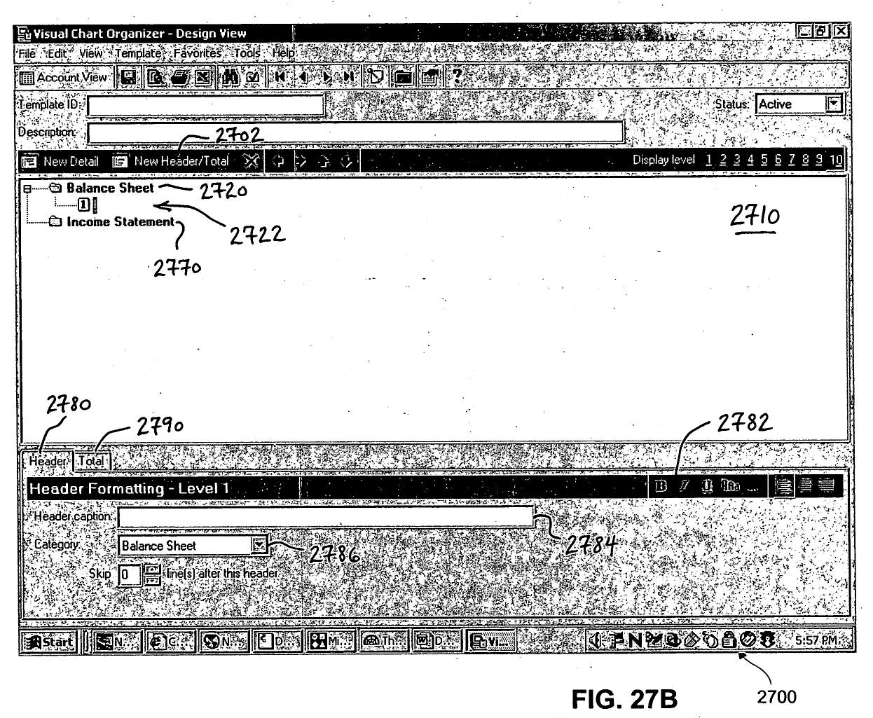

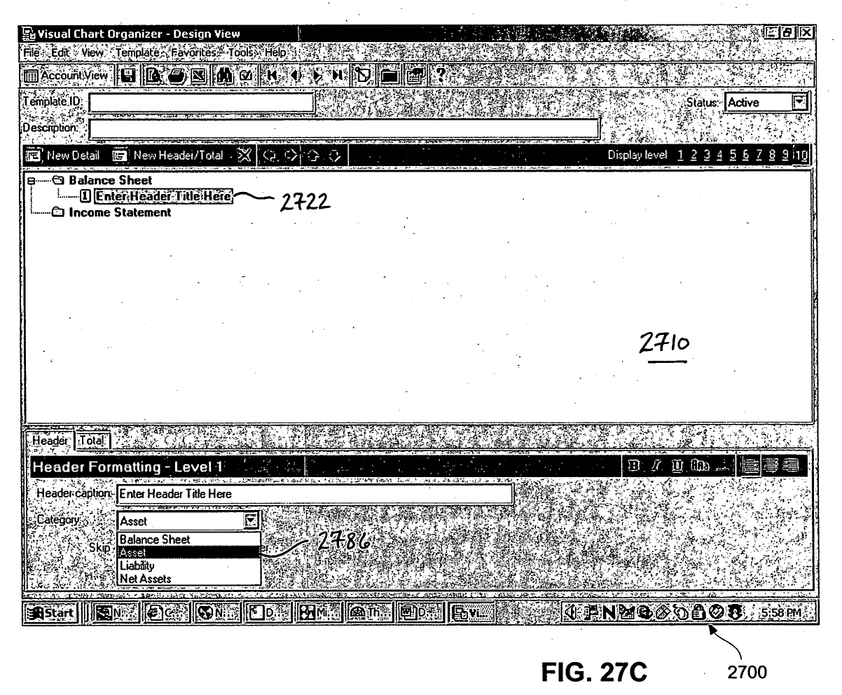

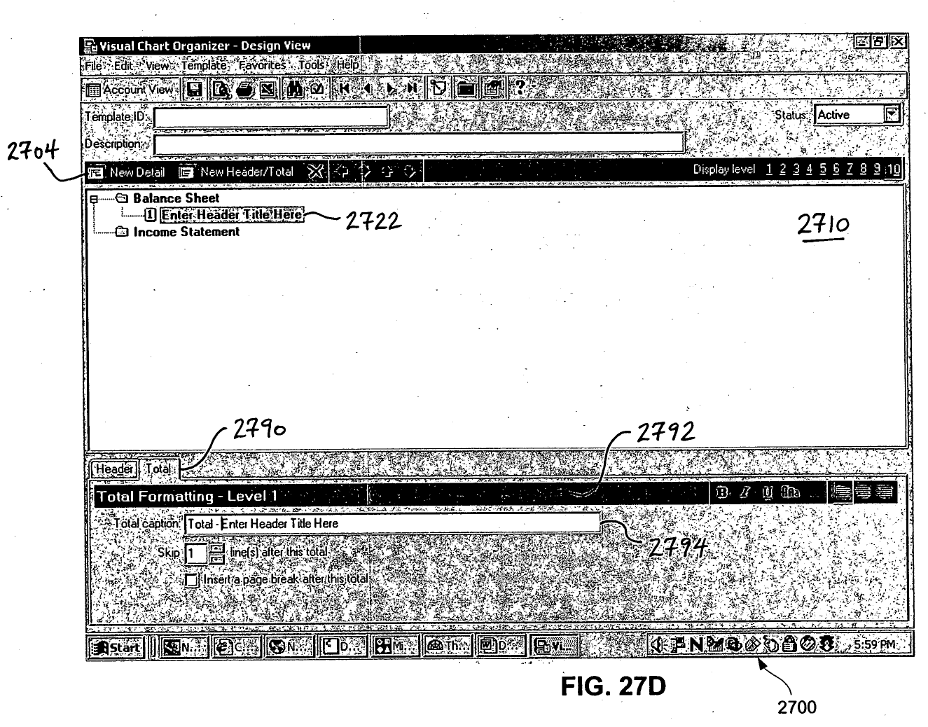

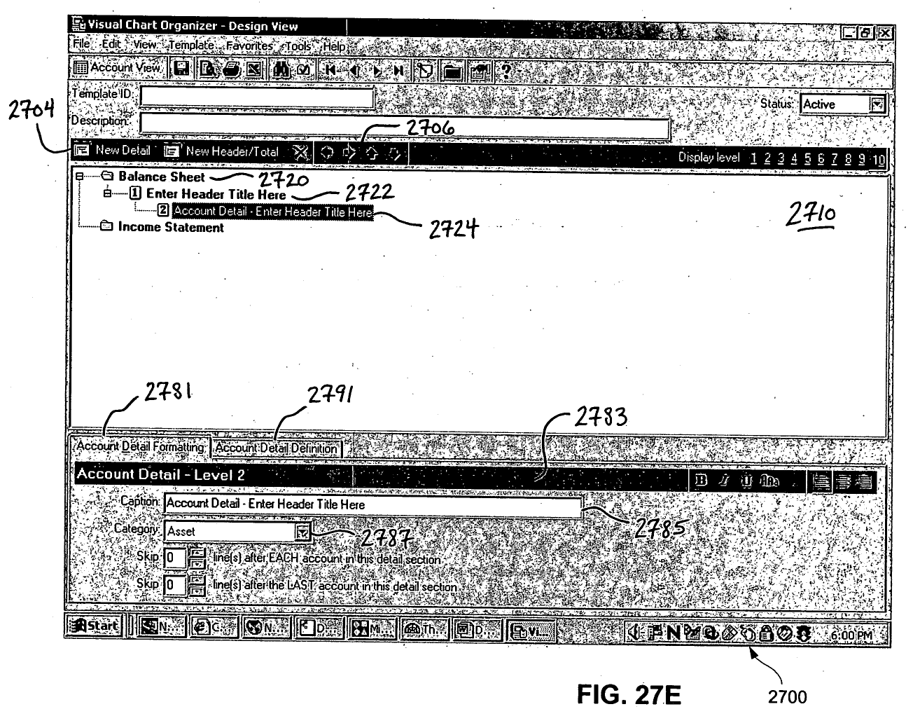

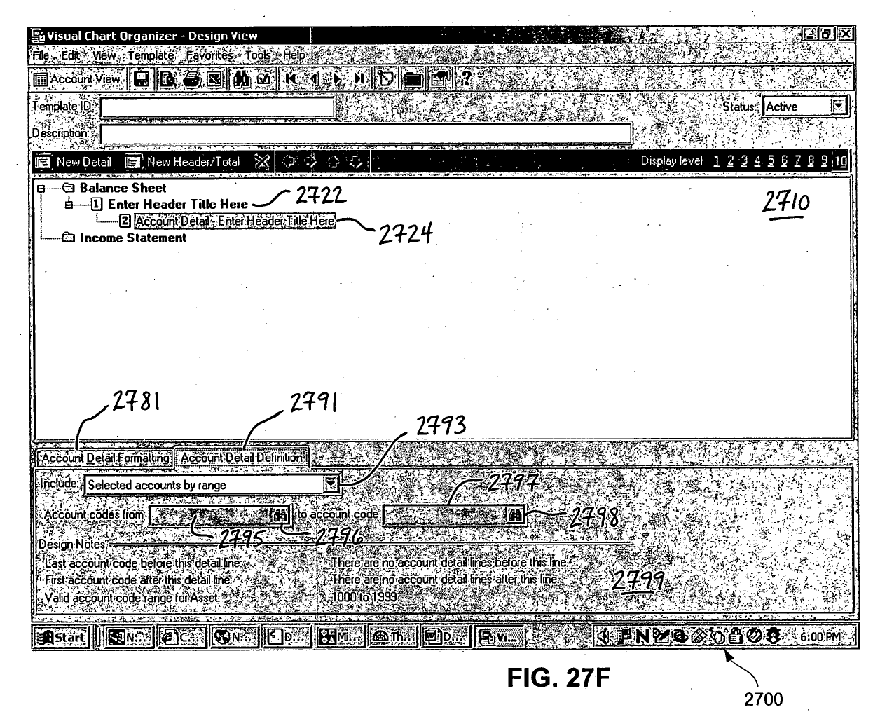

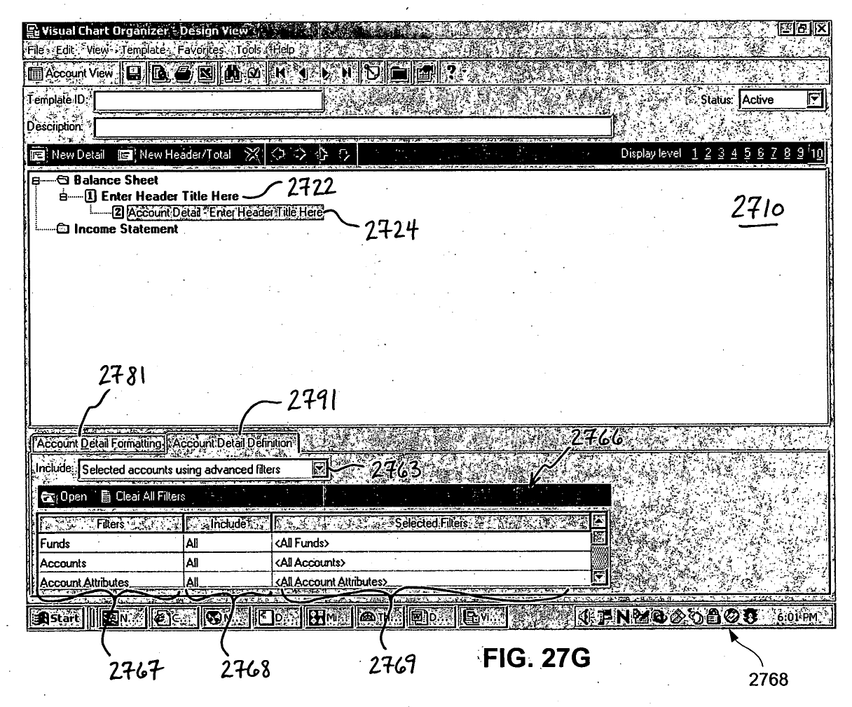

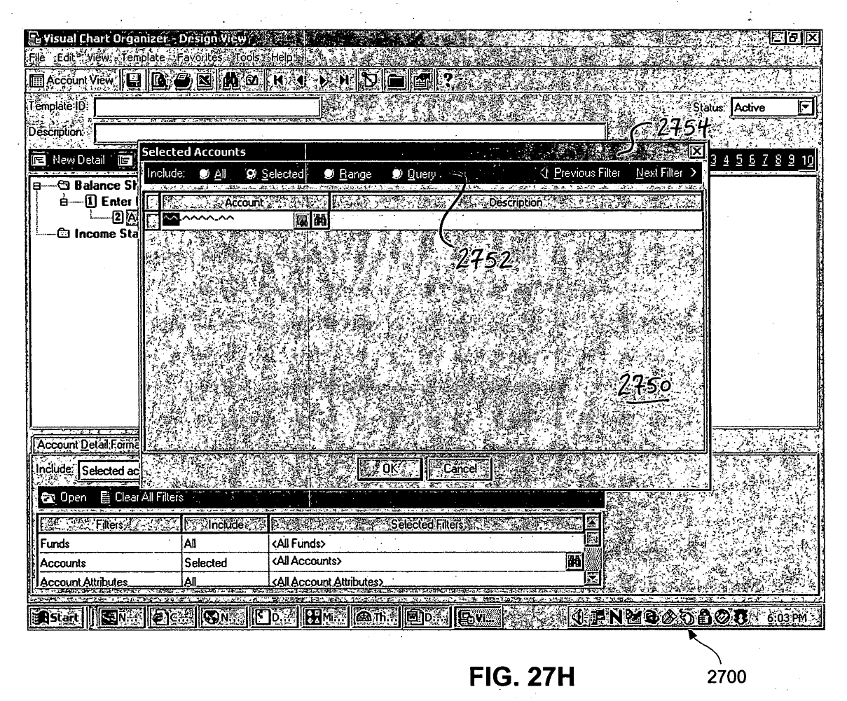

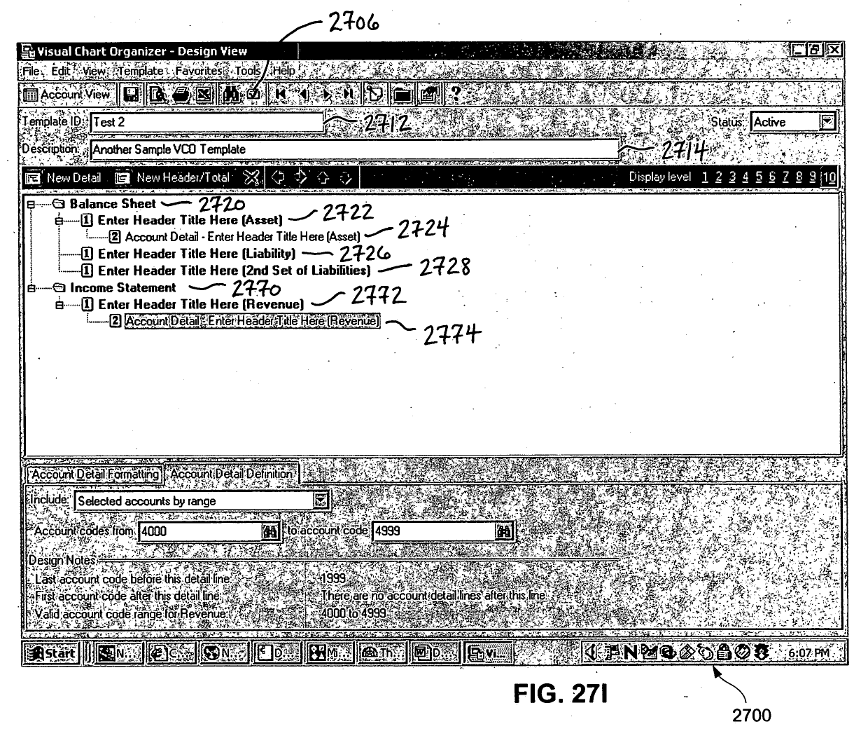

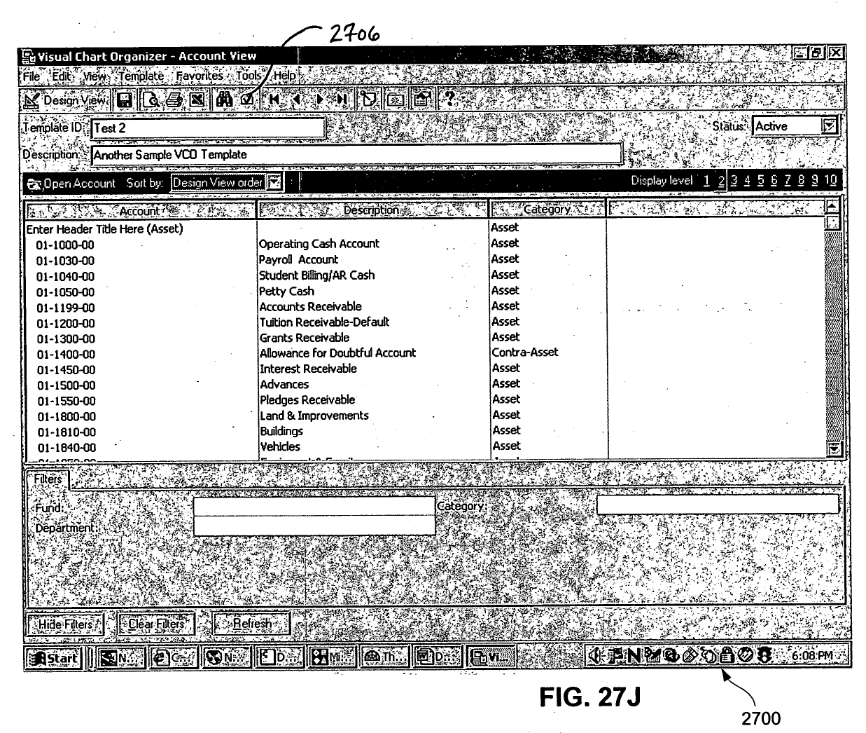

Turning now to FIGS. 27A through 27J, the process for creating a “new” chart template will be discussed and described in greater detail. By activating the “new” option from menu bar 1820 (from FIG. 18), the user is presented with a new chart template 2700 in design view format. Headers for the two sections of a financial statement, balance sheet 2720 and income statement 2770, are preferably displayed in area 2710. No header/totals or detail lines have yet been created so nothing appears in hierarchy or tree of either section. By highlighting balance sheet 2720 and then activating the new header/total button 2702, a new (and currently blank) header/total 2722 is created at level one below balance sheet 2720. The user provides a name or header caption for this header/total 2722 in field 2784 of tab 2780 at the bottom of the page. Formatting of this header is available using the formatting bar 2782. Because this header/total 2722 is below balance sheet, category field 2786 includes balance sheet, asset, liability, and net asset, as available options in the pull down menu. FIG. 27C shows that the user has chosen “asset” for the account category 2786 for this header/total 2722.

FIG. 27D shows that header/total 2722 has been given the caption “enter header title here” in field 2784 from FIG. 27B. In tab 2790, the user is able to enter name or total caption for the header/total line 2722 in field 2794. Formatting for the total line is available in formatting bar 2792. With the header/total 2722 highlighted, activation of the new detail button 2704 creates a new (and currently blank) detail line 2724 at level two below header/total 2722. As should be recalled, the user can move this detail line 2724 up or down to a different header/total location or to a higher or lower level using level controls 2706. The user provides a name or detail caption for this detail line 2724 in field 2785 of tab 2781 at the bottom of the page. Formatting of this detail line is available using the formatting bar 2783. Because this detail line 2724 is in the balance sheet section and, more specifically, directly below the header/total 2722, which was defined as an asset category (in FIG. 27C, category field 2787 defaults to asset and is not modifiable by the user. In FIG. 27F, the user associates particular accounts with this detail line 2724 using account detail definition tab 2791. In this case, the user has currently selected to associate accounts to this detail line 2724 using account code ranges, as shown in pull down menu 2793. The user can type a start range account number in field 2795 or select such an account code from look-up menu 2796. Correspondingly, the user can type an end range account number in field 2797 or select such an account from look-up menu 2798. Design notes 2799 provide the user with helpful information to help decide what account range is permissible for this particular detail line. FIG. 27G illustrates the alternative case in which the user has currently selected to associate accounts to this detail line 2724 using advanced filters rather than account code ranges, as shown in pull down menu 2763. When advanced filters are selected, the area below the pull down menu 2763 displays a filters table 2766 in which the user selects what accounts to associate or not associate with the particular detail line 2724. As shown, the filters in table 2766 include almost any piece of information maintained by the accounting system that can be associated with an account. Column 2767 of the table 2766 identifies what account characteristics are available for filtering. Column 2768 identifies how such characteristic will be applied. By clicking in the column 2768 across from any particular characteristic, all available options for that characteristics (e.g., all or none) or selected subcharacteristics are presented to the user and can be selected, as shown in FIG. 27H. Specifically, the user is presented with a search screen 2750, in which the user is able to include all, selected, or a range of the particular characteristic using controls 2752. In this example, the user is selecting “funds,” as is evident from title bar 2754. Continuing with FIG. 27G, column 2769 displays the resulting filter applied to the corresponding characteristic of column 2767 as modified by the selection from column 2768.

Further header/totals and detail lines can be added to the chart template 2700 in the manner above-described. FIG. 271 illustrates chart template 2700 that has now been saved as template ID “Test 2,” as shown in template ID field 2712, and has been given the description “another sample VCO template,” as shown in description field 2714. Header/total 2722 and detail line 2724 have been slightly renamed to indicate that they are for “asset” accounts. Two additional header/totals 2726,2728 have been added; however, neither has any detail lines yet. A header/total 2772 and a corresponding detail line 2774 have been added in the income statement section 2770 of the chart template 2700.

FIG. 27J illustrates this same chart template 2700 in “account view” format. By activating the “validate chart” button 2706, from either the design view (see FIG. 271) or from the account view (see FIG. 27J), the user is able to verify both (i) that the chart template created does not have any accounts associated with more than one detail line and (ii) that no desired accounts are missing from all included header/totals. In some situations, a user may want an account to appear more than once in a report or, alternatively, to have some accounts excluded. In such cases, however, the validate chart function allows the user to confirm that the desired accounts are showing up more than once or, alternatively, that the undesired accounts are not included. Further, in such cases, the user is notified that any financial statements generated from such chart templates will not balance properly.

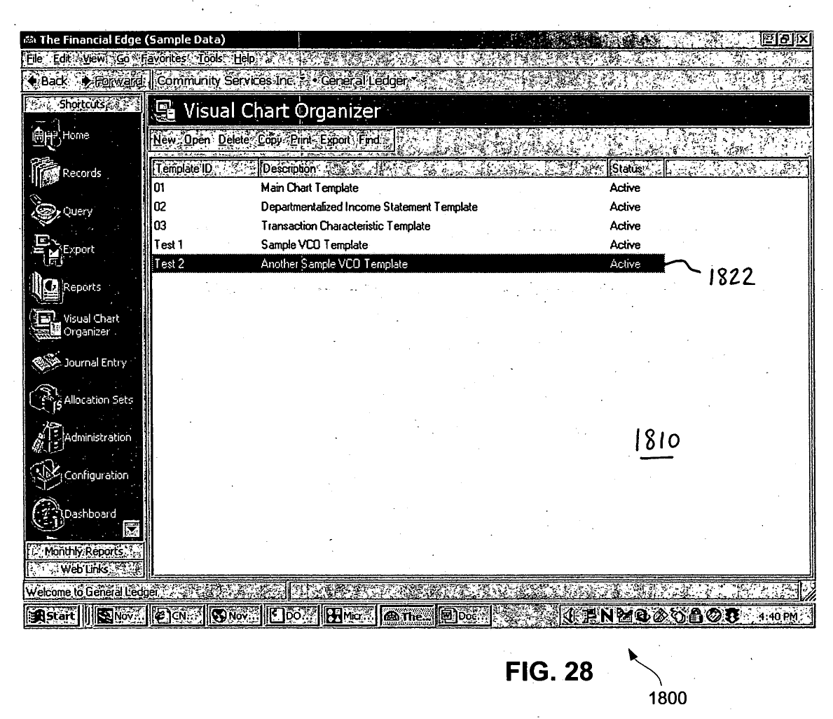

FIG. 28 illustrates the visual chart organizer main page 1800 (previously shown in FIGS. 18 and 24) with the new chart template 2700 (from FIGS. 27A through 27J) now saved and displayed as chart template 1822 in display area 1810. Chart template 1822 has been defined as template ID “Test 2” and has the description “another sample VCO template.”

Once a chart template has been created, it will now be available for selection by the user when generating a report. As will be recalled, the user is able to select an available chart template from the pull-down menu 1014 of FIG. 10C.

Methods of the Present Invention

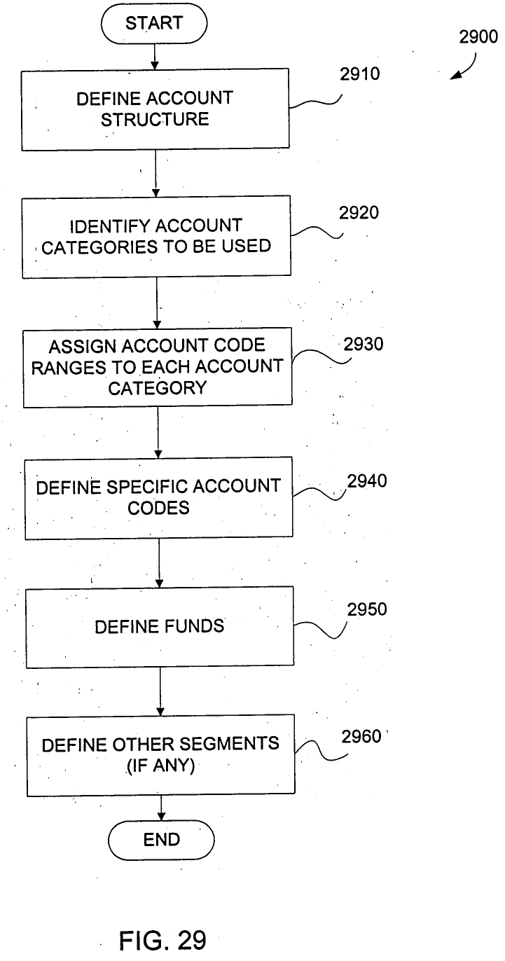

Turning now to FIG. 29, a method 2900 of setting up an account for use in the present invention is disclosed. In step 2910, the account structure to be used by the system of the present invention is defined. As will be recalled from FIG. 13A, this includes defining what account segments will be included in the account number, the length of each account segment, and whether any separators will be used therebetween. In step 2920, the particular account categories to be used by the system are identified or selected. As will be recalled from FIG. 13B, the asset, liability, net assets, revenue, expense, and transfer account categories are preferably always included. The gift, gain, and loss account categories are optional. In step 2930, account code ranges are assigned to each selected account category. For most systems, account codes will typically be four or five digits long. Preferably, there will be no overlap and no gaps in account codes between any two account categories. In step 2940, specific accounts are defined, such accounts having an account code within the acceptable range for the particular account category of the account. Accounts are also defined as being a control or contra account, if applicable. If the system is set up to include more than one fund and if the account number includes a fund segment, it is then necessary to define each such fund, as shown by step 2950. Further, if any other segments, such as department or location, as included as a segment in the account number, it is also necessary to define such additional segments, as shown in step 2960.

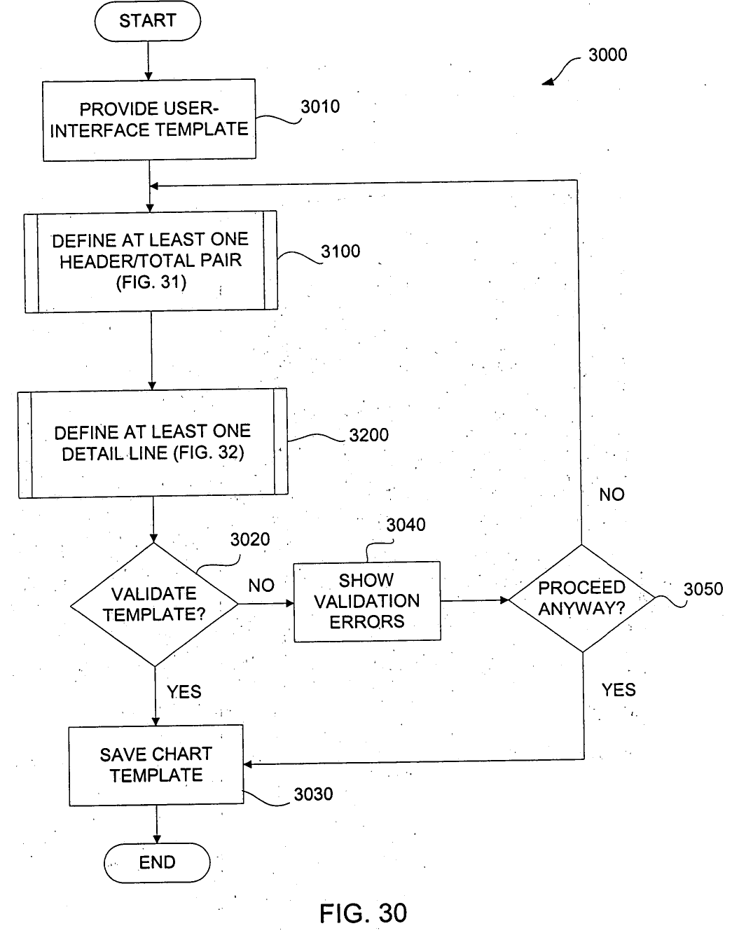

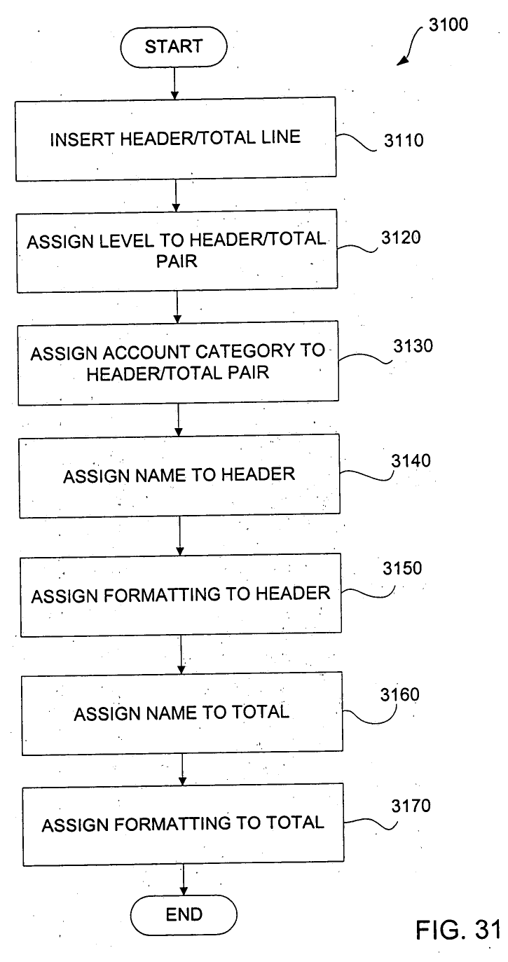

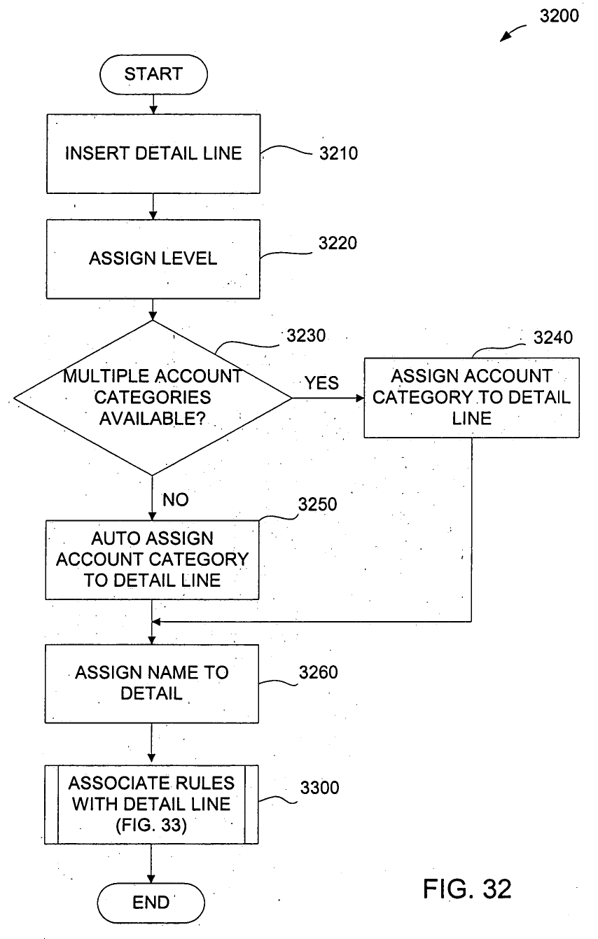

FIG. 30 illustrates a method 3000 for creating a chart template, as was generally described in association with the screen shots of FIGS. 18-28. First, a baseline template is provided in step 3010 through a user interface. The baseline template preferably includes at least one area or section for defining details of a balance sheet and/or details of an income statement and enables header/total pairs and detail lines to be defined. Next, at least one header/total pair is then defined as shown at step 3100 and as will be described in greater detail in association with FIG. 31. At step 3200, as shown and described in greater detail in FIG. 32, at least one detail line is defined within one of the at least one header/total pairs. The template can then be validated (step 3020) to confirm that all relevant accounts have been associated with at least one detail line in the chart template and to confirm that an account has not been associated with more than one detail line. If the chart template validates, it may then be saved (step 3030) and method 3000 is completed. However, it should be understood that the user can always return to this saved chart template for later edits or modifications, as desired. If the chart template does not validate in step 3020, the system presents (step 3040) a validation error page that identifies which accounts are missing from the chart template and which accounts are included more than once in the chart template. Because there may be some situations in which a user or organization wants to generate a non-validated, and hence, non-balancing report, the system presents the user with the option (step 3050) to proceed anyway. If the user wants to correct any non-validation errors, the user returns to the visual chart organizer user interface and re-performs steps 3100 or 3200 to define or modify header/total pairs and detail lines, respectively.

The process 3100 of defining at least one header/total pair is illustrated in FIG. 31. First, a request (step 3110) to insert a header/total pair is received. A single, “blank” header/total line appears in the user interface area of the chart template. A default level (one level below the just preceding and highlighted header/total pair or section) is assigned. This level is assignable or modifiable (step 3120) by the user. An account category is then assigned (step 3130) to the header/total pair. As stated previously, for a header/total pair on the balance sheet section of the chart template, an allowable account category is asset, liability, or net assets. A “balance sheet” account category is also allowable, which indicates that the header/total pair may contain accounts in more than one of asset, liability, or net assets. Correspondingly, for a header/total pair on the income statement section of the chart template, an allowable account category is revenue, expense, gift, transfer, gain, or loss (assuming all such account categories have been permitted in configuration and setup of the system). An “income statement” account category is also allowable, which indicates that the header/total pair may contain accounts in more than one of revenue, expense, gift, transfer, gain, or loss. A name or caption is then assigned or given (step 3140) to the header and formatting for the header is specified (step 3150). A name or caption is then assigned or given (step 3160) to the corresponding total line and formatting for the total line is also specified (step 3170). Importantly, it is only necessary to show a single line for the header/total pair in the “design view” user interface. When actually used to generate a report or when shown in account view, the total line may be shown below the list of accounts that will appear between this particular header/total pair.

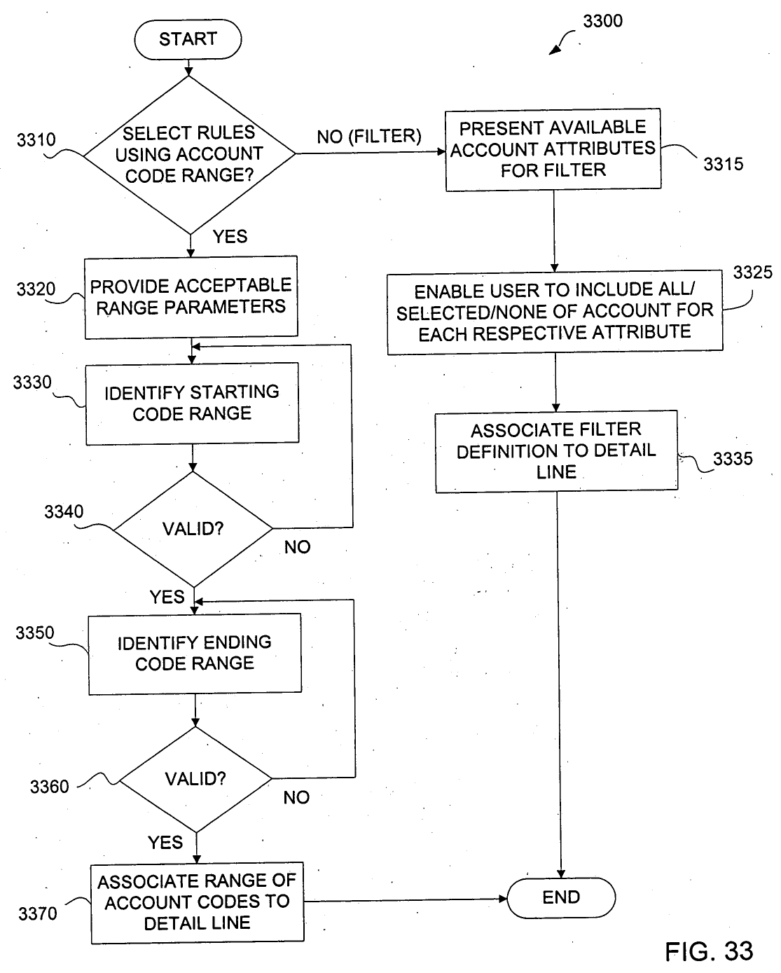

The process 3200 of defining at least one detail line is illustrated in FIG. 32. First, a request (step 3210) to insert a detail line is received. A single, “blank” detail line appears in the user interface area of the chart template. A default level (one level below the just preceding and highlighted header/total pair or detail line) is assigned. This level is assignable or modifiable (step 3220) by the user. The system then determines (step 3230) whether the detail line has more than one possible account category associated therewith (based on the header/total pair in which it is included). If there is more than one possible account category, then the system enables the user to specify (step 3240) what account category is assigned to the detail line. If there is not more than one possible account category, then the system automatically assigns (step 3250) the appropriate account category to the detail line. A name or caption is then assigned or given (step 3260) to the detail line and formatting for the detail line is specified (step 3270). Finally, the process 3300 of associating specific accounts with a detail line, as discussed in greater detail in association with FIG. 33, is performed.

Turning now to FIG. 33, the process 3300 of associating specific accounts with a detail line is illustrated. First, it is necessary to determine (step 3310) whether the user is associating a range of accounts with the detail line (or alternatively with a filter). If association is to be based on a range of accounts (in step 3310), then a full range of permissible account codes (based on the header/total pair in which the detail line is included) is presented (step 3320) to the user. The user then specifies or identifies (step 3330) a starting account code for the specific range to be associated with the detail line. The system verifies (step 3340) that the starting account code chosen by the user is within the range of permissible account codes. If the starting account code does not verify, a new starting account code must be specified. The user then specifies or identifies (step 3350) an ending account code for the specific range to be associated with the detail line. The system verifies (step 3360) that the ending account code chosen by the ‘user is within the’ range of permissible account codes, which in this case means an account code after the starting account code and the end of the permissible range of account codes. If the ending account code does not verify, a new ending account code must be specified. Once valid starting and ending account codes for the detail line have been specified, the system associates (step 3370) all accounts having account codes therebetween with the particular detail line.

If association is not to be based on a range of accounts (in step 3310), then the association will be based on a filter defined by the user. First, the user is presented (step 3315) with a list of all available account attributes that can be used to define the filter. The user then defines (step 3325) the filter using such account attributes. The filter includes any combination of “all,” “some” (i.e., “selected”), or “no accounts” having one or more account attributes chosen by the user. Once the desired filter has been defined by the user, the system associates (step 3335) the filter with the particular detail line.

The above process may be repeated until the chart template has all of the header/total pairs created and all detail lines defined therein, as desired by the user.

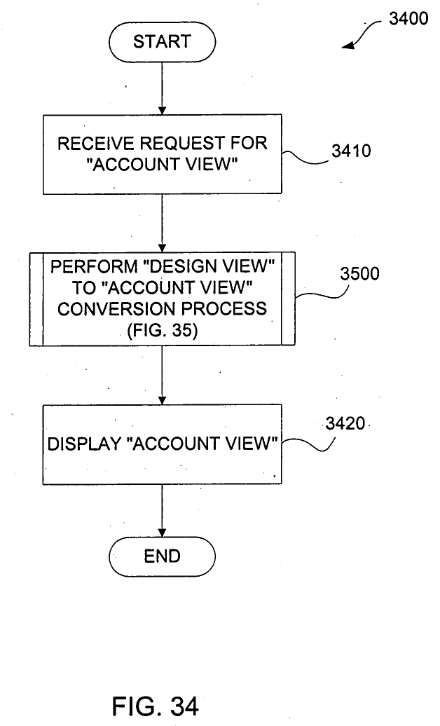

Turning now to FIGS. 34-37, the process 3400 for generating a real-time “account view” (as previously discussed in association with FIGS. 22A-22D) based on the chart template defined by the user is illustrated. First, the system receives (step 3410) a request to display the “account view” of a particular chart template. It should be understood that the chart template does not have to be completed or validated in order for the system to be able to generate a corresponding account view. Next, the system performs (step 3500) a “design view” to “account view” conversion process, described hereinafter. Once the conversion process has been performed, the account view of the particular chart template is displayed (step 3420).

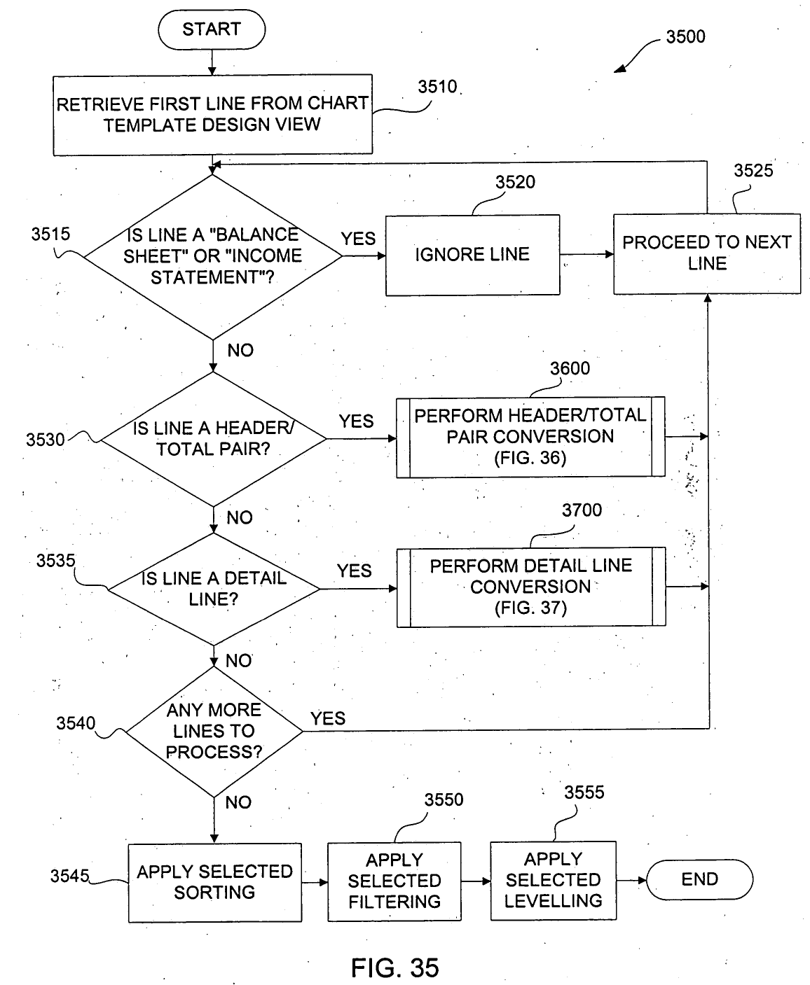

Turning now to FIG. 35, the “design view” to “account view” conversion process 3500 is illustrated. First, the system retrieves (step 3510) the first line from the chart template “design view.” The system then determines (step 3515) whether this retrieved line is the “balance sheet” or “income statement” section header. If so, this retrieved line is ignored (step 3520) and the system proceeds (step 3525) to the next line from the chart template design view. If the determination in step 3515 is negative, then the system determines (step 3530) whether the retrieved line is a header/total pair line. If so, then the system performs (step 3600) a header/total pair conversion.

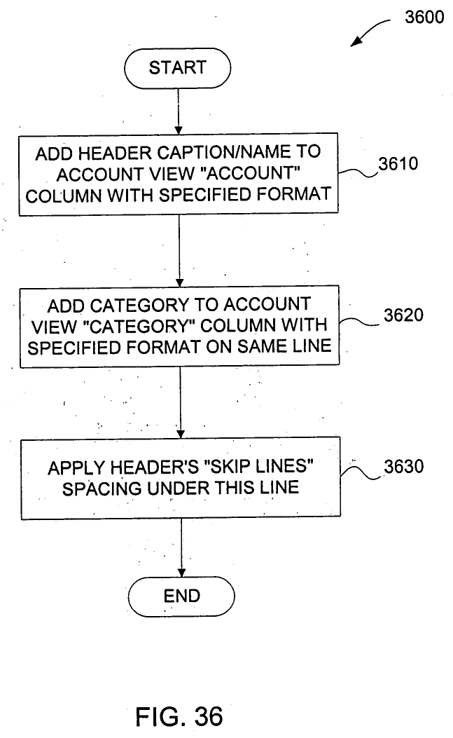

Turning now to FIG. 36, the header/total pair conversion 3600 is illustrated. First, the system adds (step 3610) the header caption (or name) for the present header/total pair to the “account” column of the account view display. Any previously specified formatting for the header is also displayed. Next, the system adds (step 3620) the category associated with this particular header/total pair into the “category” column of the account view display. This category is on the same line as the header caption and has the same formatting as the header caption. Finally, the system applies or inserts (step 3630) the number of blank lines specified by the user to follow any header. Turning back to FIG. 35, the system proceeds (step 3525) to the next line from the chart template design view.

Still with reference to FIG. 35, if the determination in step 3530 is negative, then the system determines (step 3535) whether the retrieved line is a detail line. If so, then the system performs (step 3700) a detail line conversion.

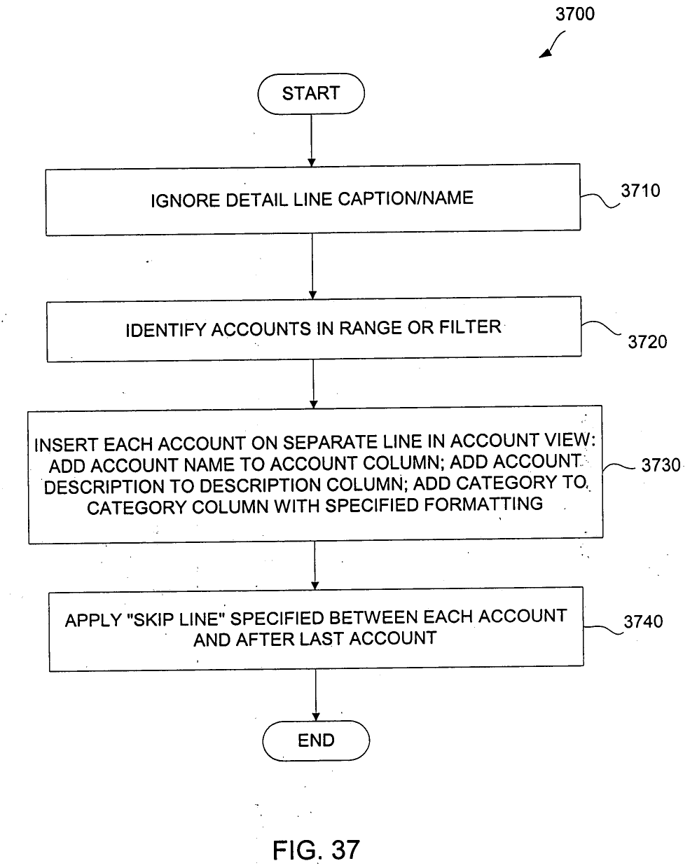

Turning now to FIG. 37, the detail line conversion 3700 is illustrated. First, the system ignores (step 3710) the detail line caption. Next, the system identifies (step 3720) all accounts associated with the detail line, based on the range or filter previously associated with the detail line. The system then inserts (step 3730) a separate line for each such account associated with this one detail line. Each separate line includes the account name in the “account” column of the account view display, the account description in the “description” column of the account view display, and category associated with this particular detail line in the “category” column of the account view display. The system then inserts (step 3740) the number of blank lines specified by the user to follow each account and the last account associated with this detail line. Turning back to FIG. 35, the system proceeds (step 3525) to the next line from the chart template design view.

Still with reference to FIG. 35, if the determination in step 3535 is negative, then the system determines (step 3540) whether there are any more lines in the chart template design view that need to be processed. If so, the system proceeds (step 3525) to the next line from the chart template design view. If not, the system applies (step 3545) any requested sorting to the account view. Preferably, if the user requests sorting based on “design view order,” no additional sorting is necessary because the account view is initially created in this sorting arrangement. If the user requests sorting based on “fund,” “department,” or some other attribute, then the system multiplies the account views and puts them in sequence within the account view display. Each grouping of account views has the same arrangement of headers but, within each grouping, only accounts that are from the respective fund, department, or with the same attribute are listed.

The system then applies (step 3550) any additional filtering specified by the user. Only accounts identified by the specified filter are then displayed in the account view. Optionally, any headers having no accounts therebelow may be hidden as well. The system then applies (step 3555) selected leveling to the display view. Each header and account has the same “level” associated with the header/total pair and detail line, respectively, from the design view. For example, if the user selects to view only level one, then all lines (header or account) having a level two or greater are hidden. Correspondingly, if the user selects to view down to level four, then all lines having a level five or greater are hidden. Preferably, each line in the account column (whether a header or an account line) is indented based on its corresponding level. For example, level one headers and accounts are left justified, level two has a single indent, level three has a double indent, and so on.

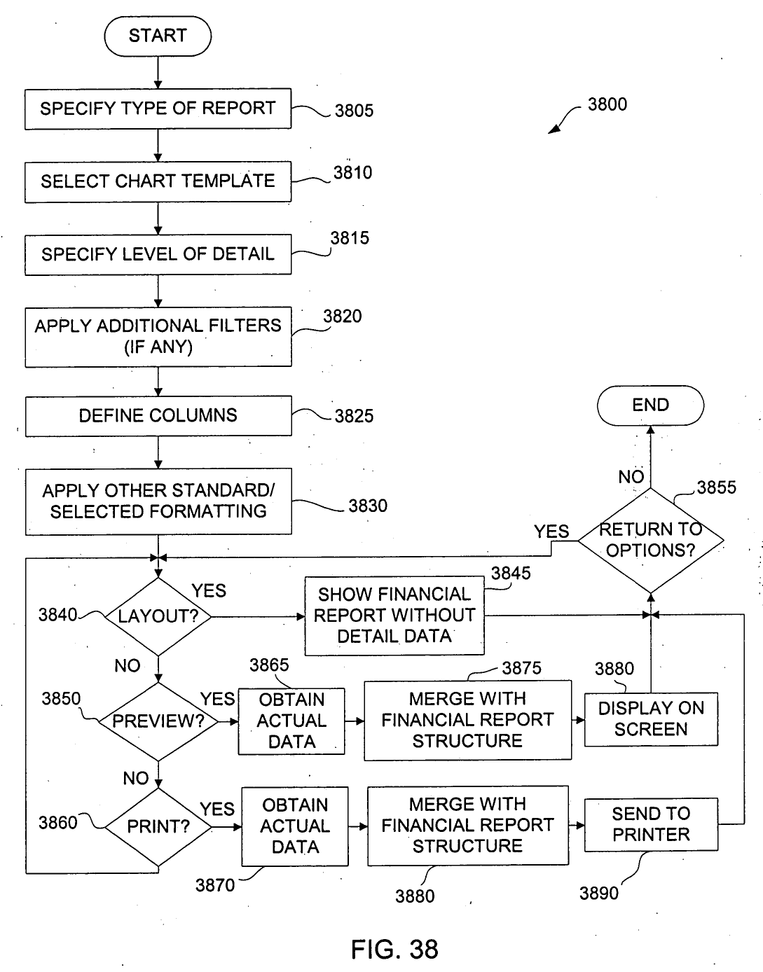

Now with reference to FIG. 38, the process 3800 for generating a report, such as a financial statement, using a chart template is illustrated. This process 3800 corresponds generally with the screen shots shown in FIGS. 8-10H. First, the user specifies (step 3805) the type of report to be generated. The user then selects (step 3810) which chart template to use in generating the report. As will be appreciated by those skilled in the art and based on the above disclosure, the chart template defines the rows of information (header lines, account lines, and total line) that will appear in the report. The user then specifies (step 3815) the level of detail for the report. As with display view, the user is able to specify down to what level of detail will be shown in the report. For example, if the user selects to view down to level three, then all lines having a level four or higher (if there are any) will not be displayed on the report. Also, as with display view, the user has the option of selecting and applying (step 3820) any filters for reducing or targeting the information that will be displayed in the report. The user then defines (step 3825) how many and what columns of information to include in the report. The user is able to specify headings for each column and for multiple columns, if desired, to define the formula for what financial data will appear in each column, and to specify a date range. The user also has the option of applying (step 3830) many other conventional formatting and customization options, such as report title, headers and footers for each page of the report, page numbering, color scheme, whether to show accounts having zero balance or that are inactive, and the like.

Still with reference to FIG. 38, the user has the options of viewing a layout of the report (step 3840), displaying a print preview of the report (step 3850), or printing the report (step 3860). If the user requests to view a layout of the report in step 3840, the system displays (step 3845) the report on the screen. The rows of such “layout” report are similar to the display view, previously described, with the addition of total lines. The columns are also displayed, but no real data is inserted. The benefit of the layout report is that it allows the user quickly to view what the report structure will look like without any delays associated with acquiring real-time data and applying necessary formulas, and without the distractions of seeing numbers. The user has the option (step 3855) of returning back to any of the report setup options at any time. If the user requests a print preview of the report (step 3850), the system obtains (step 3865) actual real-time data from the account database 125 (from FIG. 1), merges and applies formulas to such data and inserts the same into the appropriate location in the report structure (step 3875), and displays (step 3885) the report on the screen. Again, the main difference between the layout view and the print preview view is the inclusion of real-time data in the print preview report. The user still has the option (step 3855) of returning back to any of the report setup options at any time. If the user requests a print of the report (step 3860), the system obtains (step 3870) actual real-time data from the account database 125 (from FIG. 1), merges and applies formulas to such data and inserts the same into the appropriate location in the report structure (step 3880), and sends (step 3890) the report to the printer 117 (from FIG. 1). Obviously, if the user selects to print from print preview, it is not necessary for the system to re-retrieve the real-time data and merge the same into the report structure since this has already been done for the print preview.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. In a computerized accounting system, in which rows of a financial report generated by the accounting system are defined by a user-configurable chart template, a method of creating the chart template comprising the steps of:
displaying a visual representation of the chart template via a user interface, the visual representation corresponding to at least one section of the financial report;
receiving an input for a header/total pair for insertion into the at least one section of the financial report, the header/total pair defining a header row and a corresponding total row for inclusion in the financial report;
receiving an input for a detail line associated with the header/total pair; and
associating a rule with the detail line, the rule defining which accounts of the accounting system are to be listed between the header row and the corresponding total row of the financial report.

2. The method of claim 1 further comprising assigning an account category to the header/total pair.

3. The method of claim 2 further comprising assigning an account category to each account in the accounting system and wherein the rule requires that all accounts associated with the detail line be of the account category of the associated header/total pair.

4. The method of claim 1 further comprising presenting a list of acceptable account categories assignable to the header/total pair based on the at least one section.

5. The method of claim 1 further comprising assigning a level to the header/total pair.

6. The method of claim 5 wherein the level determines the indentation of the header and total rows in the financial report.

7. The method of claim 5 wherein the level selectively determines whether the header and total rows are displayed in the financial report.

8. The method of claim 5 further comprising assigning a level to the header/total pair and a level to the detail line, wherein the level of the detail line is greater than the level of the header/total pair.

9. The method of claim 1 wherein each account in the accounting system includes an account code and wherein the rule associated with the detail line is based on a range of account codes.

10. The method of claim 9 wherein the range of account codes is a subset of a range of permissible account codes associated with an account category of the corresponding header/total pair.

11. The method of claim 1 wherein the rule associated with the detail line is based on a filter of account criteria.

12. The method of claim 1 further comprising displaying a visual representation of the chart template wherein the detail line is replaced by a list of all accounts associated with the detail line by the rule.

13. The method of claim 1 wherein the section is a balance sheet.

14. The method of claim 1 wherein the section is an income statement.

15. The method of claim 1 wherein the input for the header/total pair includes a caption for the header row.

16. In a computerized accounting system with access to a database of accounts, each account having account data associated therewith, the account data including account name and account financial information, a method of generating a financial report comprising the steps of:
displaying a user-configurable chart template to a user of the system via a user-interface;
receiving inputs into the chart template, each input defining a respective detail line;
associating a rule with each detail line of the chart template, each respective rule defining a subset of accounts to be grouped together in the financial report;
retrieving from the database account data for each account associated with the detail lines of the chart template;
merging the retrieved account data into the financial report, the financial report having columns for account name and account financial information, the rows of information in the financial report grouped according to the detail lines of the chart template, and
presenting the financial report to the user.

17. The method of claim 16 wherein, when displaying the user-configurable chart template to the user, the chart template is initially blank.

18. The method of claim 16 wherein, when displaying the user-configurable chart template to the user, the chart template already includes at least one pre-defined detail line.

19. The method of claim 16 further comprising the step of validating the chart template to identify any accounts in the database not associated with at least one detail line of the chart template.

20. The method of claim 16 further comprising the step of validating the chart template to identify any accounts in the database associated with more than one detail line of the chart template.

21. The method of claim 16 further comprising the step of receiving further inputs into the chart template, each further input defining header rows and total rows for inclusion in the financial report.

22. The method of claim 16 further comprising the step of receiving further inputs into the chart template, each further input defining a header/total pairs, and wherein each respective detail line is associated with one of the header/total pairs.

23. The method of claim 22 further comprising the step of assigning an account category to each respective header/total pair.

24. The method of claim 23 further comprising assigning an account category to each account in the database and wherein the rule associated with each respective detail line requires that all accounts associated with the respective detail line be of the account category of the associated header/total pair.

25. The method of claim 22 further comprising assigning a level to each respective header/total pair and each respective detail line.

26. The method of claim 25 wherein each header/total pair defines a respective header row and a respective corresponding total row for inclusion in the financial report, and wherein the level determines the indentation of each respective header and total row in the financial report.

27. The method of claim 25 wherein the level selectively determines whether each respective header and total rows are displayed in the financial report.

28. The method of claim 27 wherein the user determines up to what level the financial report includes.

29. The method of claim 25 wherein the level determines the indentation of the account names of each accounts associated with a respective detail line.

30. The method of claim 25 wherein the level selectively determines whether accounts associated with each respective detail line are displayed in the financial report.

31. The method of claim 16 wherein each account in the database includes an account code and wherein the rule associated with each respective detail line is based on a range of account codes.

32. The method of claim 16 wherein the rule associated with each respective detail line is based on a filter of account criteria.

33. The method of claim 16 further comprising receiving a request from the user for generation of the financial report.

34. The method of claim 16 further comprising the step of presenting the user with a list of available financial reports.

35. The method of claim 16 wherein funds are defined in the accounting system and wherein the rows of information in the financial report are further sorted by such funds.

36. The method of claim 16 wherein the step of presenting the financial report comprises displaying the financial report on a computer screen.

37. The method of claim 16 wherein the step of presenting the financial report comprises printing the financial report.

38. The method of claim 16 further comprising the step of presenting the user with a list of available financial reports.

39. The method of claim 16 further comprising the step of saving the chart template.

40. The method of claim 16 further comprising displaying a visual representation of the chart template wherein each respective detail line is replaced by a list of all accounts associated by the rule of the respective detail line.

41. The method of claim 16 wherein the chart template corresponds to a section of the financial report.

42. The method of claim 41 wherein the section is a balance sheet.

43. The method of claim 42 wherein each detail line has an associated account category and wherein the account category of each detail line in the balance sheet section of the chart template is one or more of the group of assets, liabilities, and net assets.

44. The method of claim 41 wherein the section is an income statement.

45. The method of claim 44 wherein each detail line has an associated account category and wherein the account category of each detail line in the income statement section of the chart template is one or more of the group of revenue, expense, gift, transfer, gain, and loss.
